(19) United States
(12) Patent Application Publication
(10) Pub. No.: US 2012/0109794 A1
(43) Pub. Date: May 3, 2012

(54) SYSTEM, METHOD AND APPARATUS FOR PLANNING AND MANAGING ENGAGEMENTS

(76) Inventors: Alan Nathanson, Los Angeles, CA (US); Nathan Lee Bowie, Houston, TX (US); Brian M. Lake, Oswego, IL (US); Don Gibson, Houston, TX (US)

(21) Appl. No.: 12/914,959

(22) Filed: Oct. 28, 2010

(51) Int. Cl. G06Q 10/00; G06Q 50/00

(52) U.S. Cl. 705/32; 705/301; 705/30

(57) ABSTRACT

To address this and/or other needs, the present inventors have devised a system, method and apparatus for planning and managing engagements associated with fee arrangements. In one exemplary apparatus, a server, particularly a processor within the server, enables the management of a law firm matter project. The exemplary apparatus includes the processor configured to populate a law firm matter project with either a piece of financial information and/or a piece of a matter project template associated with an existing law firm matter project. Moreover, the exemplary apparatus enables a time entry mechanism within an exemplary system. Even moreover, the exemplary apparatus calculates a budget associated with a piece of financial information.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2010, Thomson Reuters.

### FIELD OF INVENTION

Various embodiments of the present invention concern system, method and apparatus for planning and managing engagements associated with a fee arrangement.

### BACKGROUND OF THE INVENTION

Clients and law firms alike have long lamented the inherent inefficiencies and mismatch of incentives created by hourly billing. However, those observations are overshadowed by the reality that the demand for quality legal services has largely exceeded the supply of quality lawyers—at least for most United States practices. However the global economic downturn radically changed that balance, and the legal profession now experiences a profound shift to a buyers' market. With most industries in a buyers' market, pricing pressures emerge and pricing undergoes a significant evolution.

With clients wrestling the immediate and long-term implications of the economic downturn, they have specific concerns regarding one of their largest suppliers—law firms. While these specific concerns vary, there are three consistent issues clients experience with law firms:
frustration over the lack of predictability in legal fees on a given case or matter (i.e. an engagement);
frustration over the lack of value (i.e. high cost of relatively inexperienced associates and/or middle pack partners who fail to bring value proportionate to their billing rate); and
high overall cost of legal services and the inability to contain those costs from year-to-year.

Clients want increased value at reduced costs while requiring law firms to help them reduce risks and limit clients' fee exposure. In order to achieve favorable results, clients are demonstrating a greater willingness to explore various fee arrangements. There are numerous fee arrangements in use, ranging from simple variations on traditional hourly billing (e.g., fee caps, unitary or blended rates), to incentive arrangements (e.g., hourly rates with significant premiums or discounts based on result, full or partial contingency fees), to novel arrangements that satisfy many of the most common clients' concerns (e.g., fixed or project fees).

That being said, many in-house counsel clients and their purchasing departments historically have difficulty designing and evaluating fee arrangements for engagements, in particular alternative fee arrangements (AFAs). Indeed, many of those same in-house counsel clients are reluctant to implement an alternative fee arrangement out of fear for the unknown risks. Furthermore, they navigate the law firm/hourly billing environment with knowledgeable ease and are sometimes more comfortable settling on known billing practices albeit with higher discounts.

Clients, especially in-house counsel clients, cite a deep concern with AFAs-the potential reduction in service, timeliness and value. This concern is legitimate and is based on history. Some United States insurance companies experimented with AFAs in the 1980's only to discover that as law firms realized lower profits or even losses, they modified their approach by substituting cheaper and less competent lawyers to handle the work. As a result the law firms and clients alike became unhappy with AFAs prompting some companies to abandon the strategy.

Nonetheless, efficiency is needed to achieve success with most fee arrangements for engagements, especially with fixed/project/portfolio pricing arrangements. Law firms that efficiently deliver valued services increasingly position themselves to achieve higher margins regardless of the fee structure. Over time, not only do the law firms achieve greater profitability, they also increase their value and importance to the client. The law firm that is able to consistently deliver quality and use resources more efficiently derives more work and more fees, not because of the time spent on the matters but because of the number of successful outcomes in a given period.

Learning how to effectively evaluate, deliver and manage predictable pricing positions a law firm to emerge stronger when the economy revives and for the long term. The long term benefits include the strengthening of client relationships, more competitive management of resources, advantages in the ability to demonstrate real value to clients, better knowledge of the client's needs, improved knowledge of the client's industry, and recognition across the client's business that the law firm's approach to legal services is both differentiated and of value across its various practice areas. In addition, demonstrating value is not limited to that single client. As law firms master their approach and the resulting demonstrable value to their clients, true differentiation in the legal market place is possible.

While fee arrangements are evolving, currently no solution exists for planning and managing engagements associated with fee arrangements with the efficiency needed to gain an industry advantage. Accordingly, the inventors have recognized additional improvements in planning and managing engagements associated with fee arrangements.

### SUMMARY OF THE INVENTION

To address this and/or other needs, the present inventors have devised a system, method and apparatus for planning and managing engagements associated with fee arrangements. In one exemplary apparatus within an exemplary system, a server, particularly a processor within the server, enables the management of a law firm matter project. The exemplary apparatus includes the processor configured to populate a law firm matter project with either a piece of financial information and/or a piece of a matter project template associated with an existing law firm matter project. Moreover, the exemplary apparatus enables a time entry mechanism within an exemplary system. Even moreover, the exemplary apparatus calculates a budget associated with financial information.

Advantageously, the present invention enables law firms to plan, create and manage engagements (i.e. single matter projects or portfolio matter projects) and their associated budgets and work plans, while optimizing the firm's efficiency at meeting clients' needs. The law firm's experience is mined to streamline creation of engagement plans and budgets, facilitate execution of matters against plan through a working process built around how attorneys work and/or collaboratively create, monitor and manage client engagements.

Additionally, the present invention enables law firms to create, monitor and manage integrated budgets and work plans for matter projects and portfolio matter projects while meeting law firm clients' demands for transparent, predictable costs. Law firms are under increasing pressure to deliver more value to their clients in a cost-effective manner by working within plans and budgets that are consistent and predictable. The seamless integration with a law firm's existing information management systems—including time and billing, human resources, email and customer relationship management—allows attorneys to confidently manage within the evolving demands of today's clients. The leverage of the law firm's experience enables lawyers to build detailed plans and precise budgets. In addition, the law firms adjust timekeeper and staff assignments, timelines and budgets to optimize plans within a client's specified guidelines and objectives by continuously monitoring and allowing the firms to track the performance of an engagement against a plan. Moreover, the budget and plans for matter projects and portfolio matter projects are accessible to potentially all law firm personnel because they are stored on a firm-wide server instead of an individual's desktop.

### BRIEF DESCRIPTION OF THE DRAWINGS

FIG. 1 is an exemplary system corresponding to one or more embodiments of the invention.

FIG. 2 is an exemplary method corresponding to one or more embodiments of the invention.

FIG. 3 is an exemplary interface corresponding to one or more embodiments of the invention.

FIG. 4 is an exemplary interface corresponding to one or more embodiments of the invention.

FIG. 5 is an exemplary interface corresponding to one or more embodiments of the invention.

FIG. 6 is an exemplary interface corresponding to one or more embodiments of the invention.

FIG. 7 is an exemplary interface corresponding to one or more embodiments of the invention.

FIG. 8 is an exemplary interface corresponding to one or more embodiments of the invention.

FIG. 9 is an exemplary interface corresponding to one or more embodiments of the invention.

FIG. 10 is an exemplary interface corresponding to one or more embodiments of the invention.

FIG. 11 is an exemplary interface corresponding to one or more embodiments of the invention.

FIG. 12 is an exemplary interface corresponding to one or more embodiments of the invention.

FIG. 13 is an exemplary interface corresponding to one or more embodiments of the invention.

FIG. 14 is an exemplary interface corresponding to one or more embodiments of the invention.

FIG. 15 is an exemplary interface corresponding to one or more embodiments of the invention.

FIG. 16 is an exemplary interface corresponding to one or more embodiments of the invention.

FIG. 17 is an exemplary interface corresponding to one or more embodiments of the invention.

FIG. 18 is an exemplary interface corresponding to one or more embodiments of the invention.

FIG. 19 is an exemplary interface corresponding to one or more embodiments of the invention.

FIG. 20 is an exemplary interface corresponding to one or more embodiments of the invention.

FIG. 21 is an exemplary interface corresponding to one or more embodiments of the invention.

FIG. 22 is an exemplary interface corresponding to one or more embodiments of the invention.

FIG. 23 is an exemplary interface corresponding to one or more embodiments of the invention.

FIG. 24 is an exemplary interface corresponding to one or more embodiments of the invention.

FIG. 25 is an exemplary interface corresponding to one or more embodiments of the invention.

FIG. 26 is an exemplary interface corresponding to one or more embodiments of the invention.

FIG. 27 is an exemplary interface corresponding to one or more embodiments of the invention.

FIG. 28 is an exemplary interface corresponding to one or more embodiments of the invention.

FIG. 29 is an exemplary interface corresponding to one or more embodiments of the invention.

FIG. 30 is an exemplary interface corresponding to one or more embodiments of the invention.

FIGS. 31-124 are exemplary interfaces corresponding to one or more embodiments of the invention, particularly a time entry mechanism.

### DETAILED DESCRIPTION OF THE EXEMPLARY EMBODIMENTS

This description, which incorporates the Figures and the claims, describes one or more specific embodiments of an invention. The one or more embodiments, offered not to limit but only to exemplify and teach the invention, are shown and described in sufficient detail to enable those skilled in the art to implement or practice the invention. Thus, where appropriate to avoid obscuring the invention, the description may omit certain information known to those skilled in the art.

The description includes many terms with meanings derived from their usage in the art or from their use within the context of the description. However, as a further aid, the following exemplary definitions are presented. The term “engagements” are single matter projects and/or portfolio matter projects. Exemplary matter projects and/or portfolio matter projects create, monitor and manage client matter projects and/or portfolio matter projects through planning and budgeting while optimizing the law firm's efficiency at meeting the clients' needs. Further examples of engagements, matter projects, portfolio matter projects are described throughout the specification.

### Exemplary System for Planning and Managing Engagements

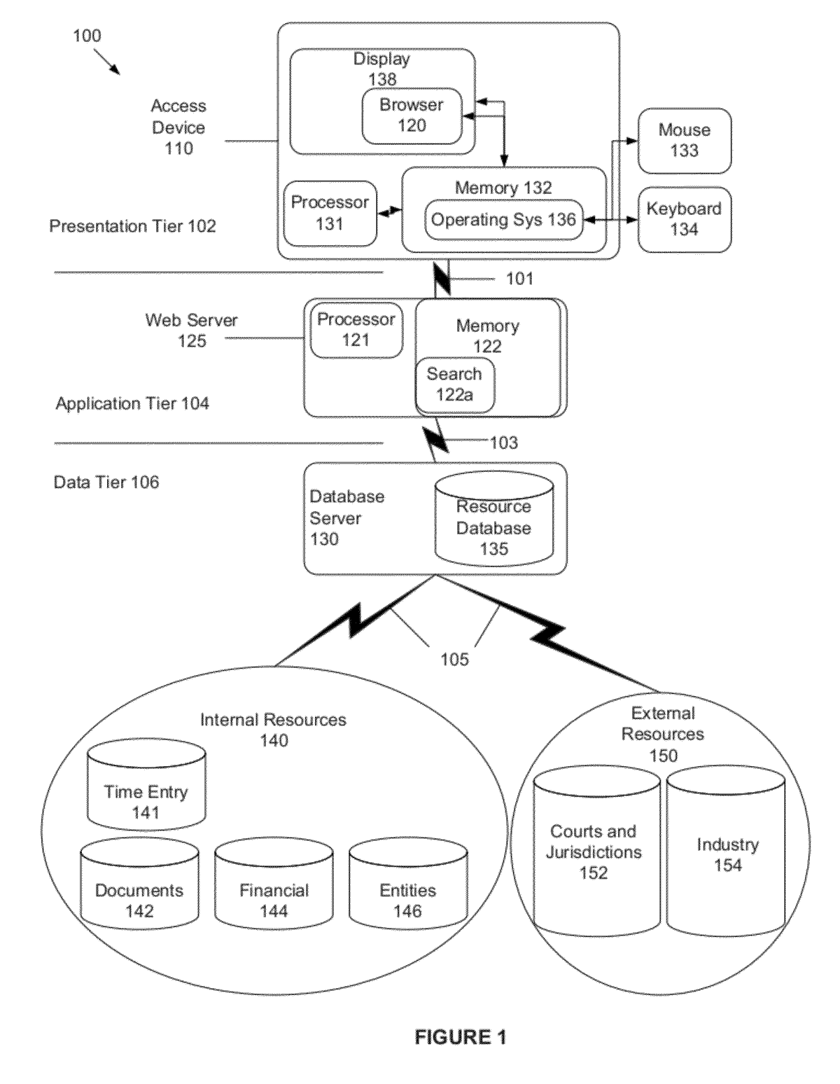

FIG. 1 shows an exemplary system 100 for planning and managing engagements, which may be adapted to incorporate the capabilities, functions, methods, interfaces, and so forth described herein. System 100 includes a presentation tier 102, an application tier 104, and a data tier 106.

Within the presentation tier 102 resides at least one access device 110. Access device 110 is generally representative of one or more access devices. In the exemplary embodiment, access device 110 takes the form of a personal computer, workstation, personal digital assistant, mobile telephone, or any other device capable of providing an effective user interface with a server or database. Specifically, access device 110 includes a processor 131, a memory 132, an operating system 136, a browser 120, a display 138, a keyboard 134, and a graphical pointer/selector (i.e. mouse) 133.

Processor 131 includes one or more processors, processing circuits, or controllers. In the exemplary embodiment, processor module 131 takes any convenient or desirable form. Coupled to processor 131 is memory 132. Memory 132 is also coupled to an operating system 136, a browser 120, and a display 138. In the exemplary embodiment, operating system 136 takes the form of a version of the Microsoft® Windows operating system, and browser 120 takes the form of a version of Microsoft® Internet Explorer®. Operating system 136 and browser 120 receive inputs from keyboard 134 and selector 133.

Access device 110 is coupled or couplable via a wireless or wireline communications network 101, such as a local-, wide-, private-, or virtual-private network, to web server 125. The wireless or wireline communications network 101 transmits a signal. An exemplary signal includes a request containing instructions for executing a query against a database and/or extracting, copying, updating and/or storing information within a database. Exemplary requests include Hypertext Transfer Protocol (HTTP), Hypertext Transfer Protocol Secure (HTTPS), Simple Mail Transfer Protocol (SMTP) and the like. For example, access device 110 transmits a HTTP request (e.g. the HTTP request contains instructions to execute a user query) via the communications network 101 to the web server 125 residing within the application tier 104.

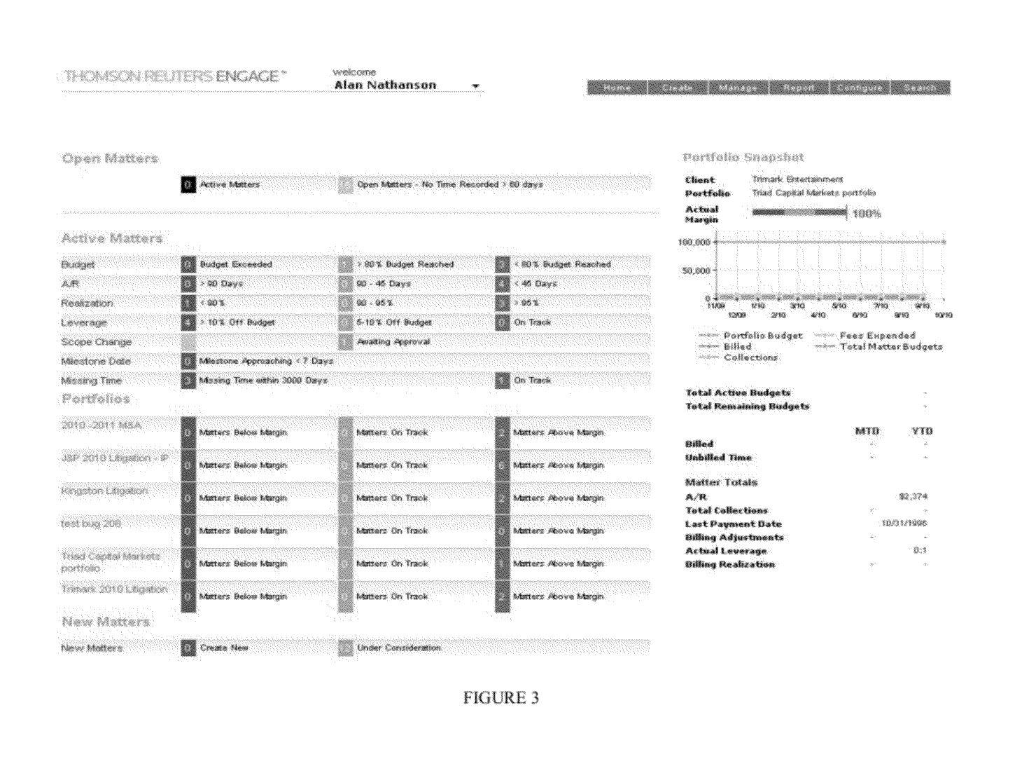

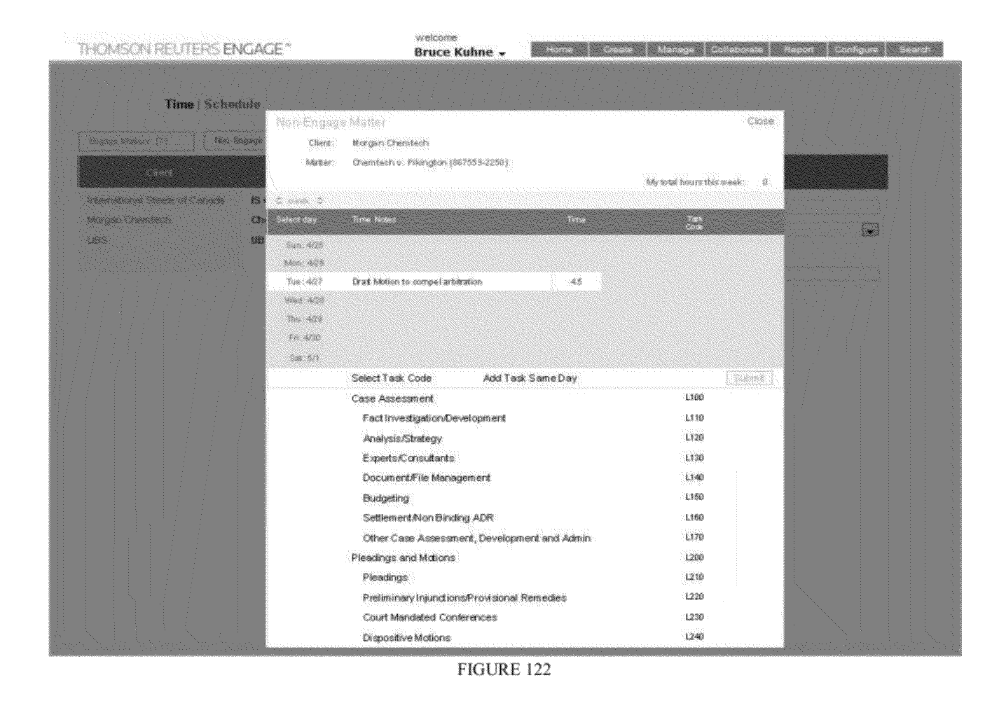

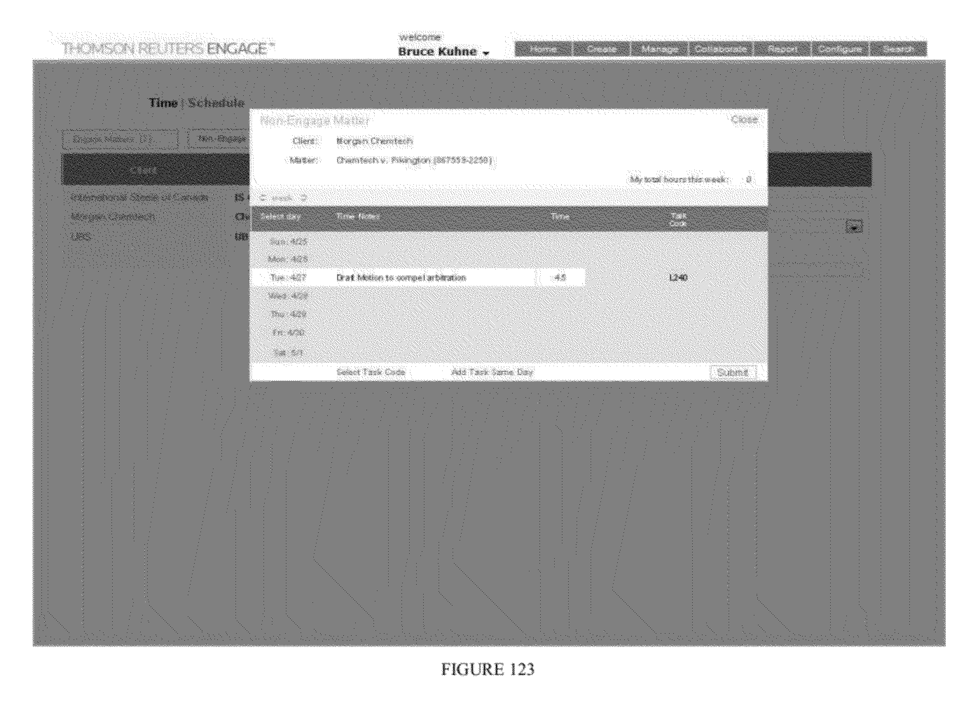

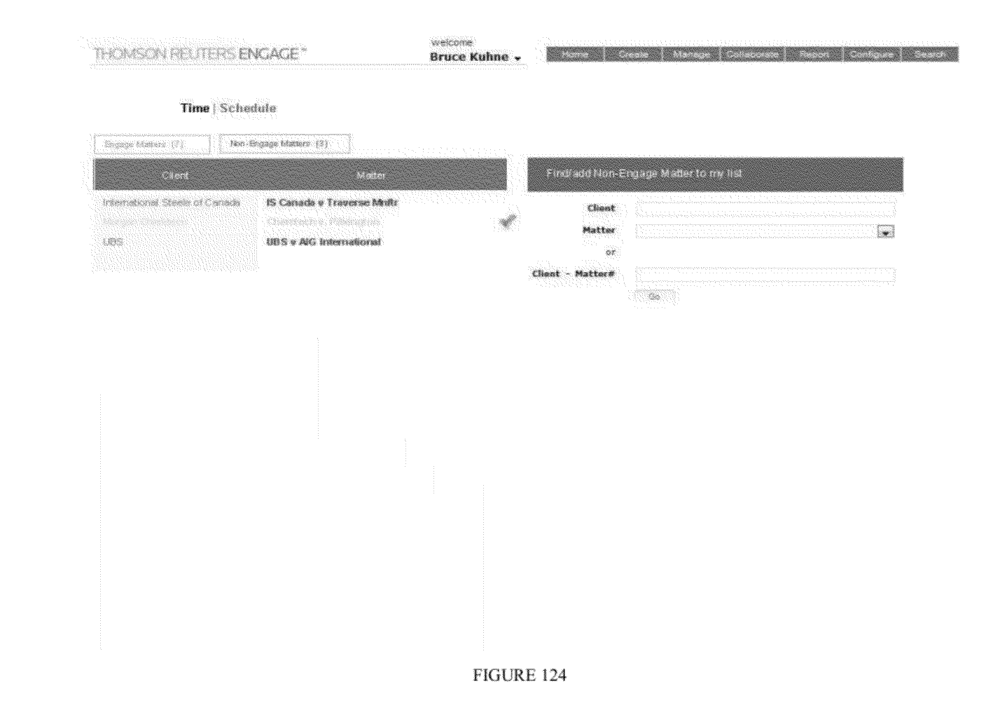

In system 100, application tier 104 includes web server 125 and database server 130. In other exemplary embodiments web server 125 and database server 130 physically reside on one server (or virtual servers) depending on the usage, storage and performance requirements. Nonetheless, an apparatus, for example, application tier 104, may contain web server 125, database server 130 or both. In addition, the apparatus is associated with and correlates to method 200 and FIGS. 3-124 with corresponding description sections.

Web server 125 is generally representative of one or more servers for serving data in the form of web pages or other markup language forms with associated applets, ActiveX controls, remote-invocation objects, or other related software and data structures to service clients of various “thicknesses.” A client which depends heavily on some other computer for computational activities is considered to be a “thin” client. A client that has the ability to perform many functions without a continuous connection to a network or central server is considered to be a “thick” client. More particularly, web server 125 includes a processor 121, a memory 122, and a search module 122a.

Processor 121 includes one or more local or distributed processors, controllers, or virtual machines. In the exemplary embodiment, processor 121 assumes any convenient or desirable form. Processor 121 is coupled to memory 122. Memory 122, which takes the exemplary form of one or more electronic, magnetic, or optical data-storage devices, is also coupled to search module 122a. Search module 122a includes one or more search engines for receiving and processing queries against the resource database 135.

Web server 125 is coupled or couplable via a wireless or wireline communications network 103, such as a local-, wide-, private-, or virtual-private network, to database server 130. The wireless or wireline communications network 103 transmits a signal. An exemplary signal includes a request containing instructions for executing a query against a database and/or extracting, copying, updating and/or storing information within a database. Exemplary requests include Hypertext Transfer Protocol (HTTP), Hypertext Transfer Protocol Secure (HTTPS), Simple Mail Transfer Protocol (SMTP) and the like. For example, web server 125 transmits a request containing instruction for querying a database, via the communications network 103, to the database server 130.

In the data tier 106, database server 130 is a centralized storage mechanism configured to ensure information cannot be modified by multiple users at once and indexes and sorts the information so it is easily searched. Located within the database server 130 is a resource database 135. The resource database 135 stores received information from the access device 110, the external resources 150 and/or the internal resources 140 and its history. For example, an internal resource history may be Associate John Smith, who back in 1999 was a 3^{rd} year associate when he worked on matter X. However, now John Smith is a partner. The resource database 135 keeps a history record of the dates John Smith was a 3^{rd} year associate as well as his current position. This history record keeping allows for additional functionality described herein. In one exemplary embodiment, the resource database 135 is one data storage mechanism. However, one skilled in the art recognizes that one or more databases could make up the resource database 135.

Resource database 135 is populated with various types of information and resources. Information comes from resources such as access device 110, internal resources 140 and external resources 150. Internal resources 140 and external resources 150 include a set of databases 152, 154 and a set of systems 141, 142, 144, 146. Databases 152, 154 take the exemplary form of one or more electronic, magnetic, or optical data-storage mechanisms. Databases 152, 154 and systems 141, 142, 144, 146 are coupled or couplable via a wireless or wireline communications network link 105, such as a local-, wide-, private-, or virtual-private network, to database server 130 and resource database 135. The wireless or wireline communications network 105 transmits a signal. An exemplary signal includes a request containing instructions for executing a query against a database and/or extracting, copying, updating and/or storing information within a database. Exemplary requests include Hypertext Transfer Protocol (HTTP), Hypertext Transfer Protocol Secure (HTTPS), Simple Mail Transfer Protocol (SMTP) and the like. For example, database server 130 transmits a request containing instructions to extract information from one or more databases, via the communications network 105, to internal resources 140 and/or external resources 150.

Internal resources 140 are a set of systems that are located behind the law firm's firewall (not pictured). Internal resources 140, in the exemplary embodiment, include a time entry system 141, a documents system 142, a financial system 144, and an entities system 146. In other embodiments, the internal resources 140 might include additional databases, systems or information regarding email, docketing, internal news data and the like.

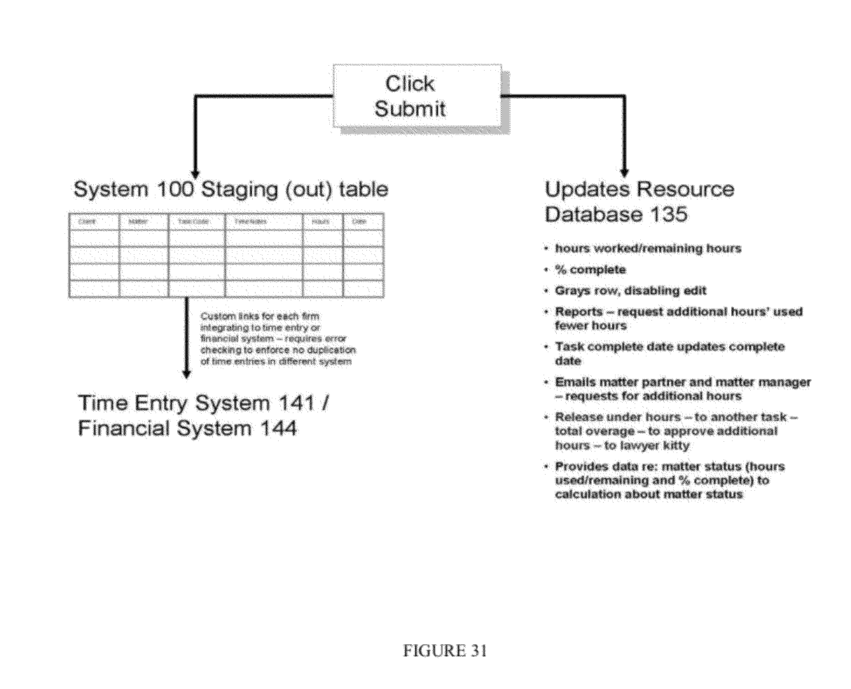

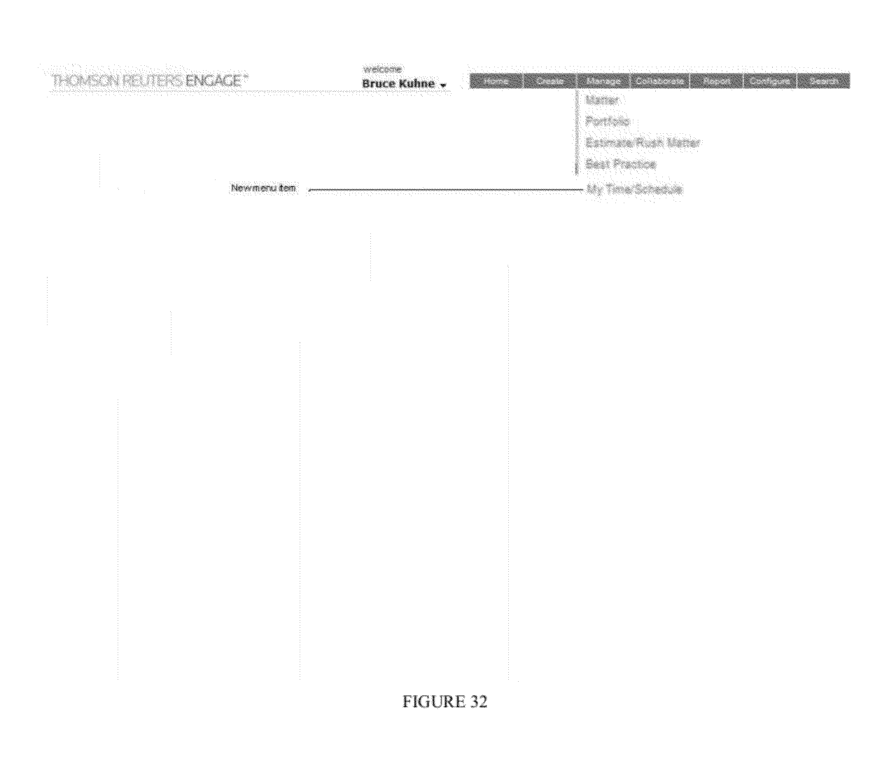

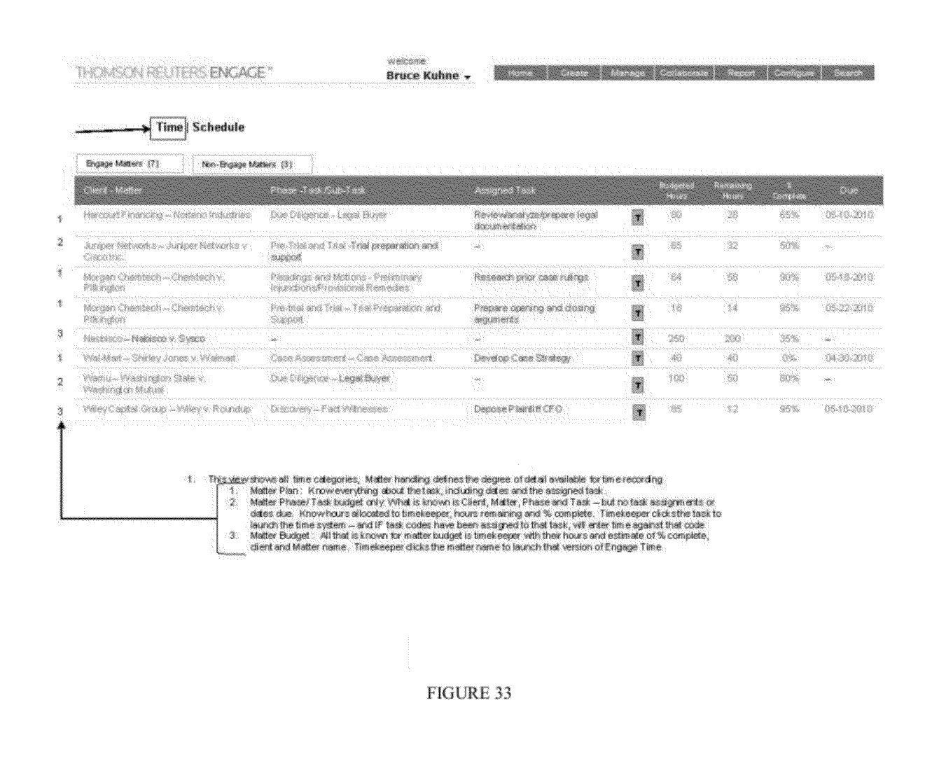

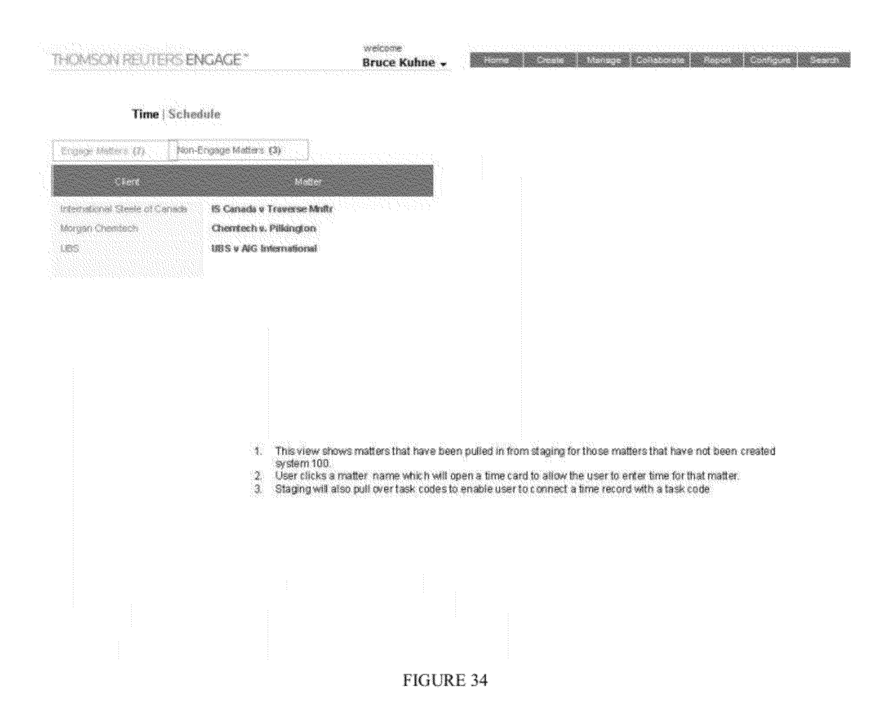

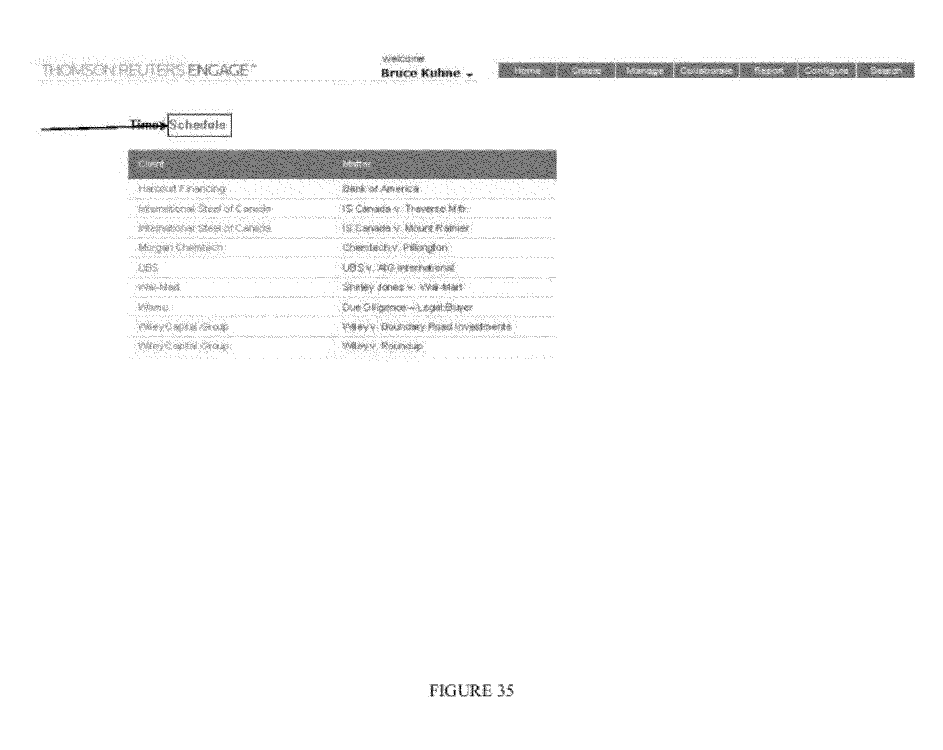

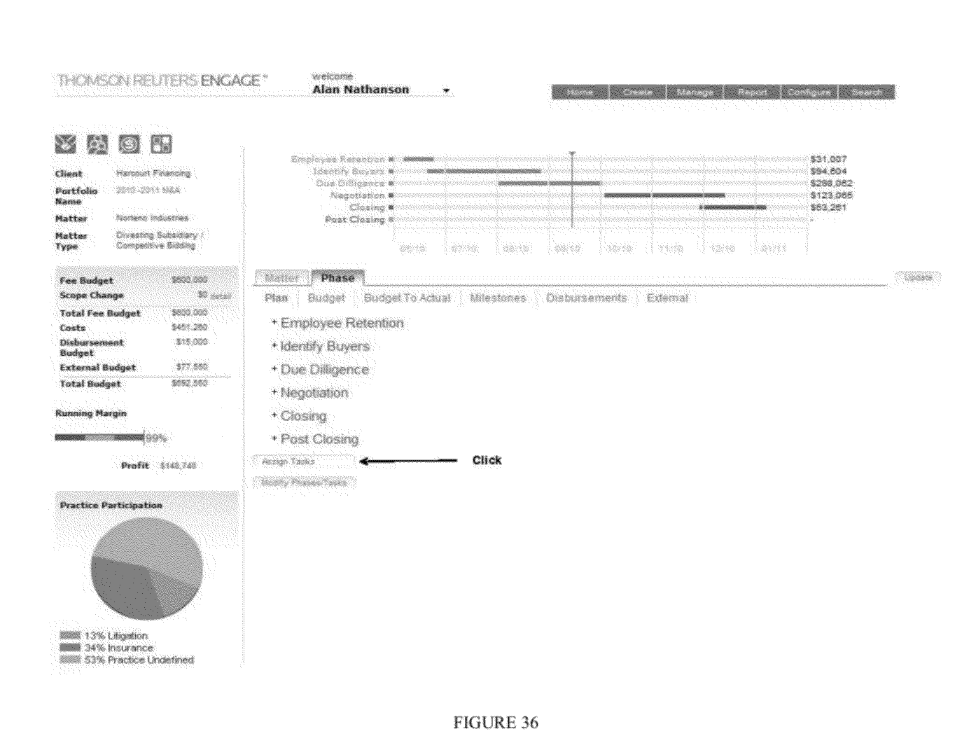

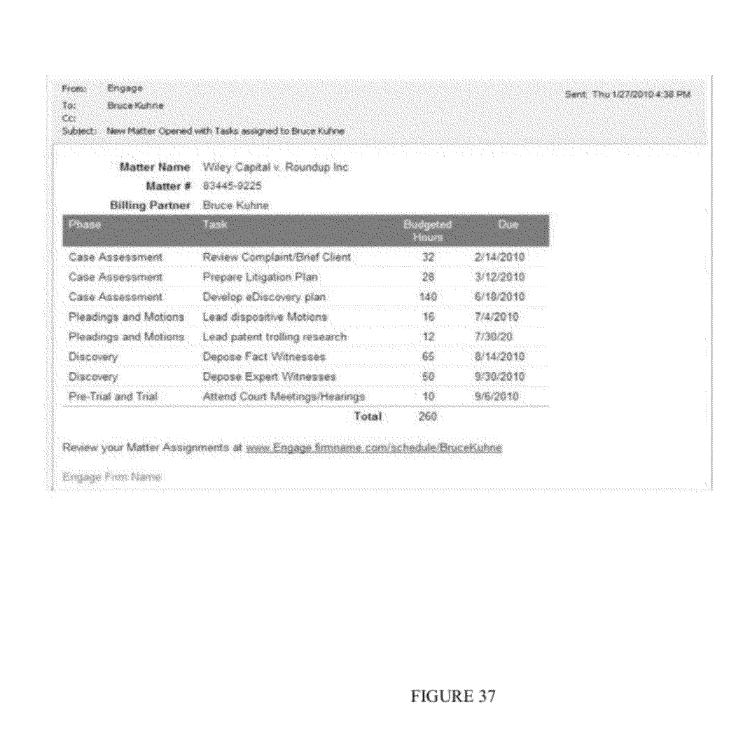

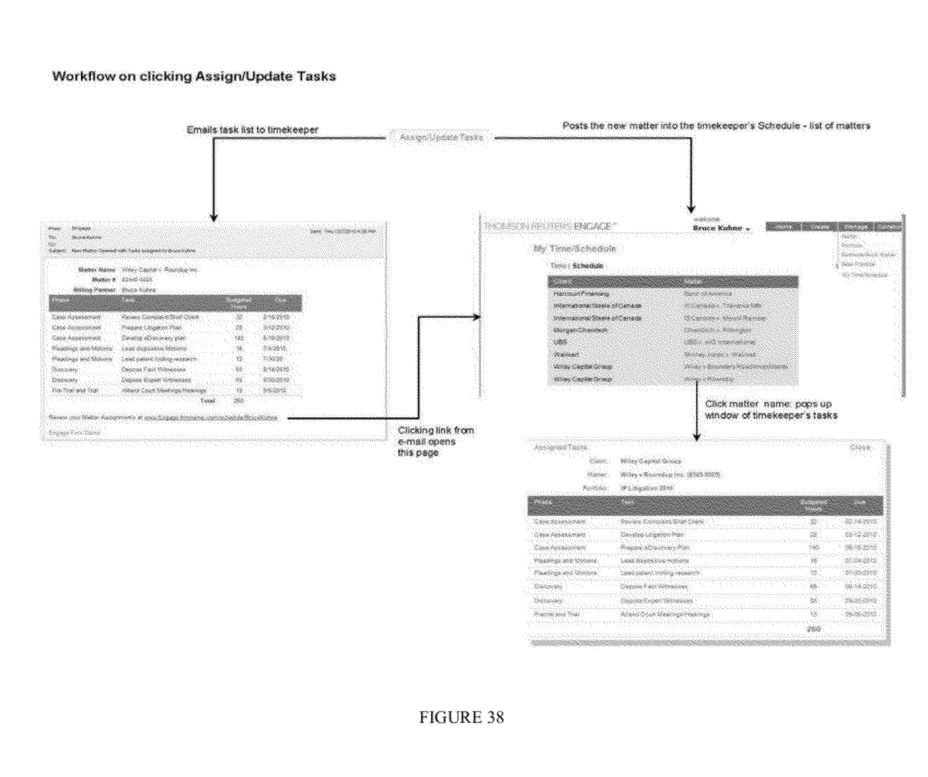

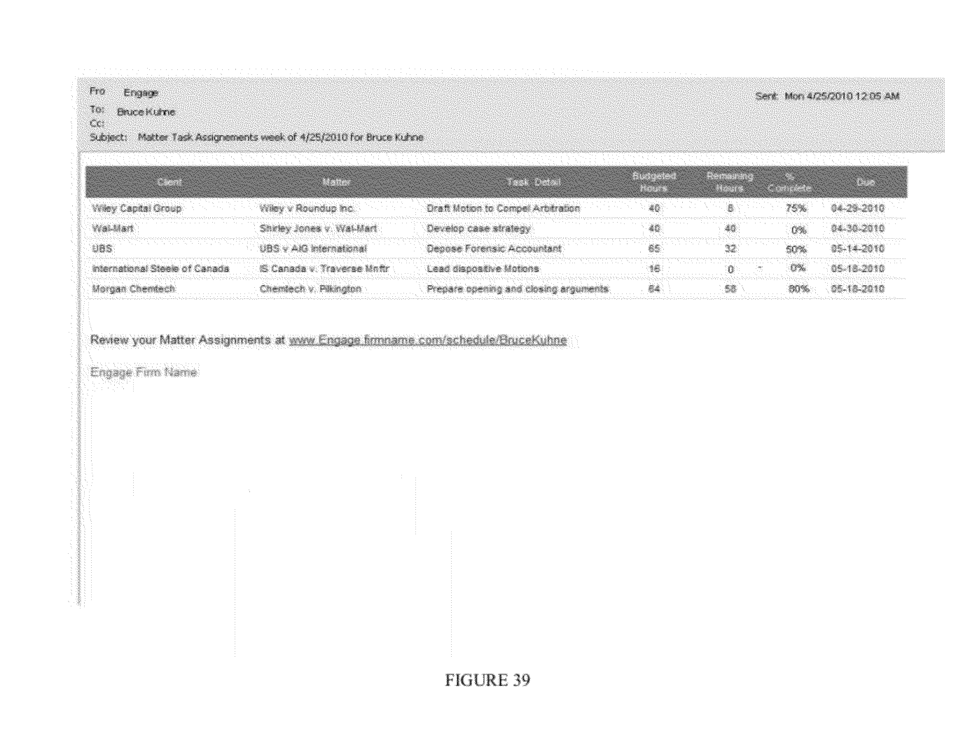

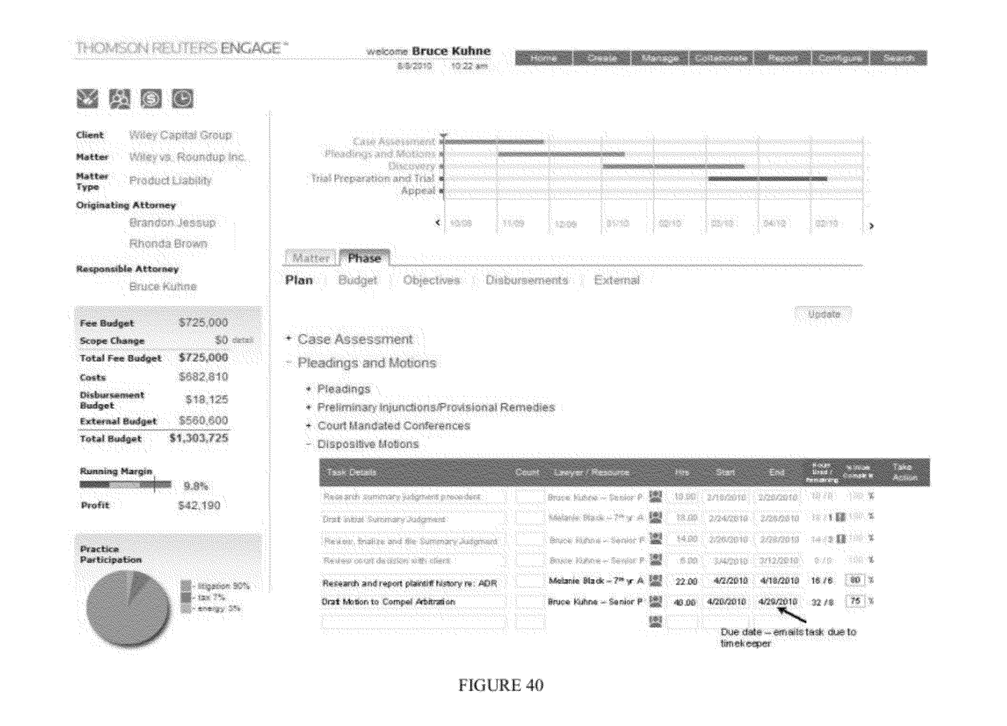

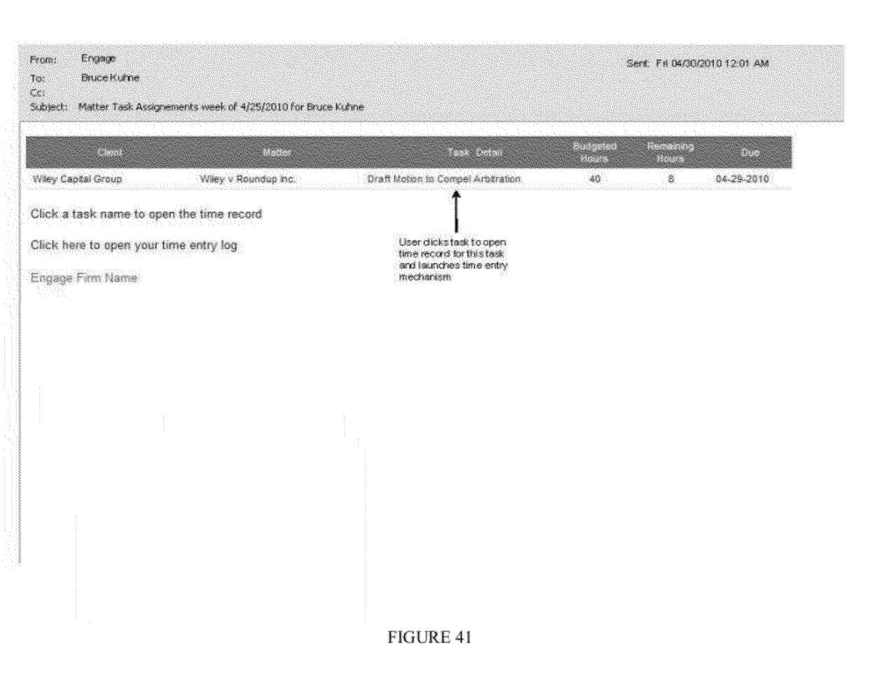

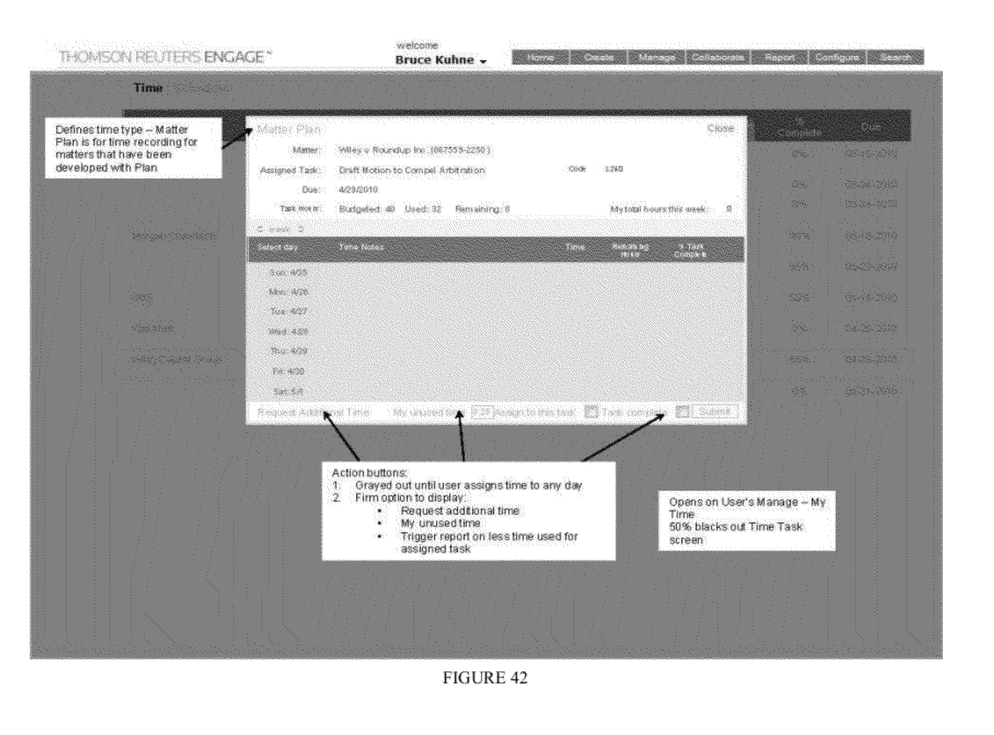

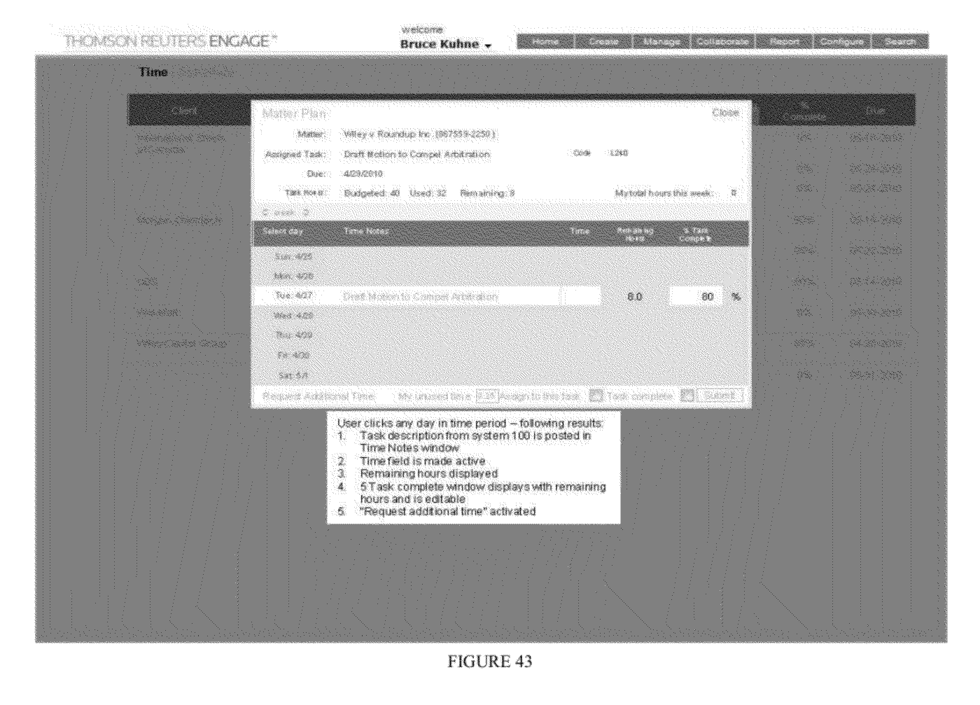

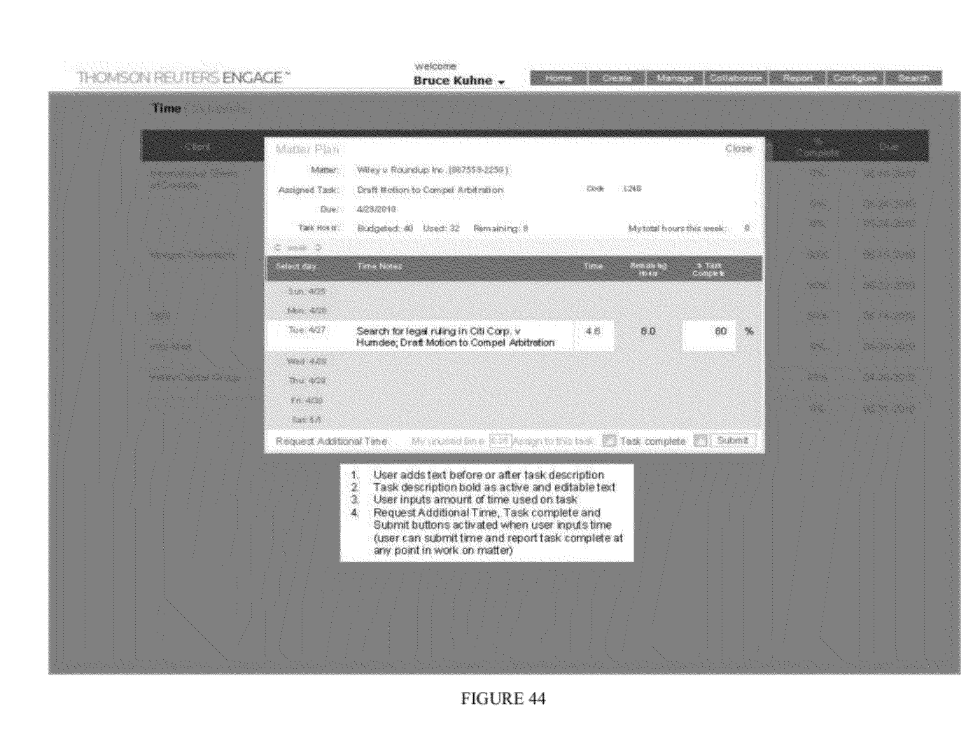

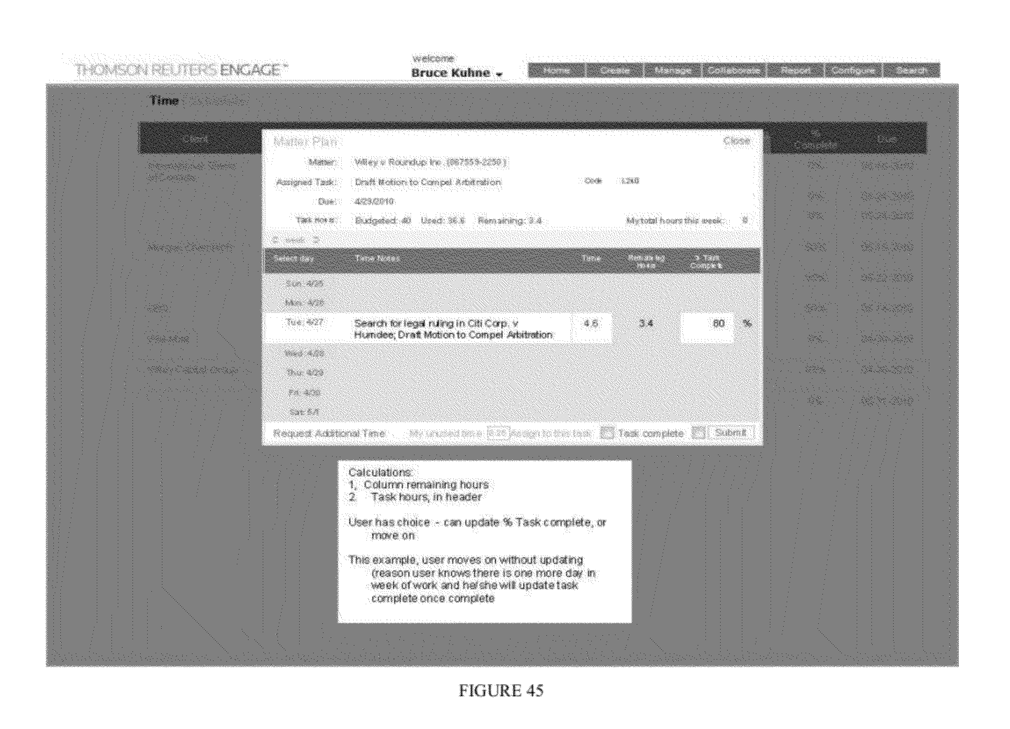

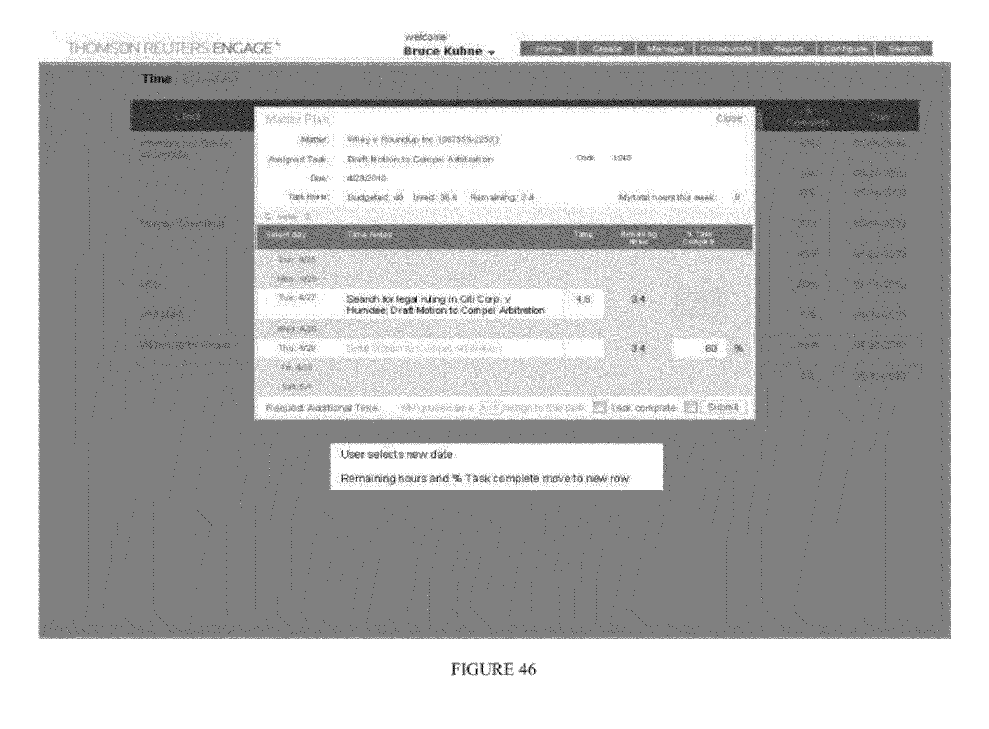

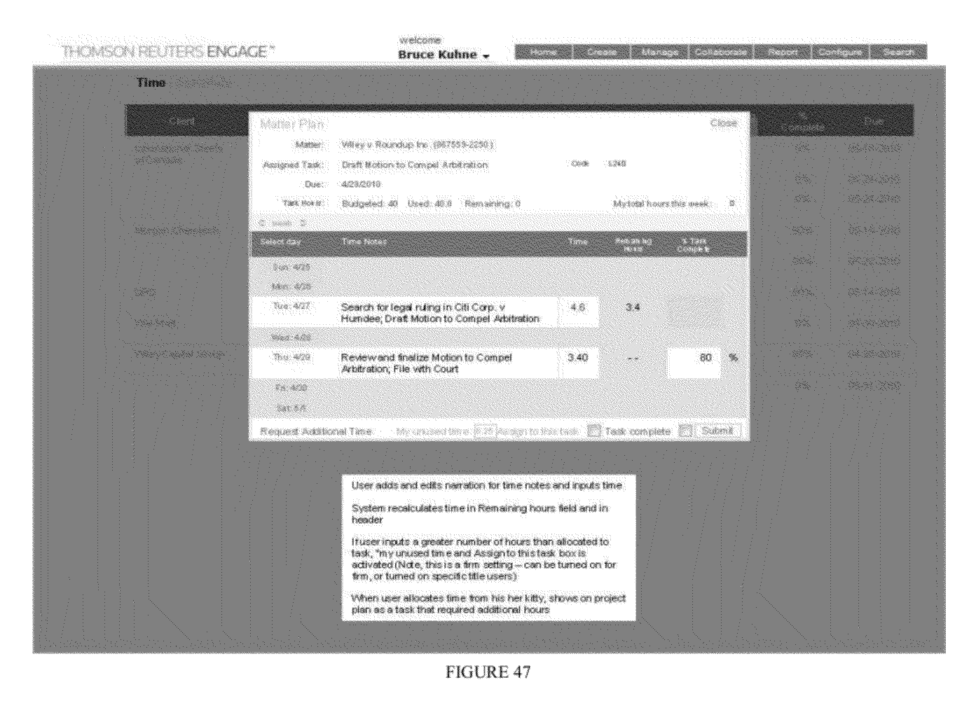

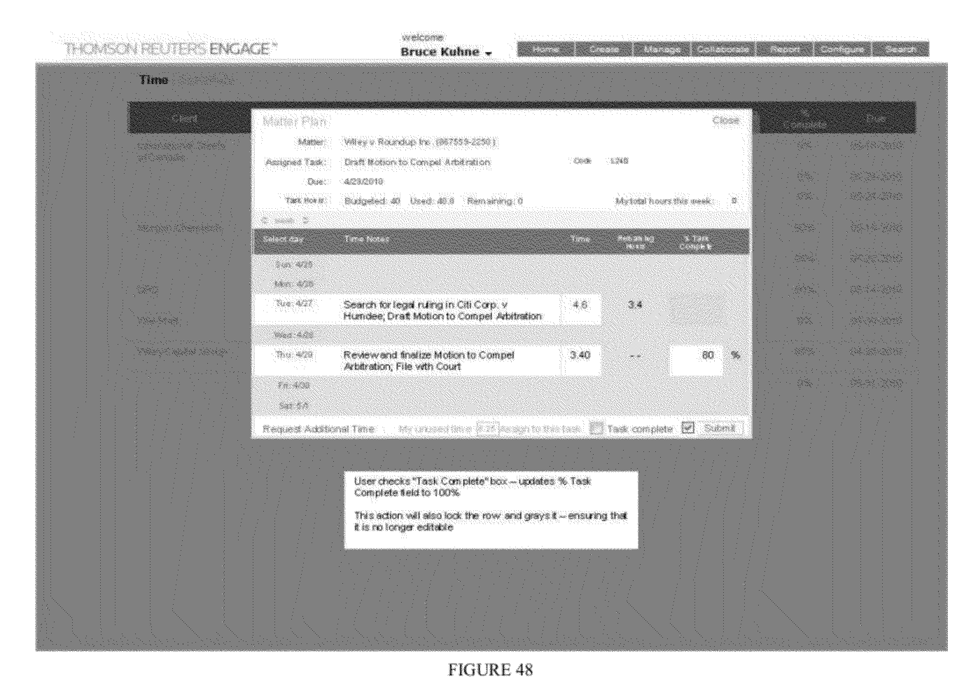

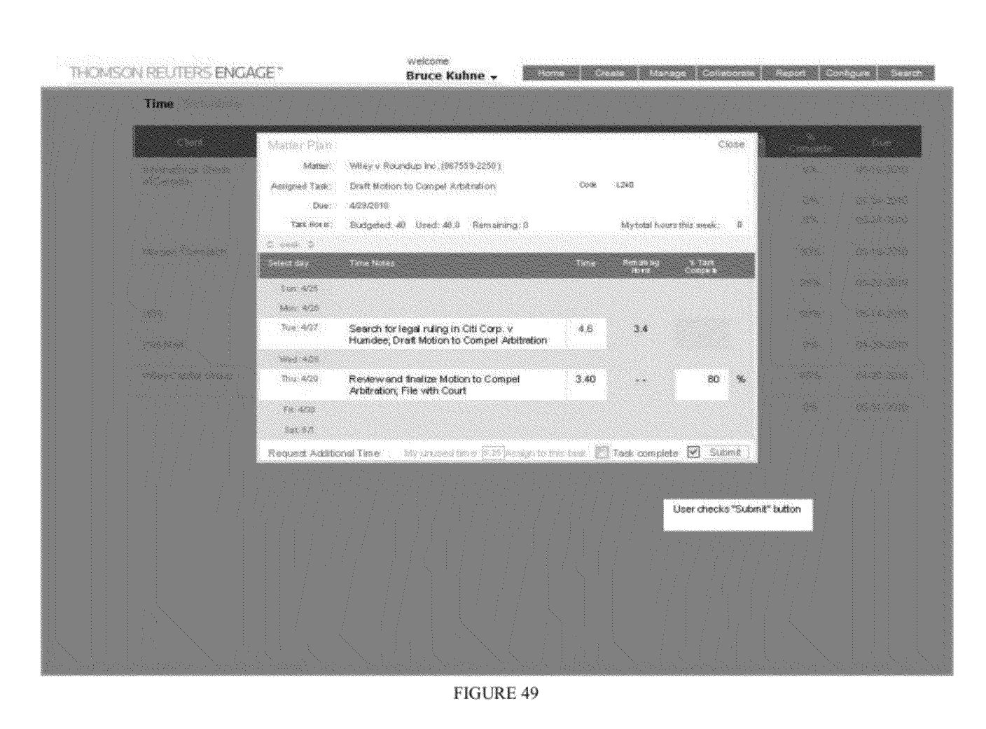

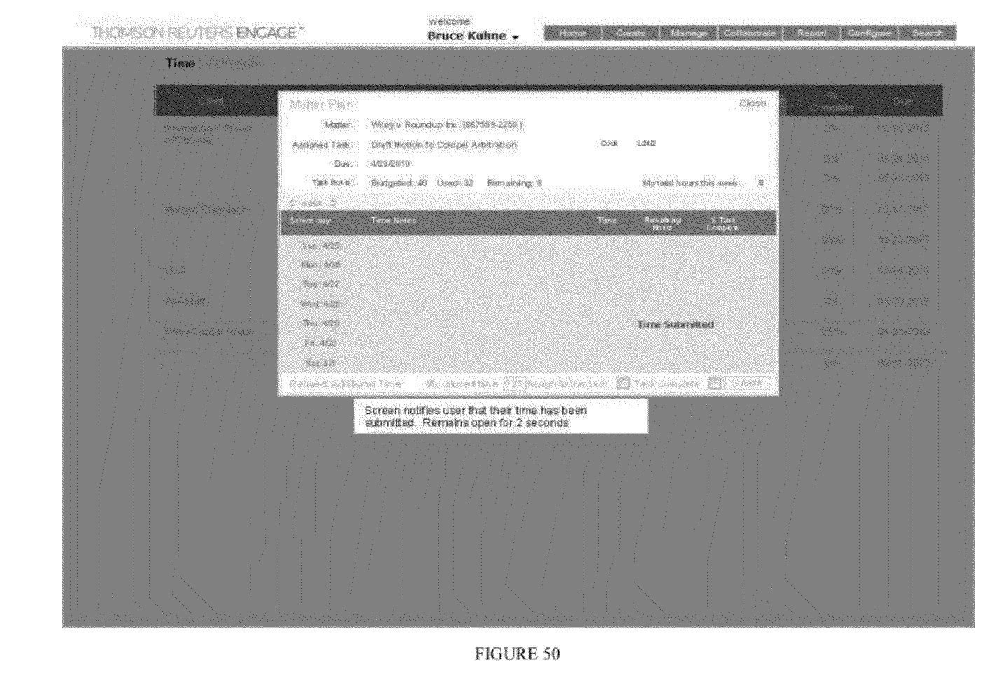

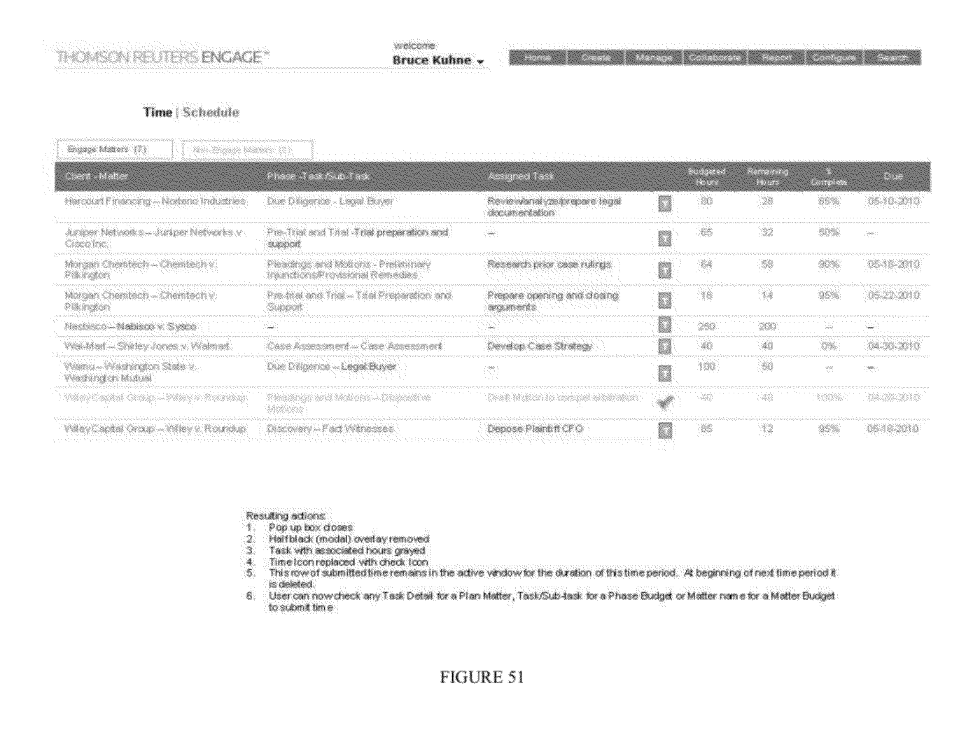

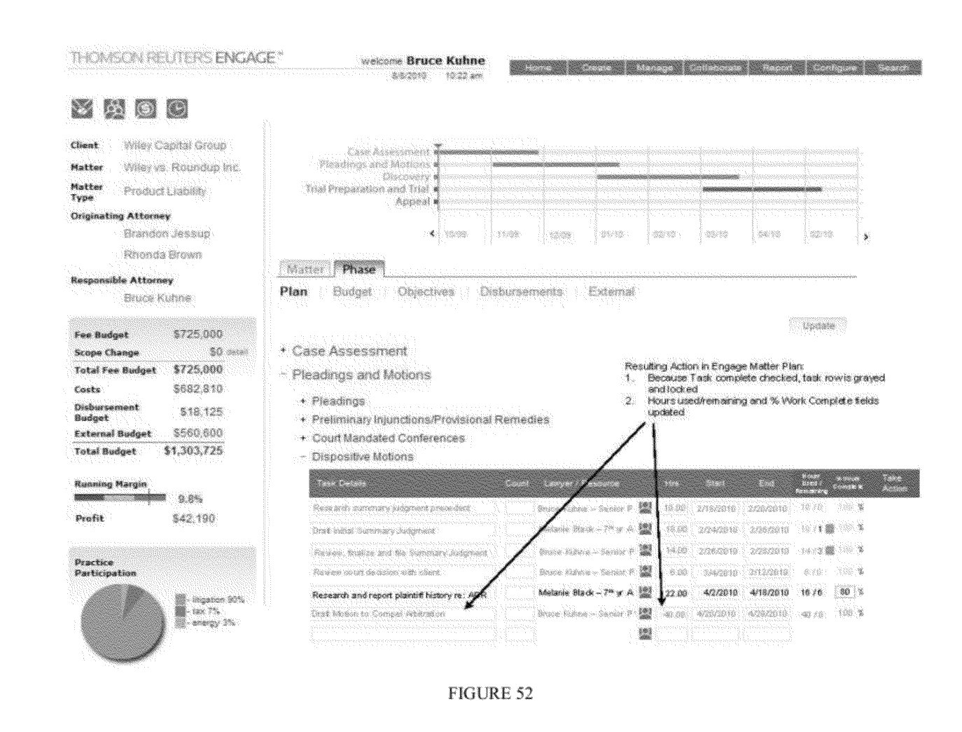

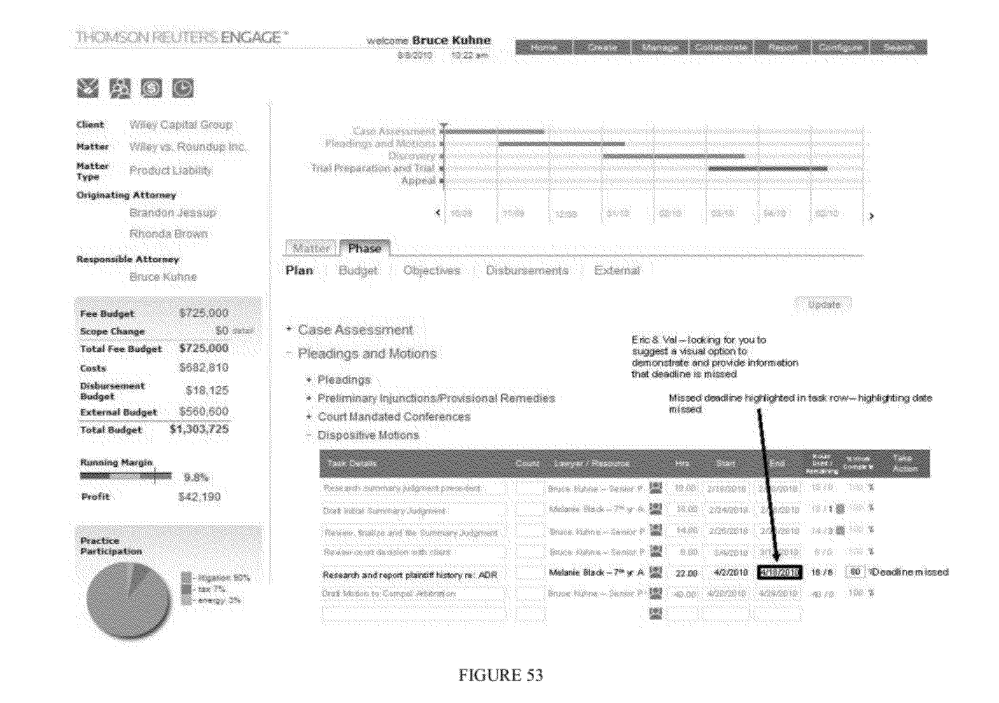

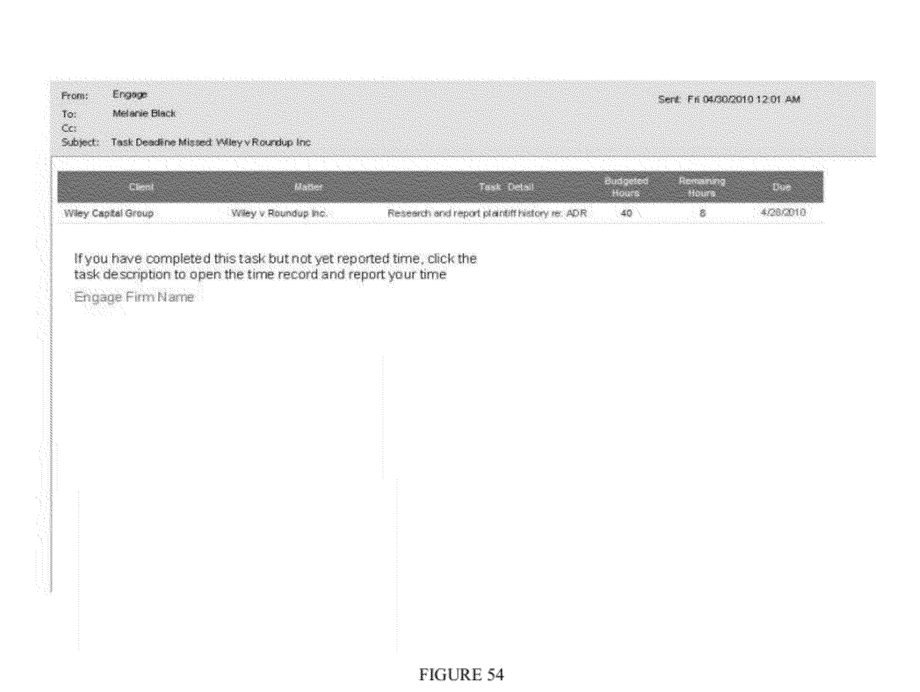

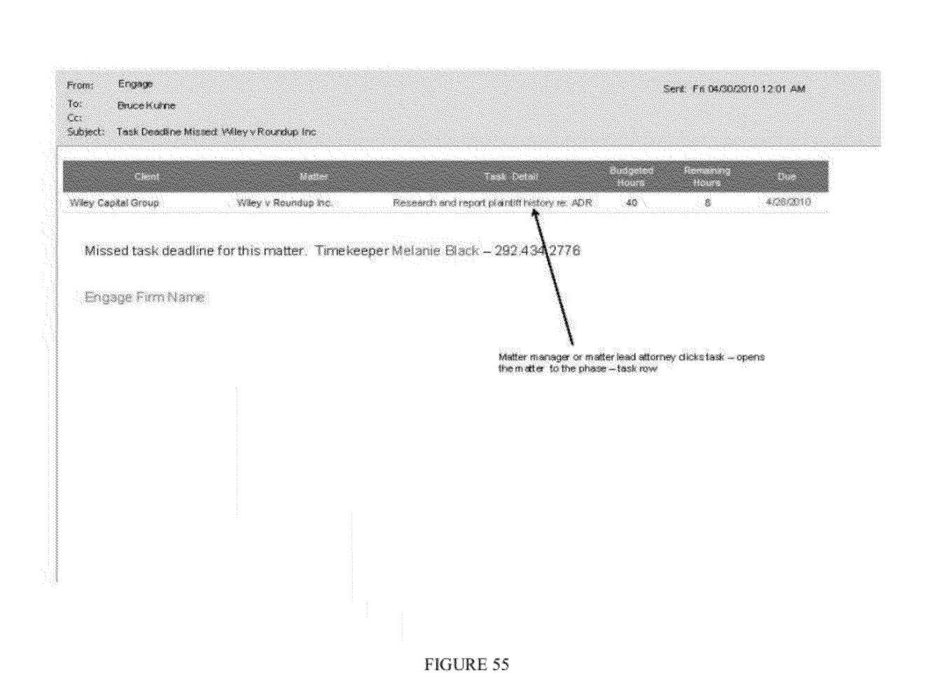

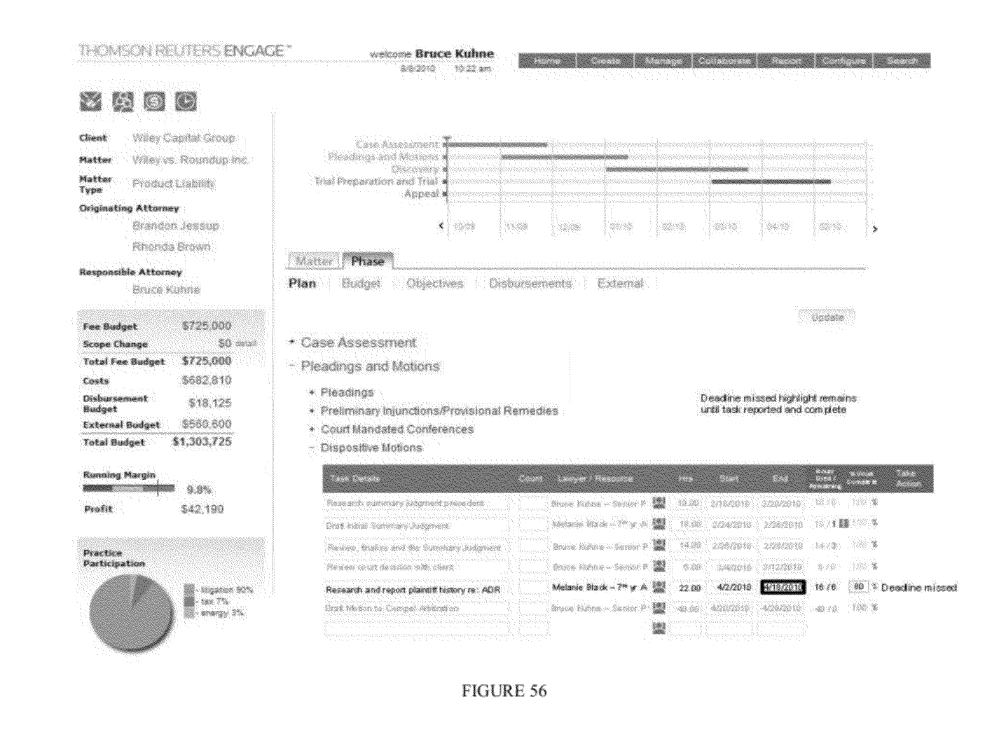

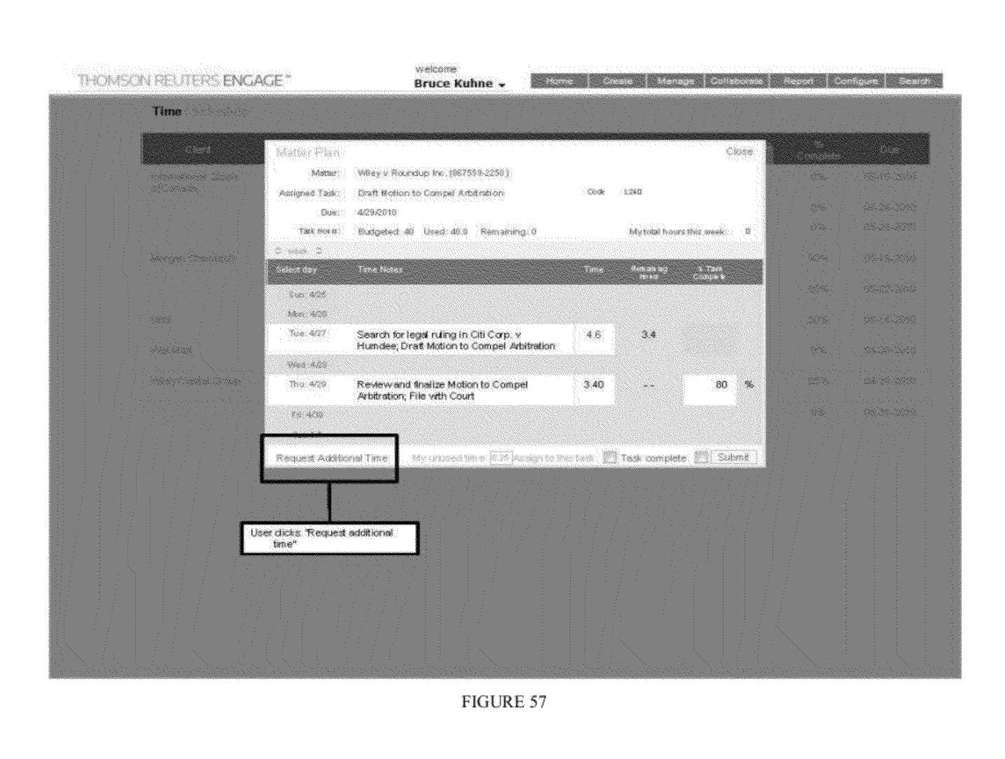

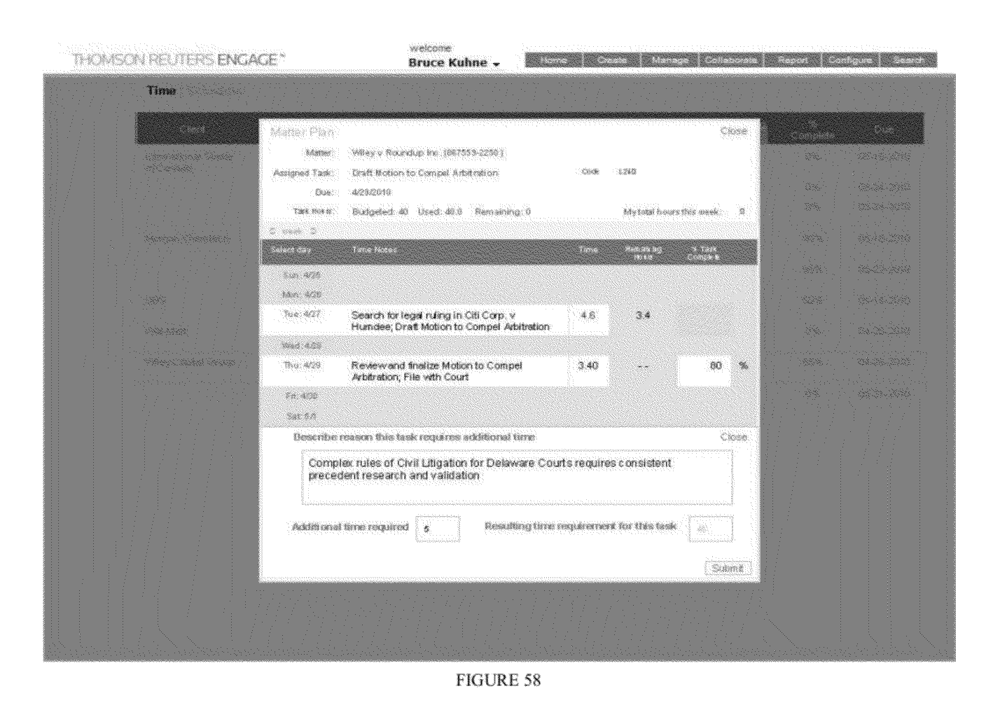

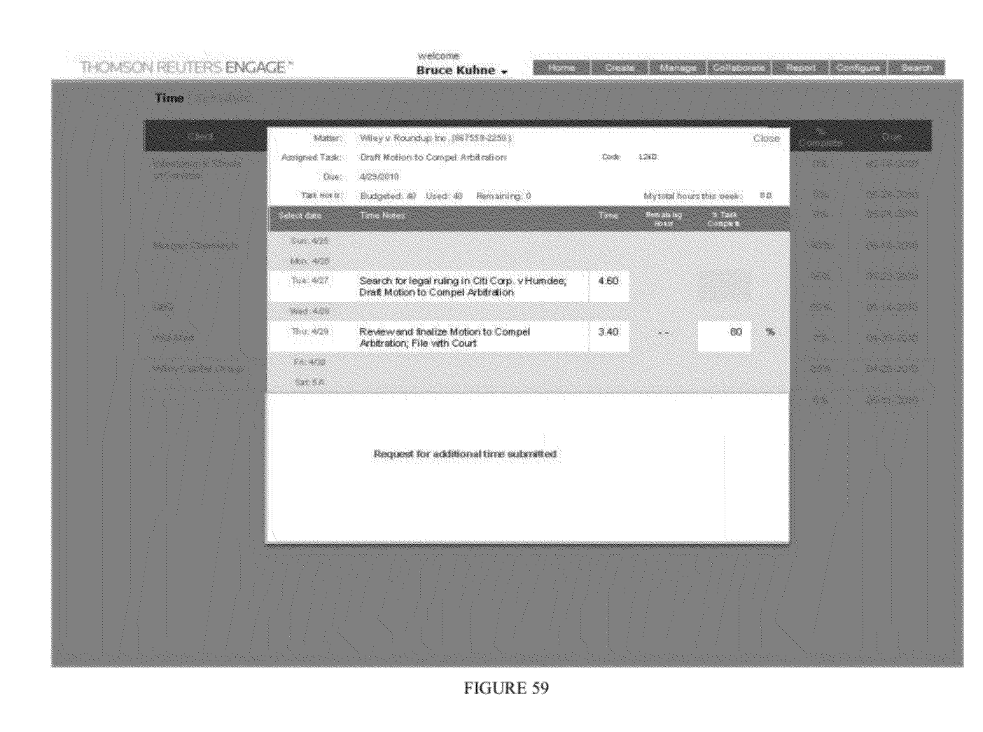

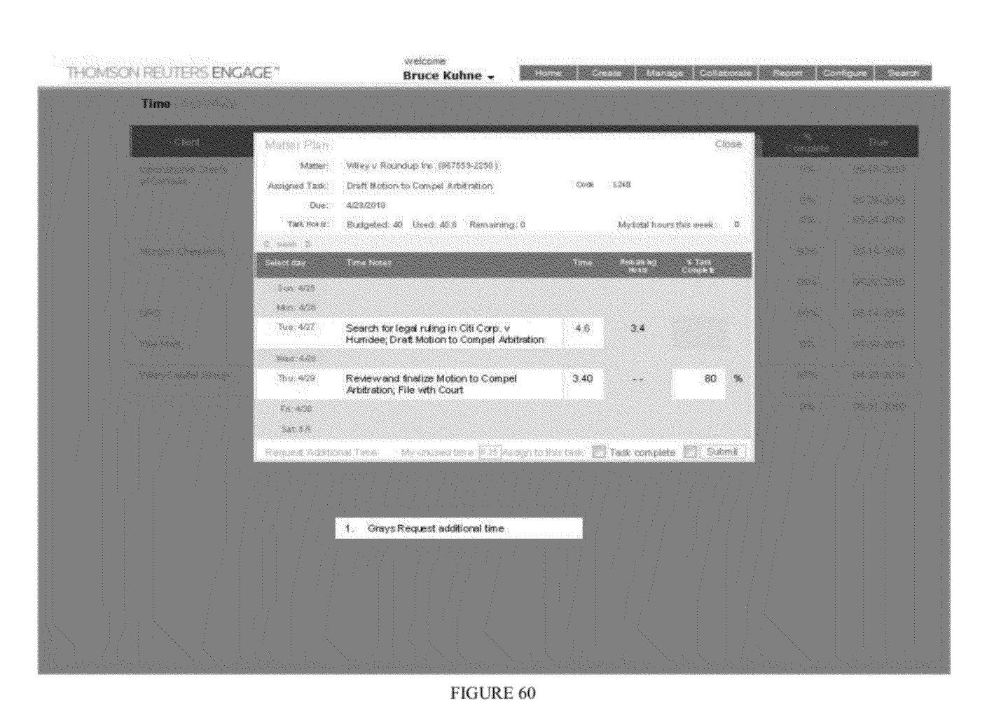

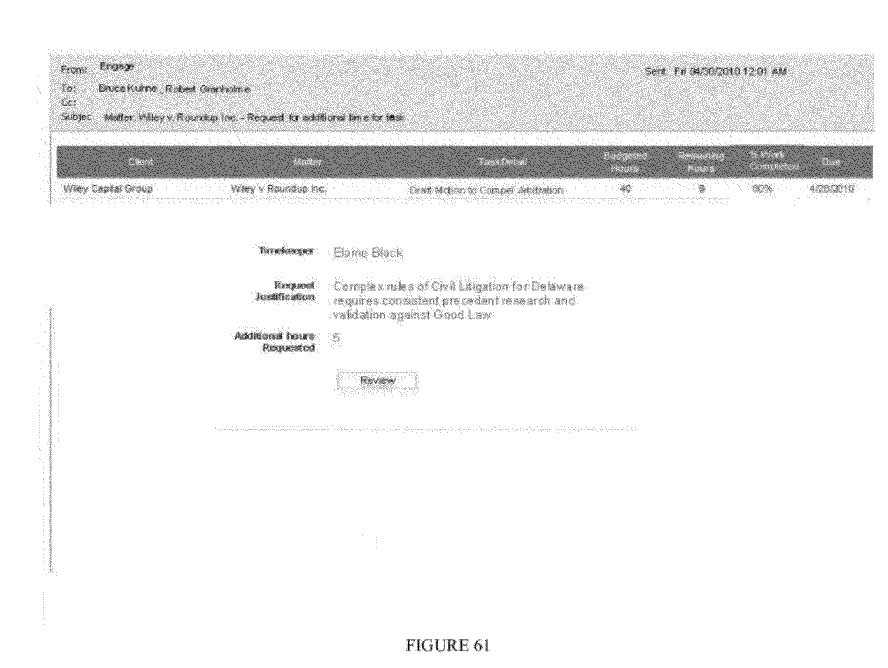

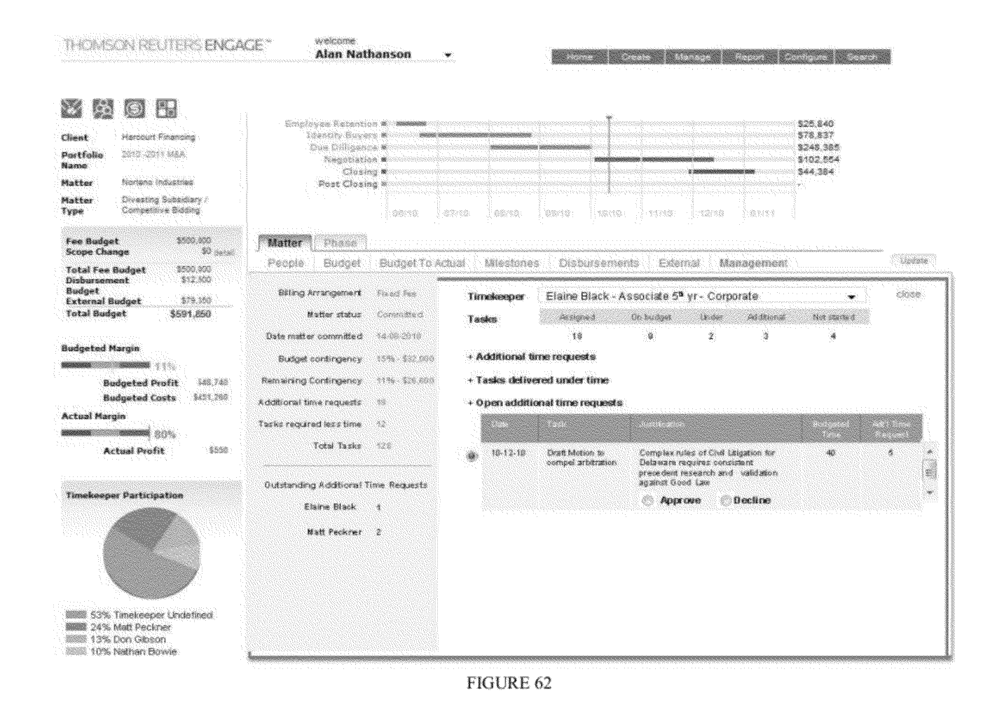

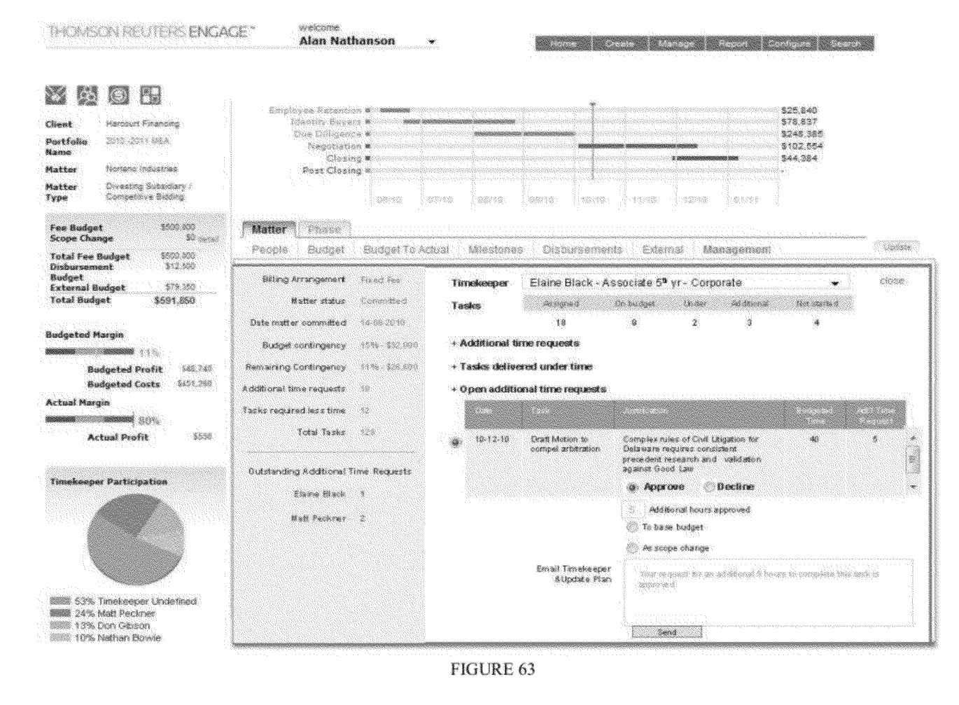

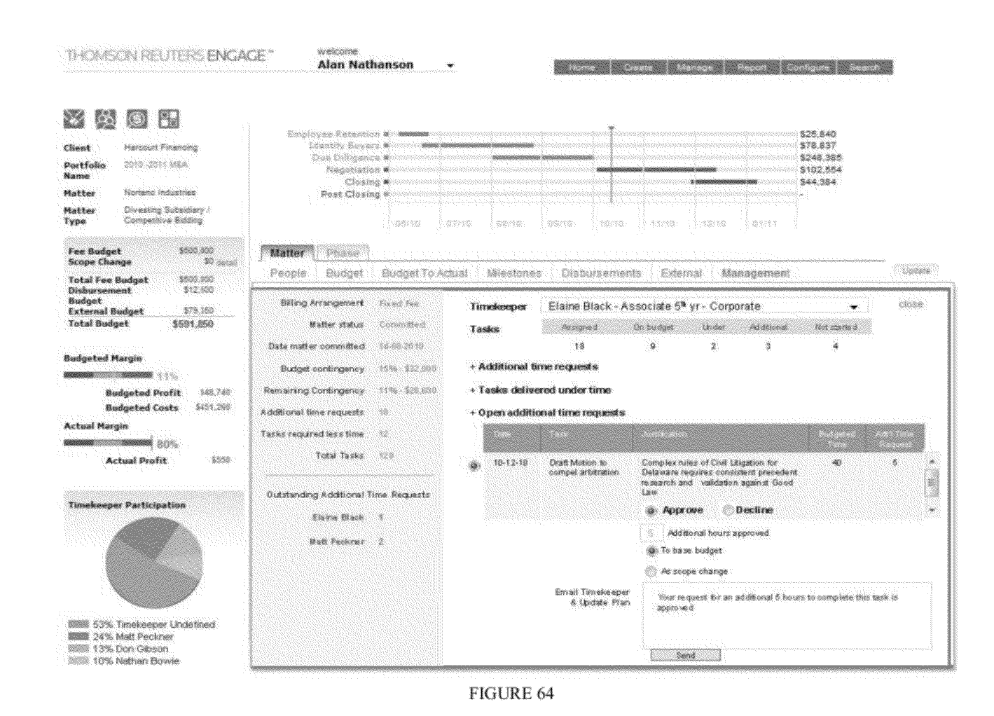

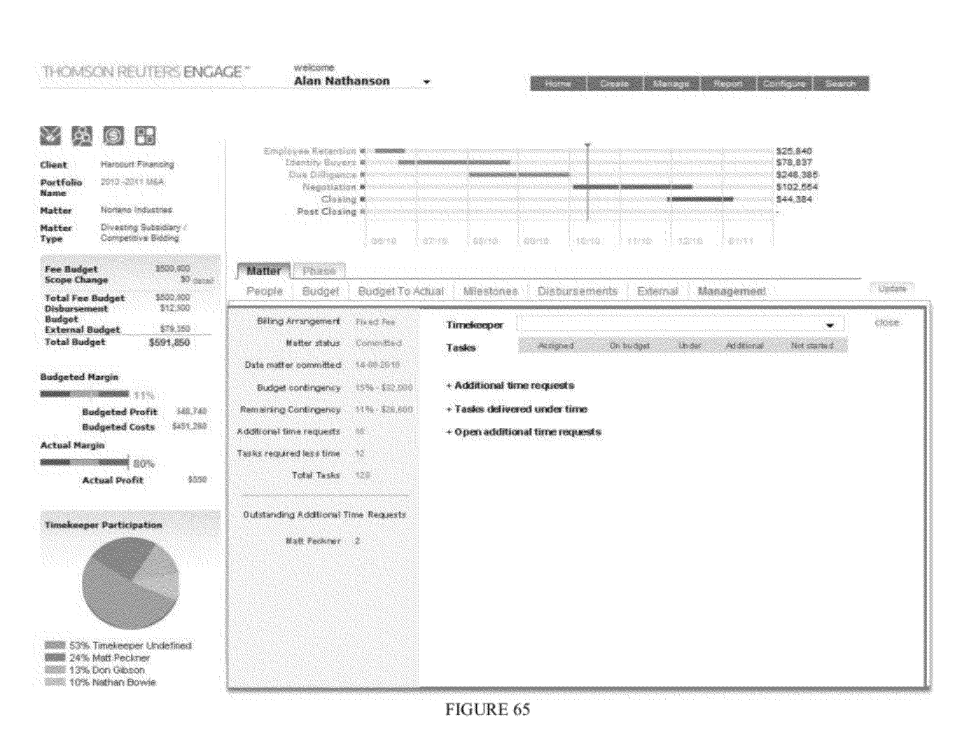

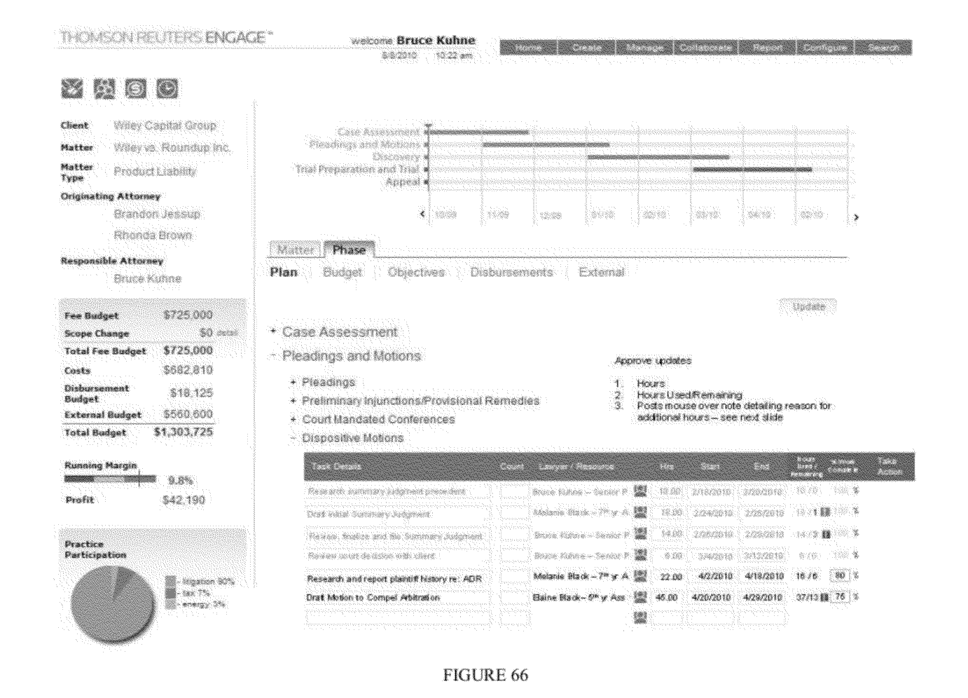

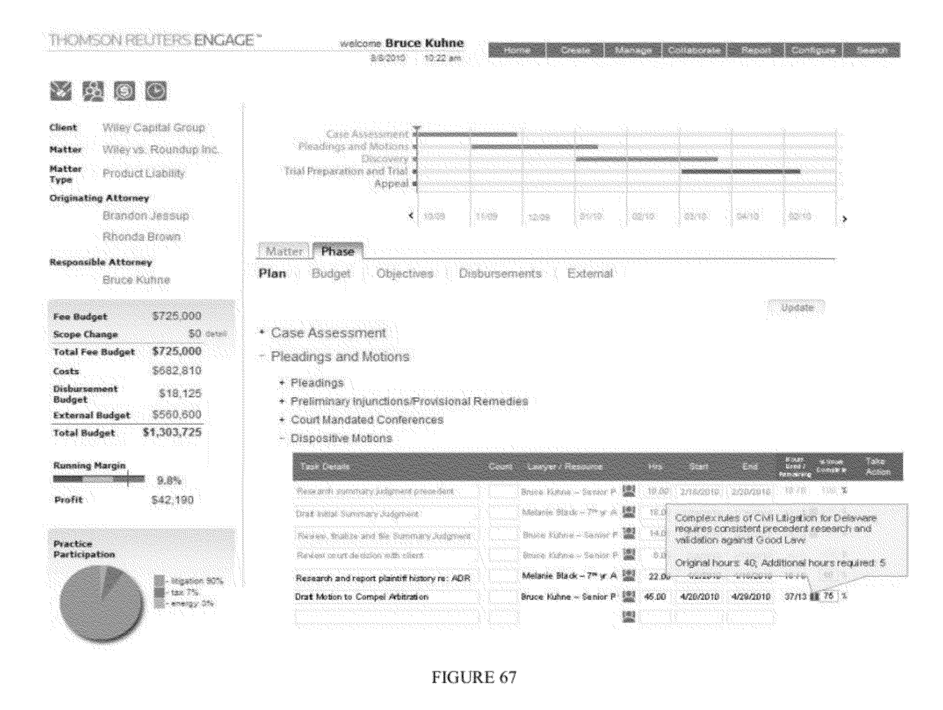

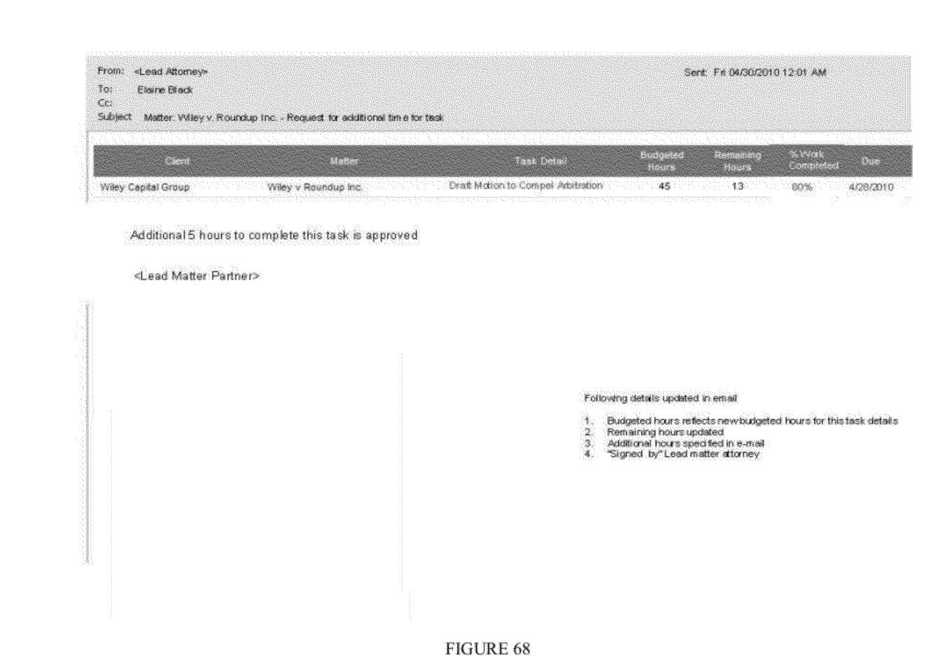

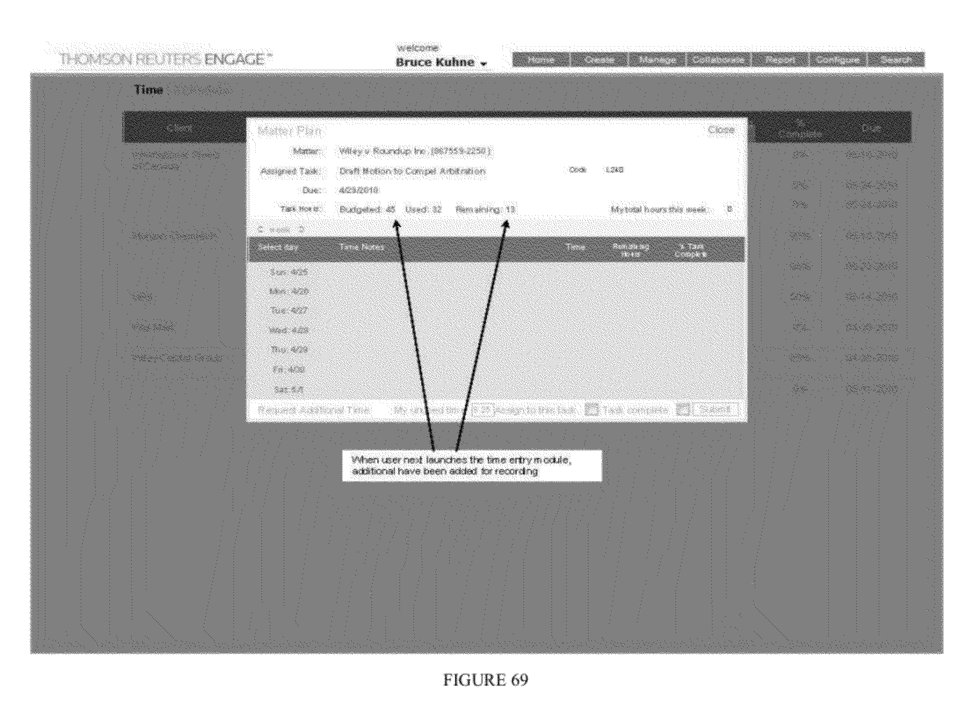

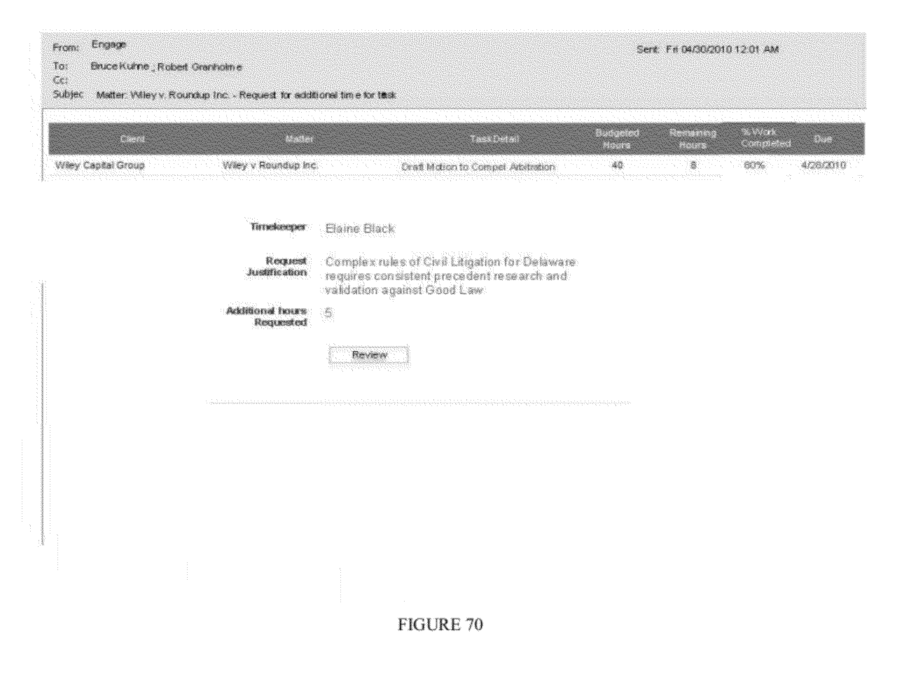

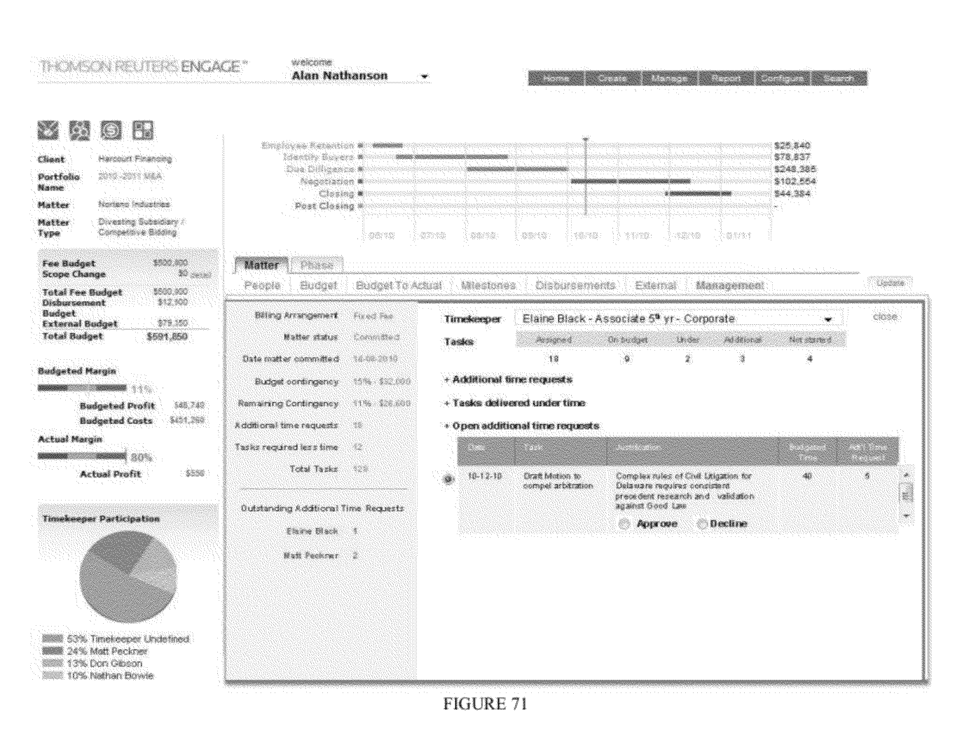

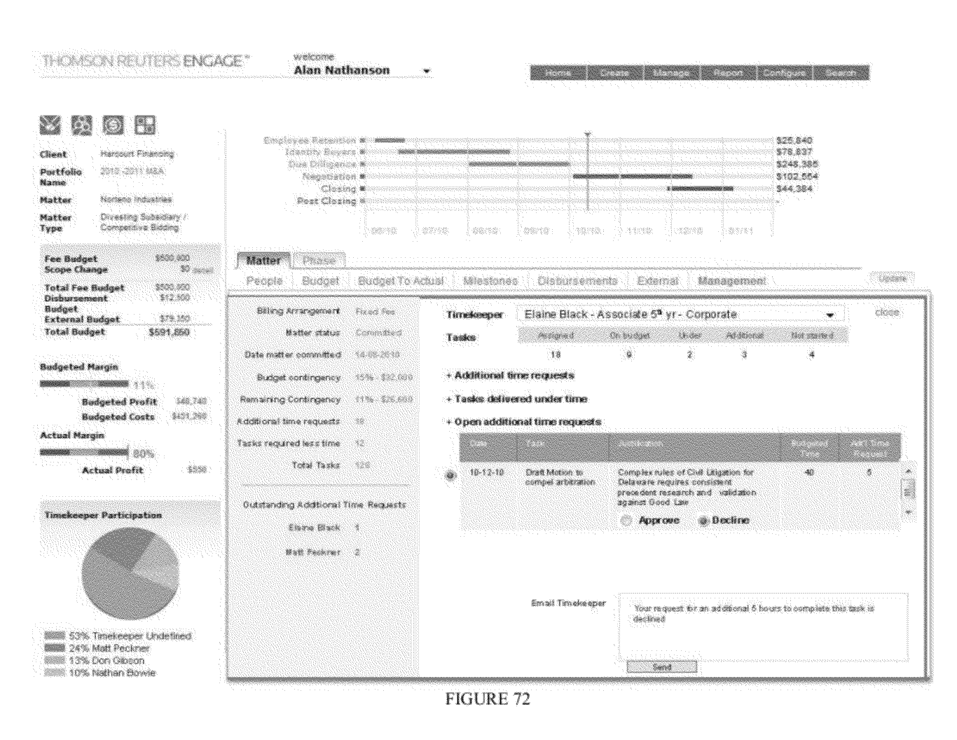

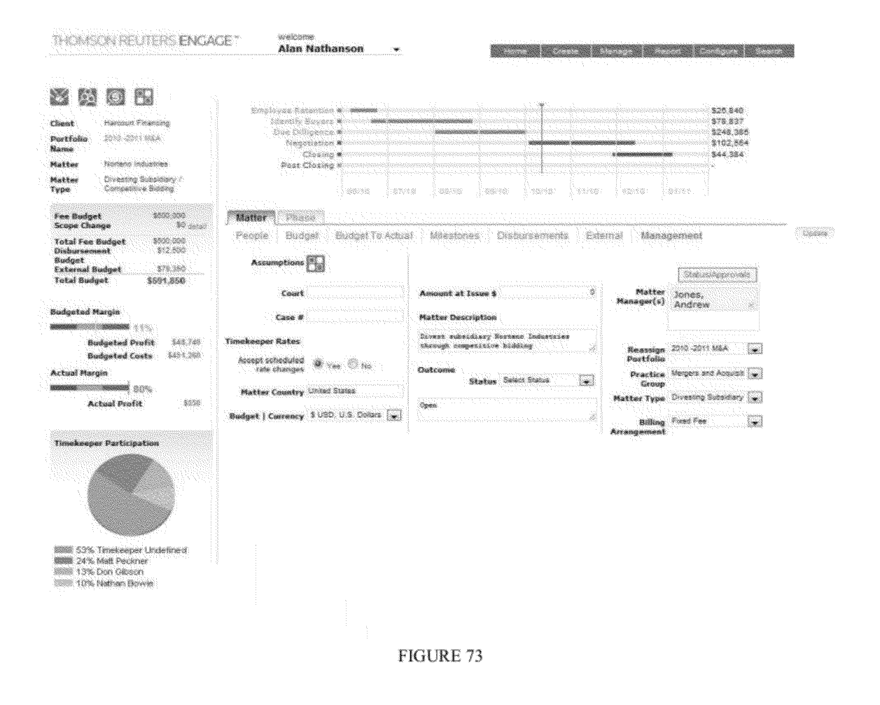

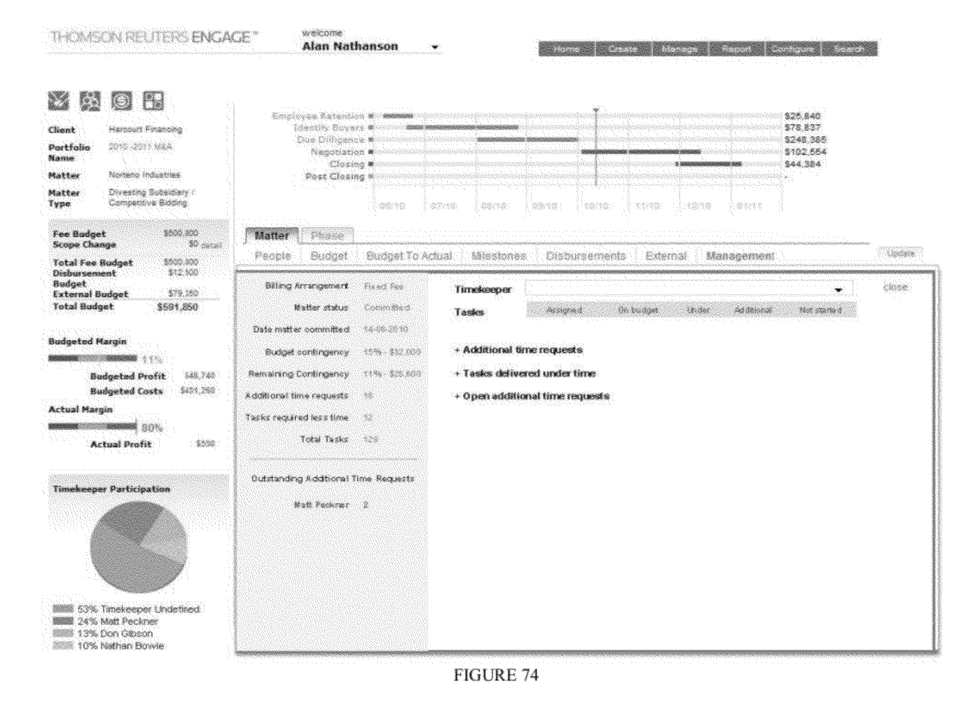

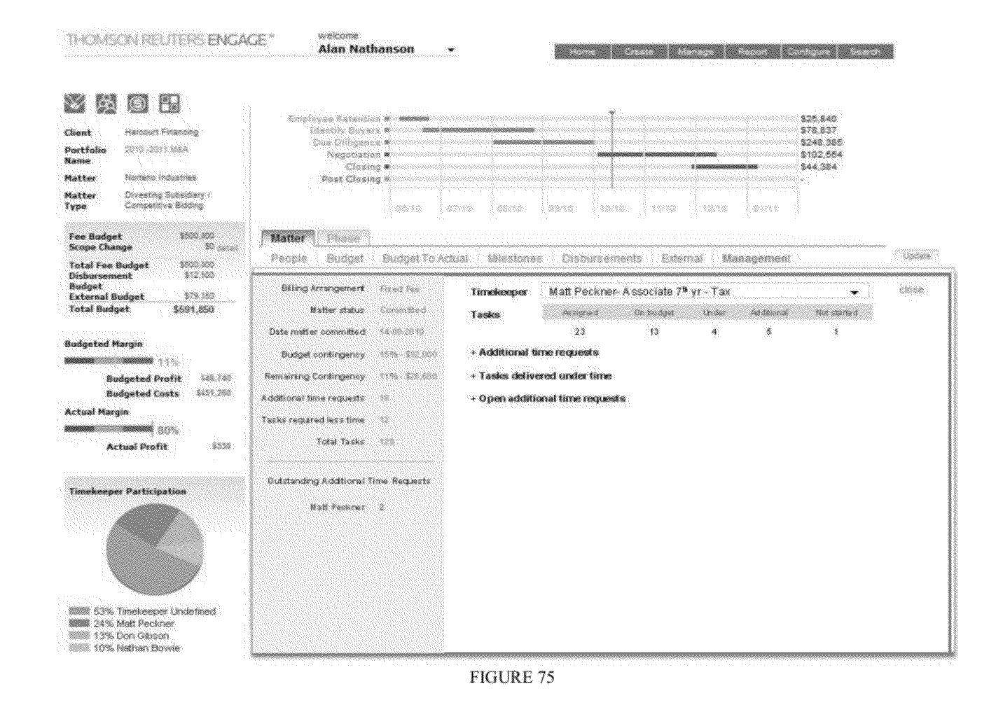

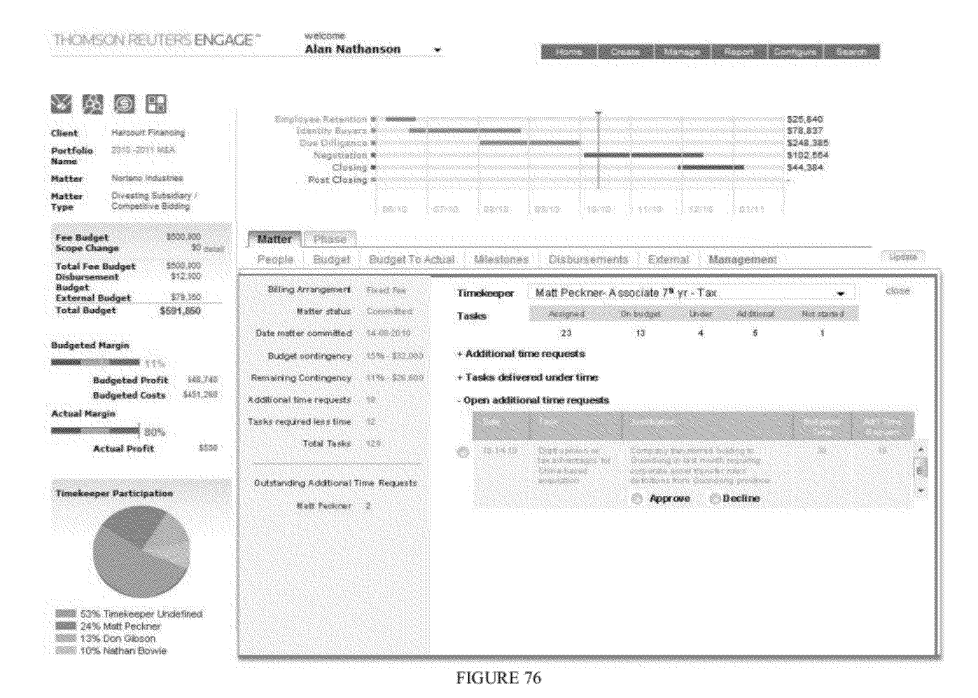

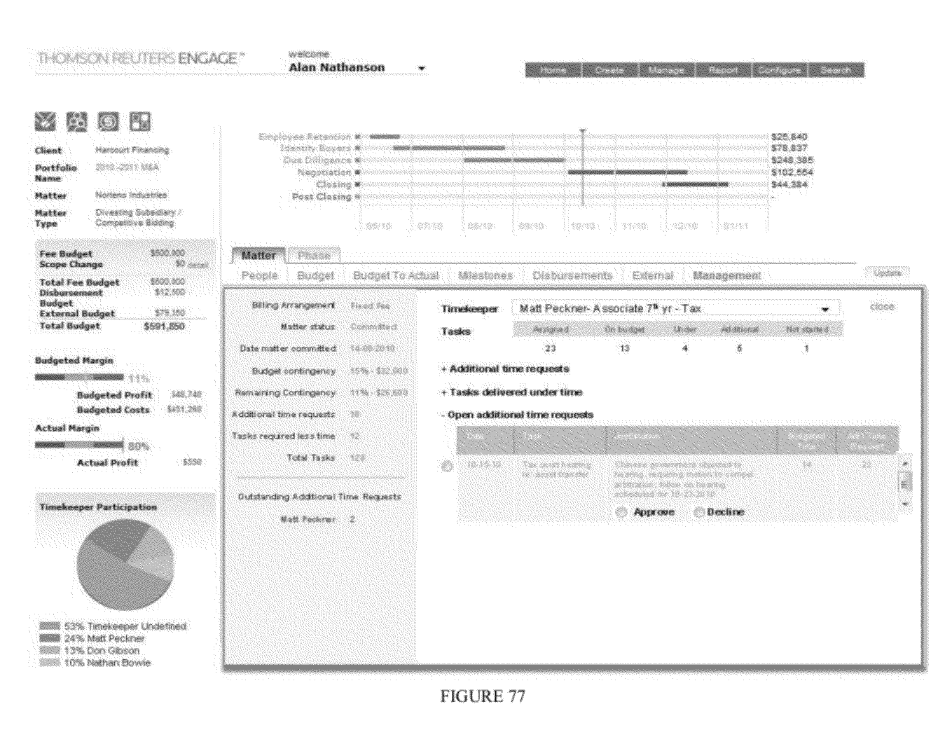

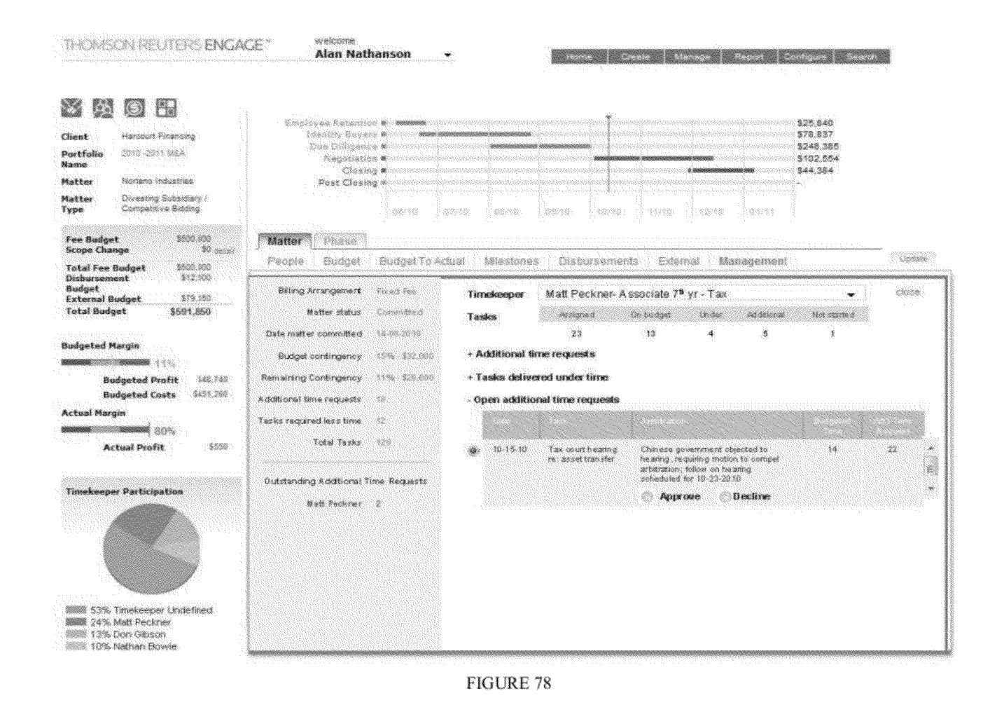

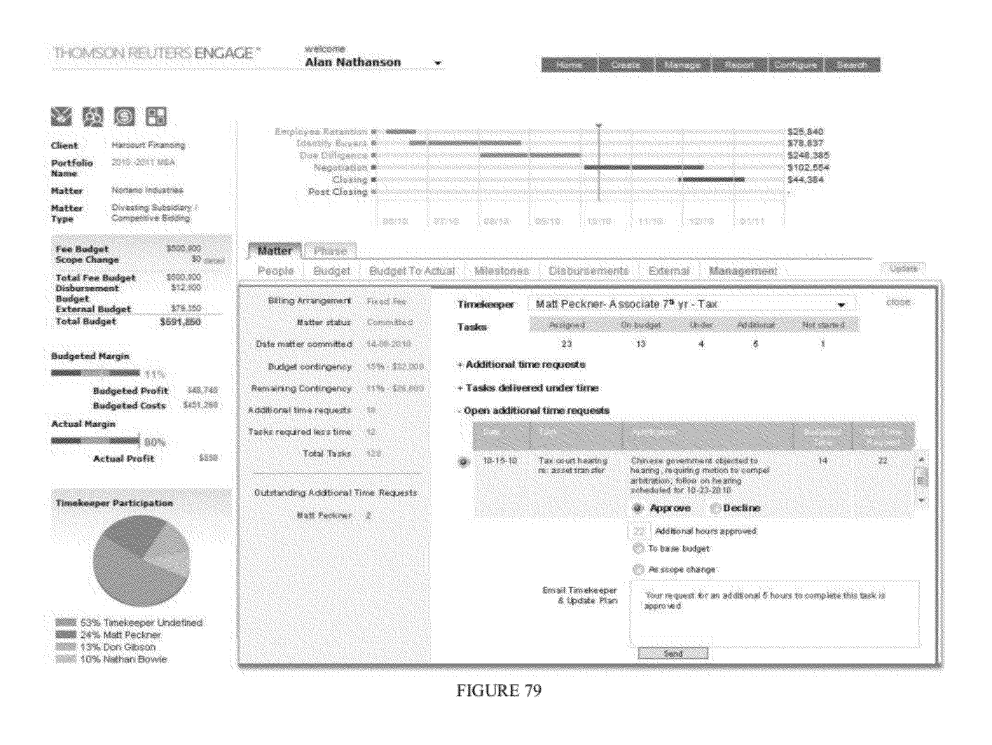

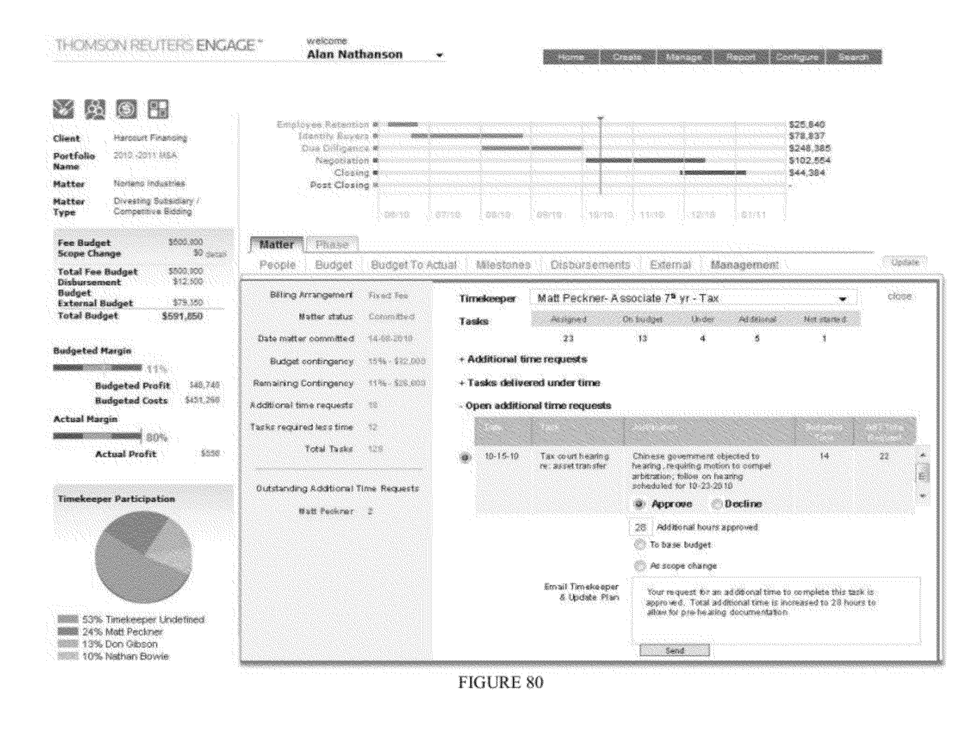

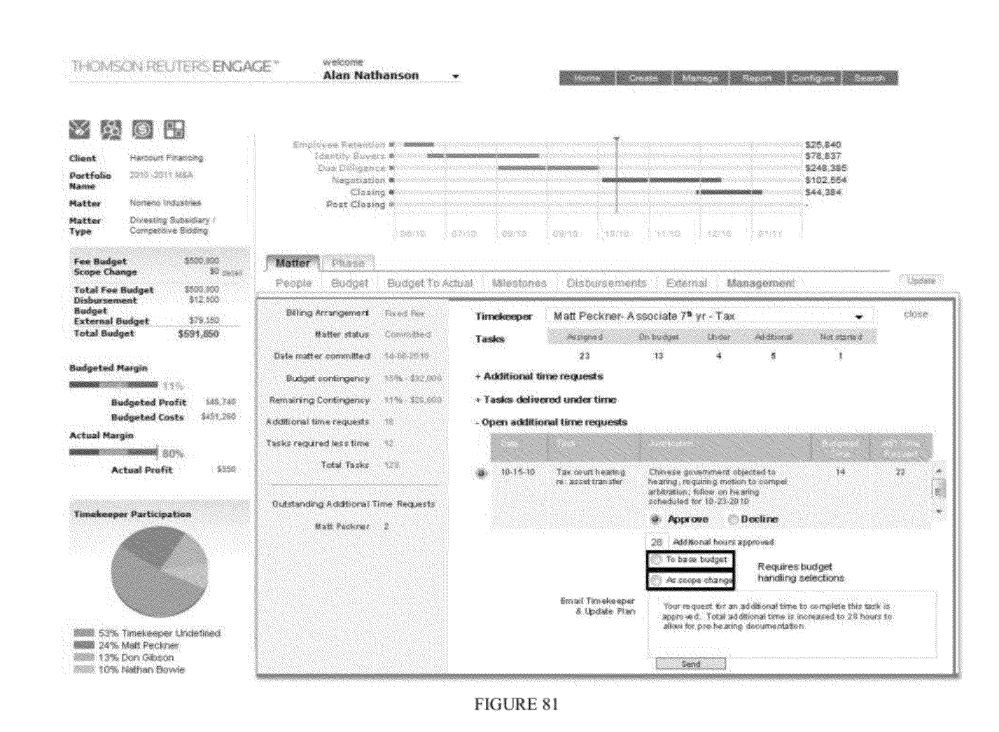

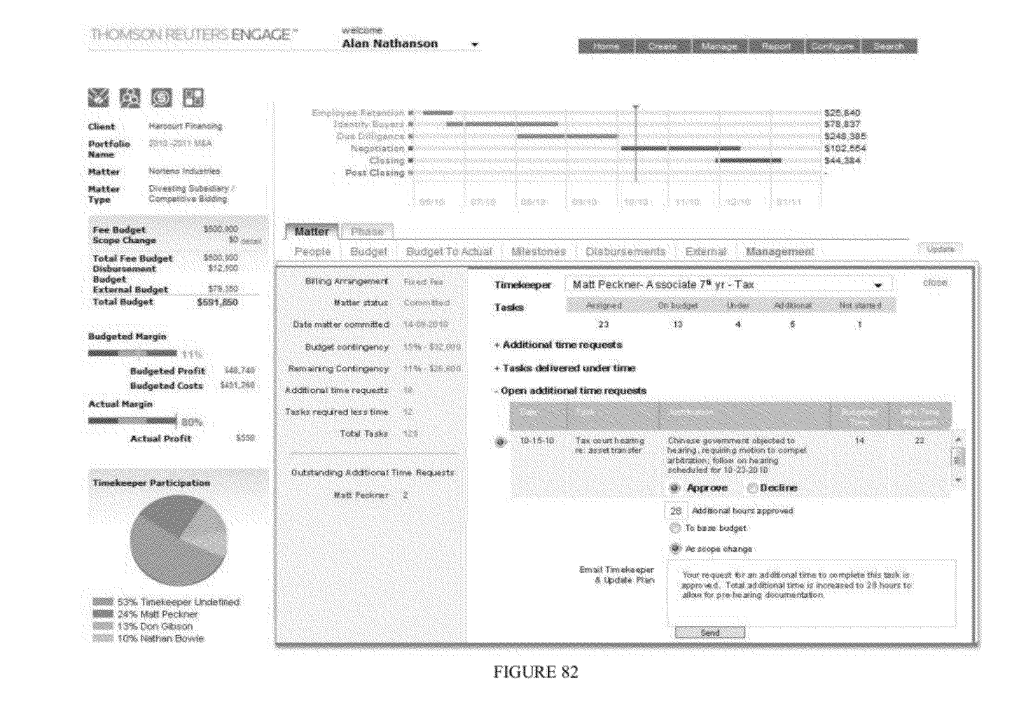

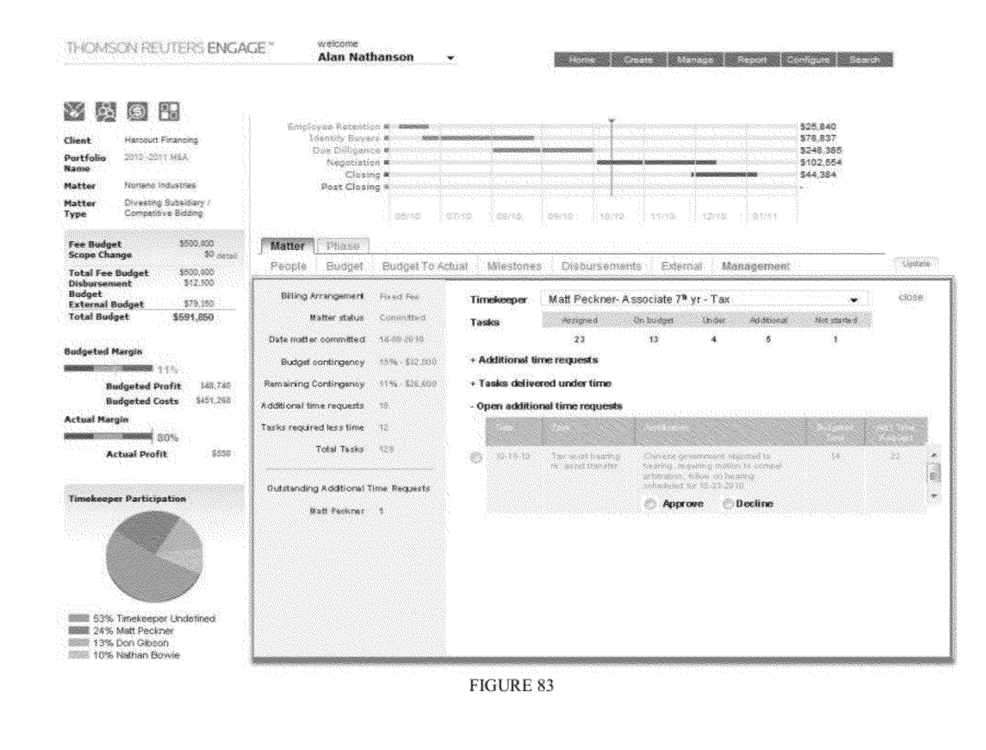

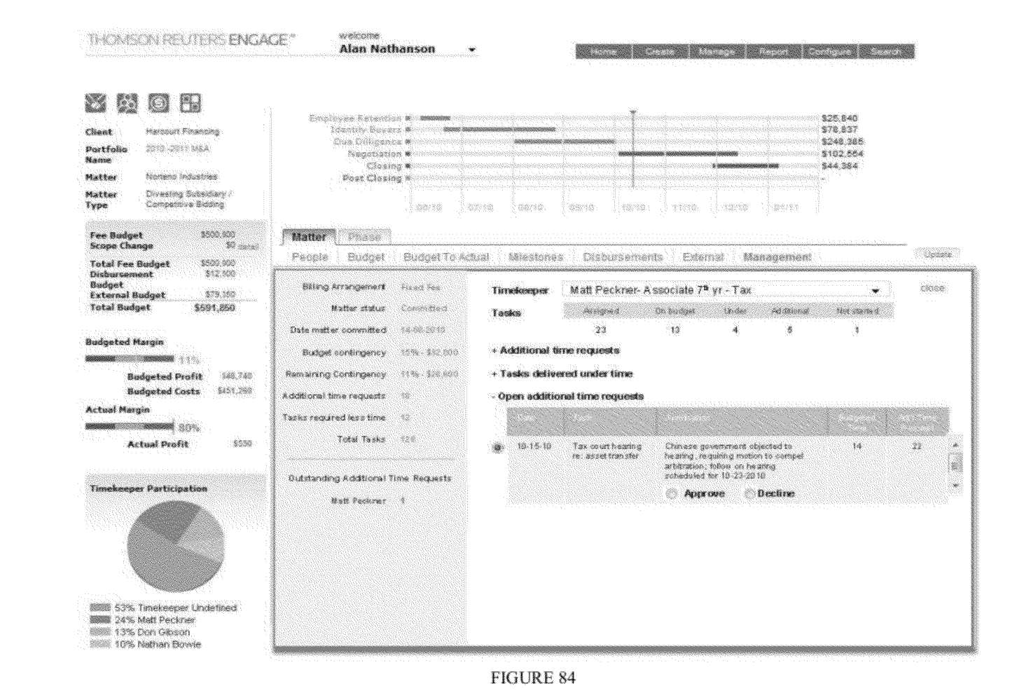

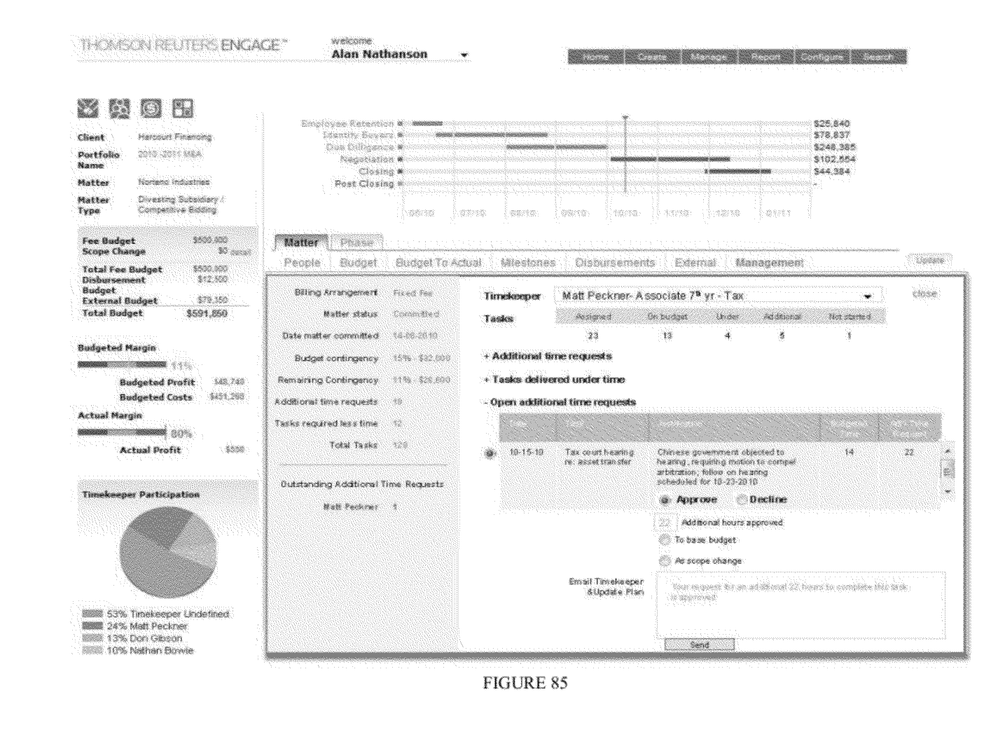

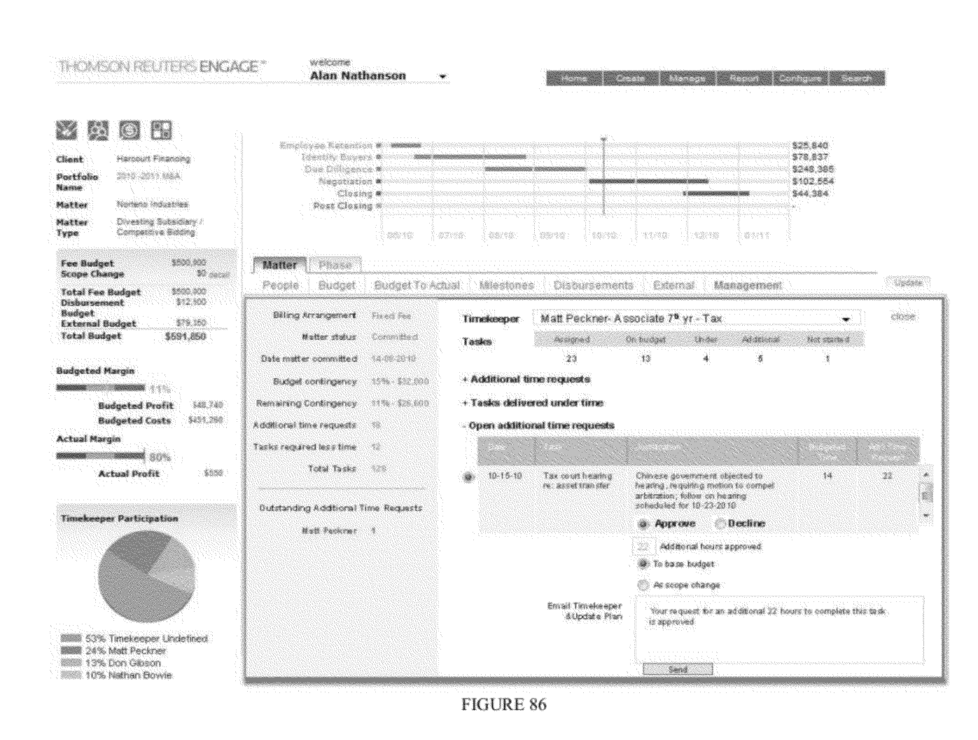

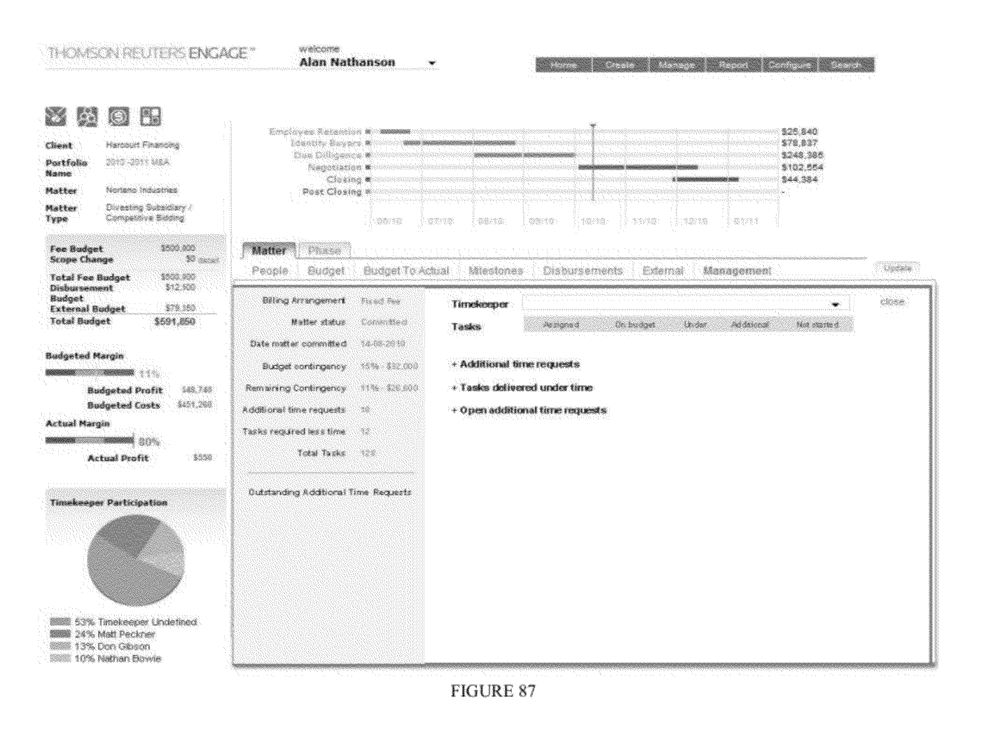

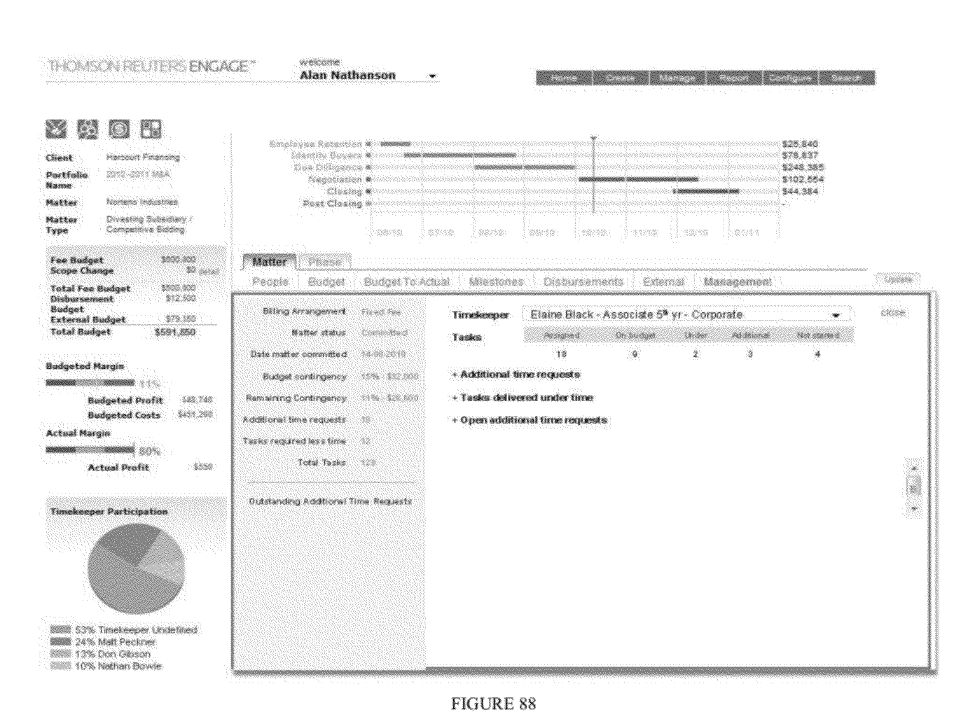

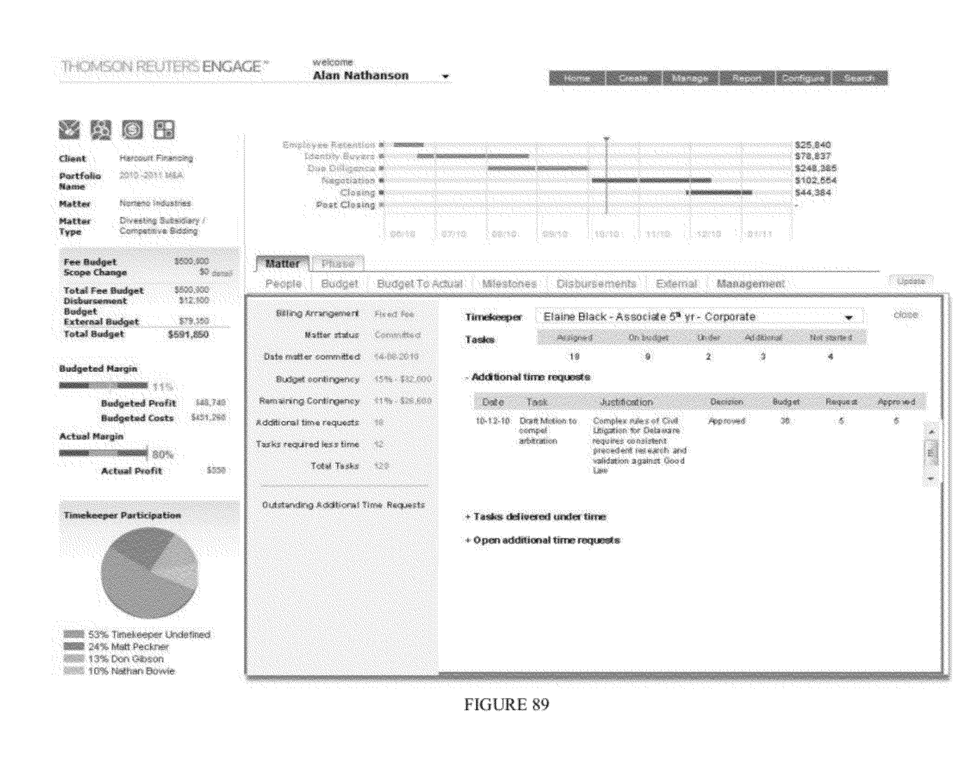

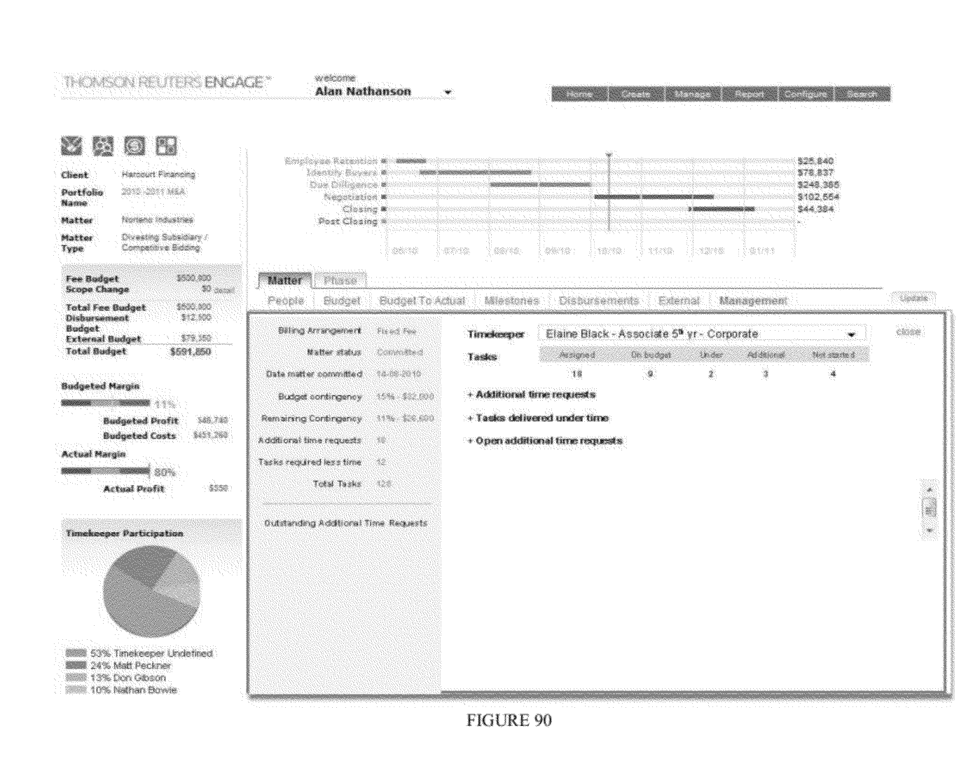

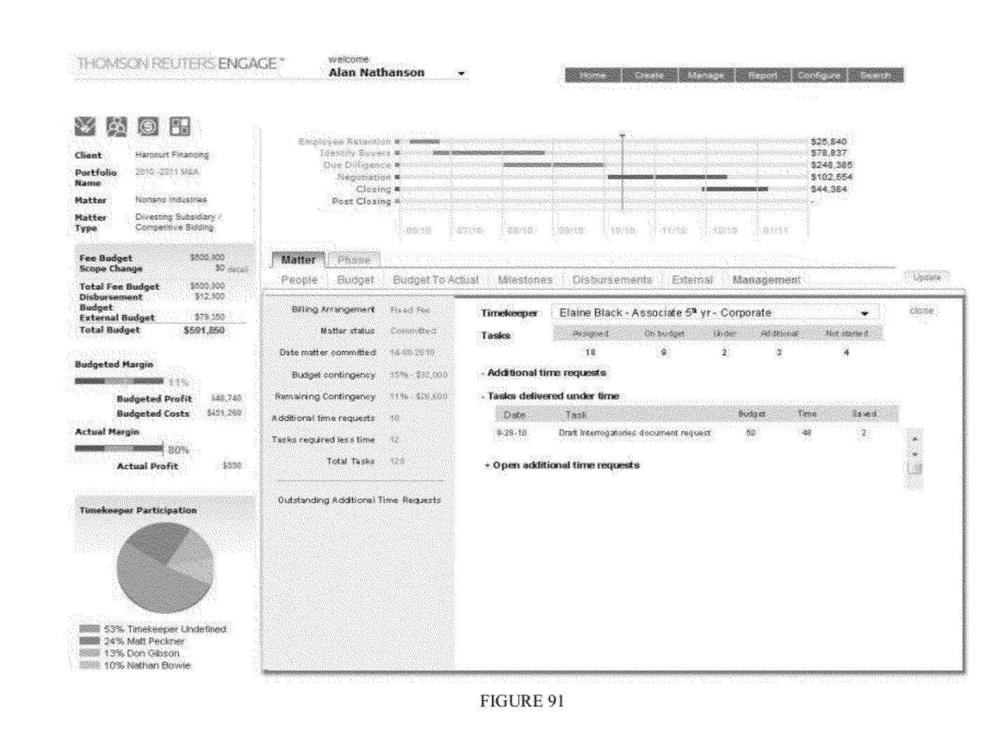

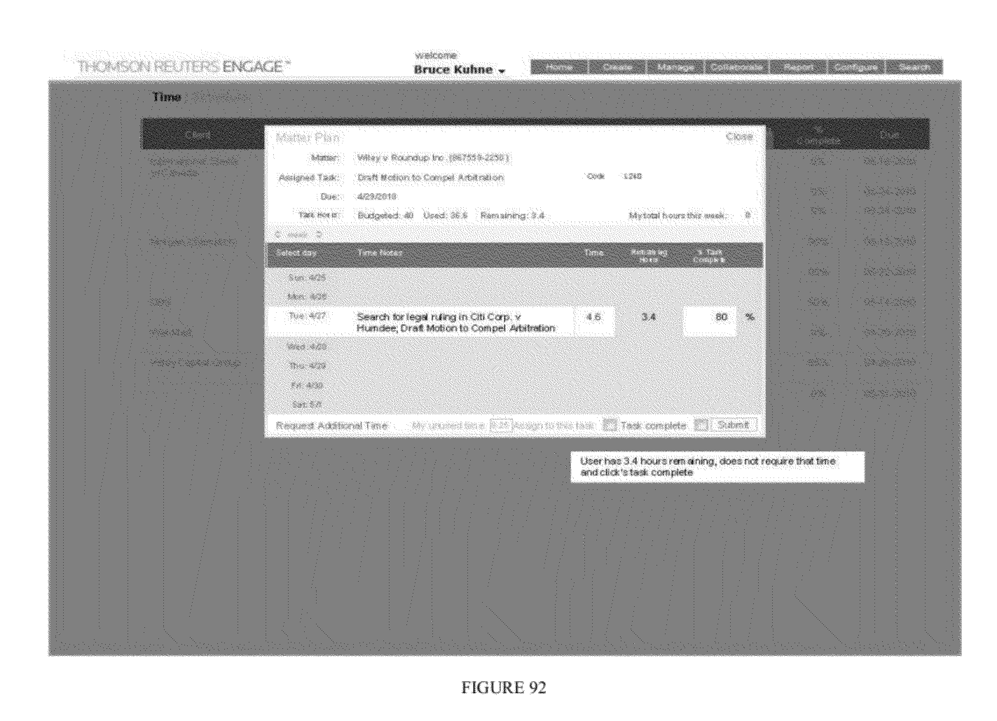

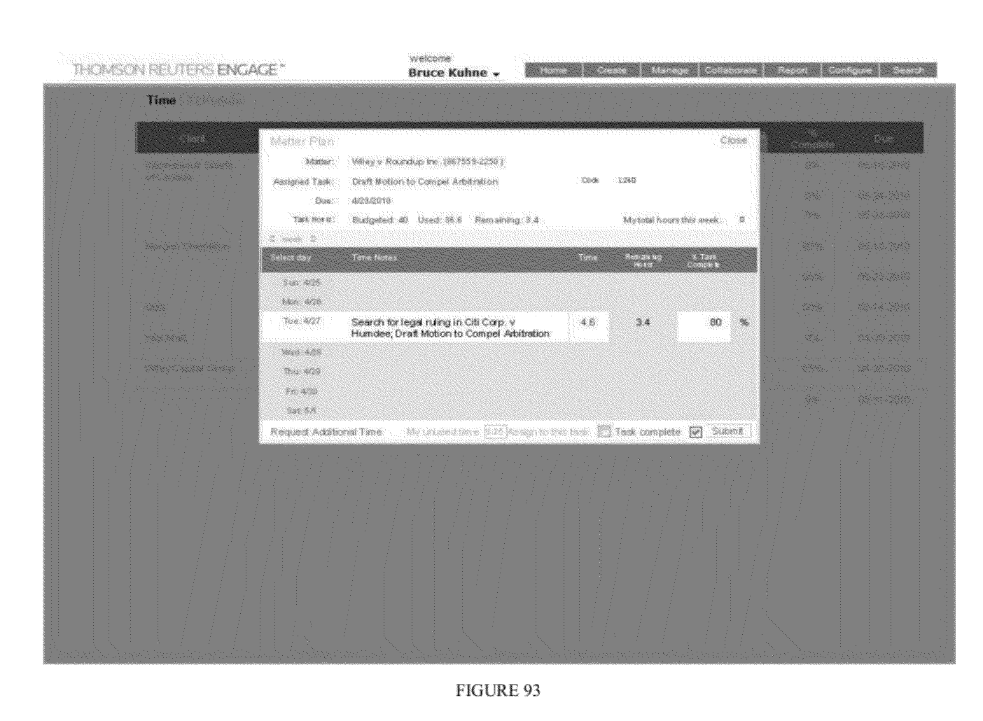

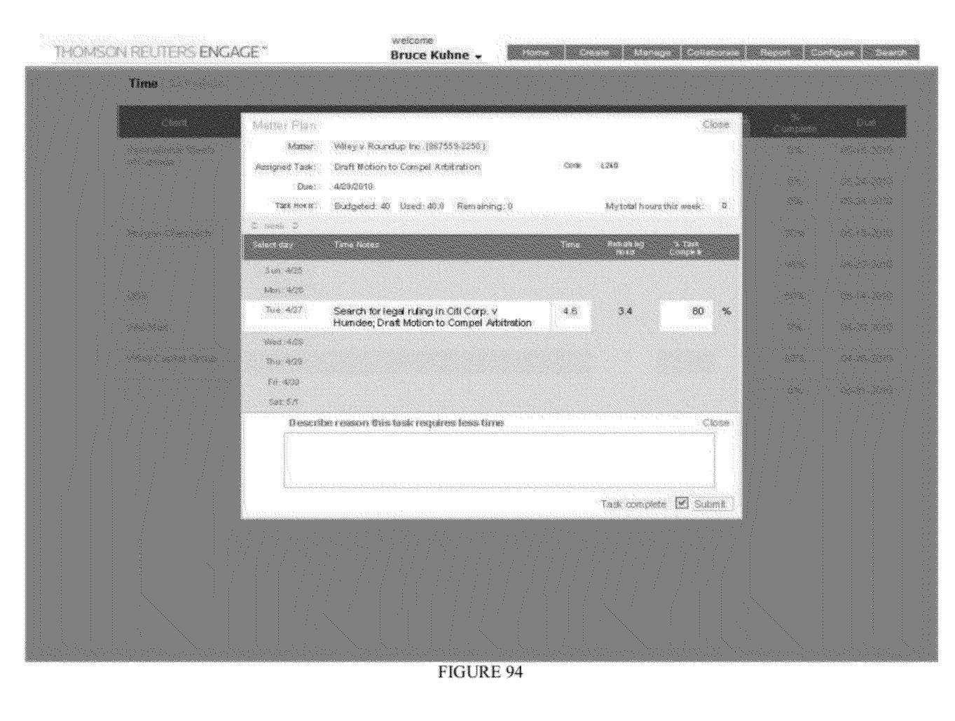

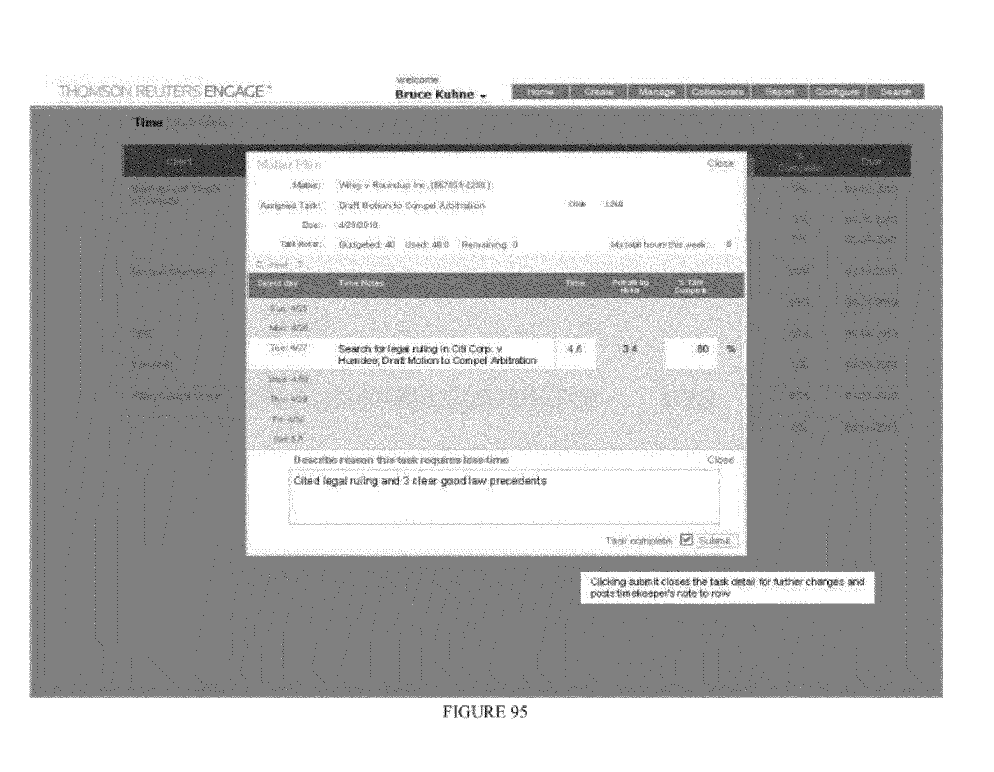

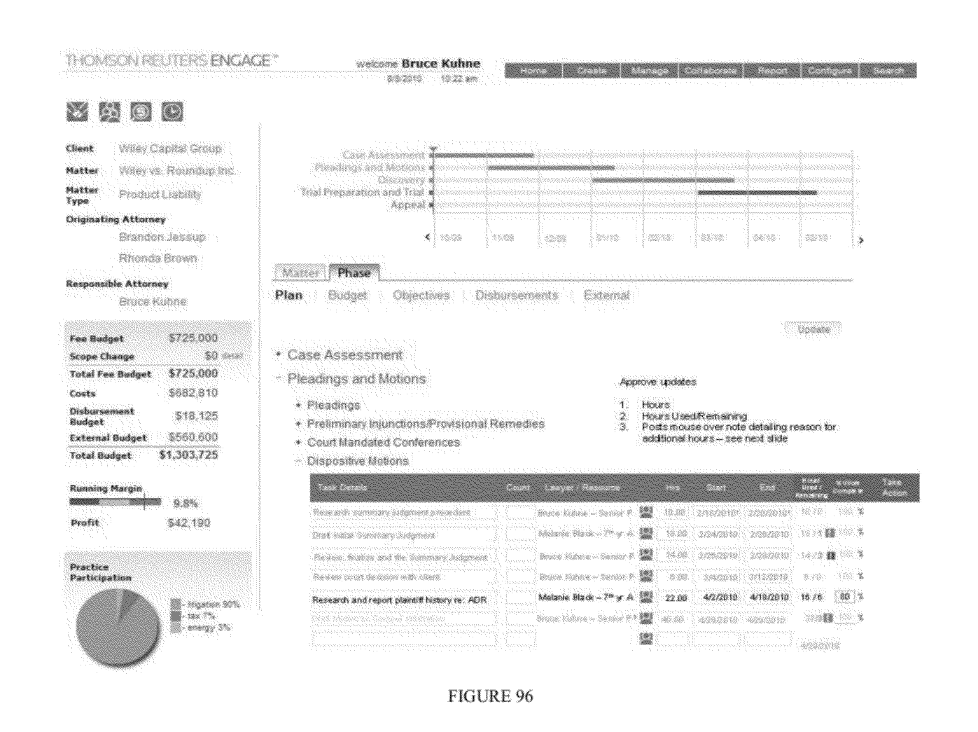

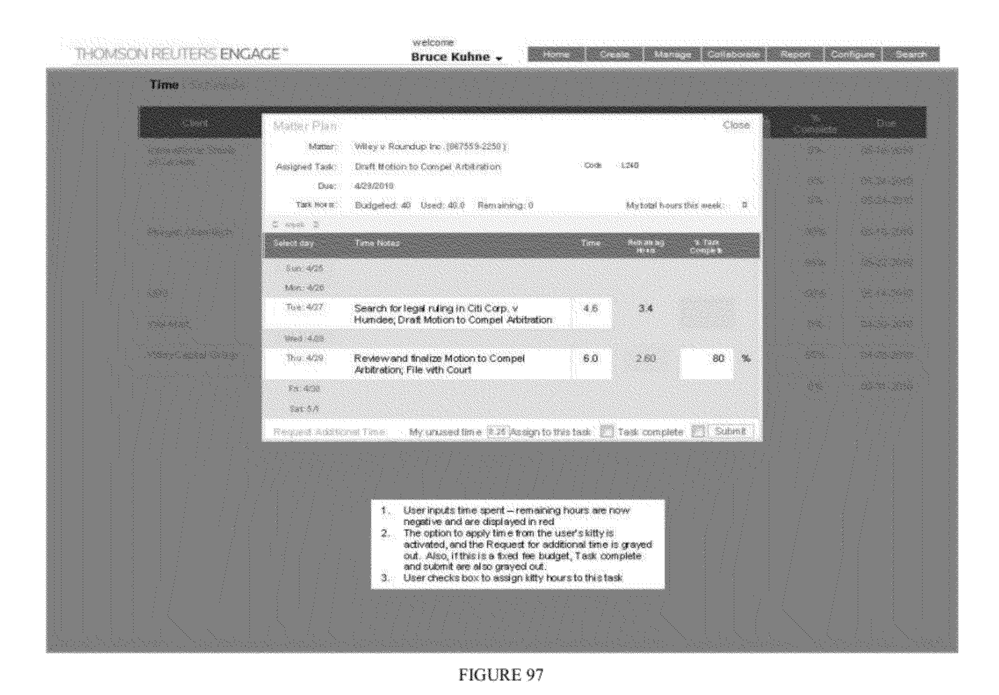

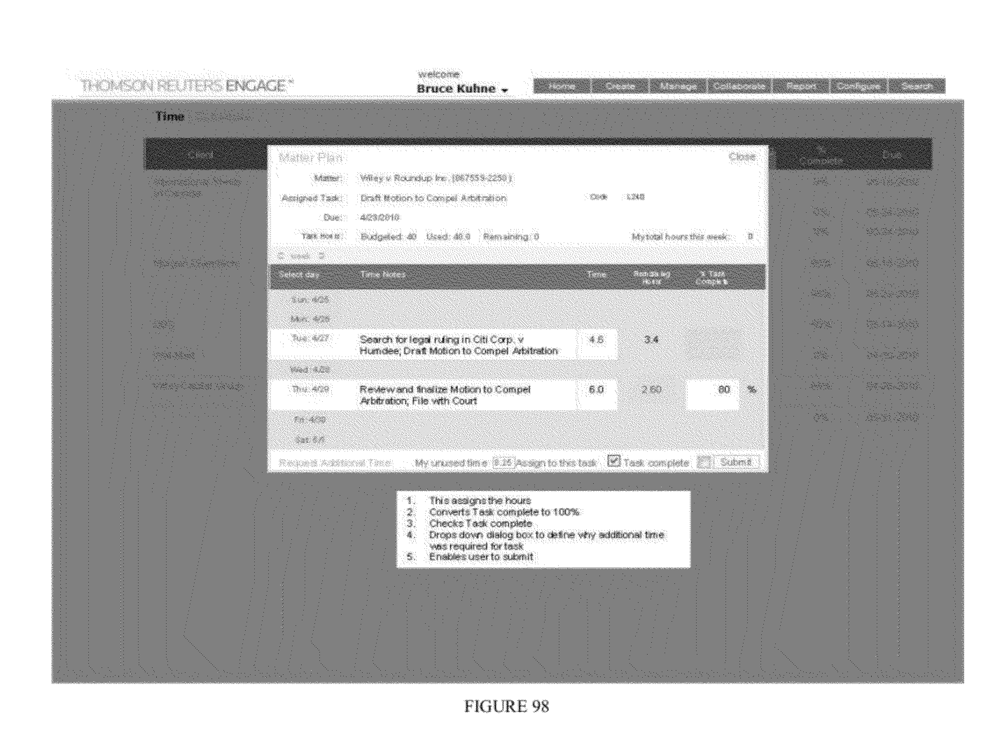

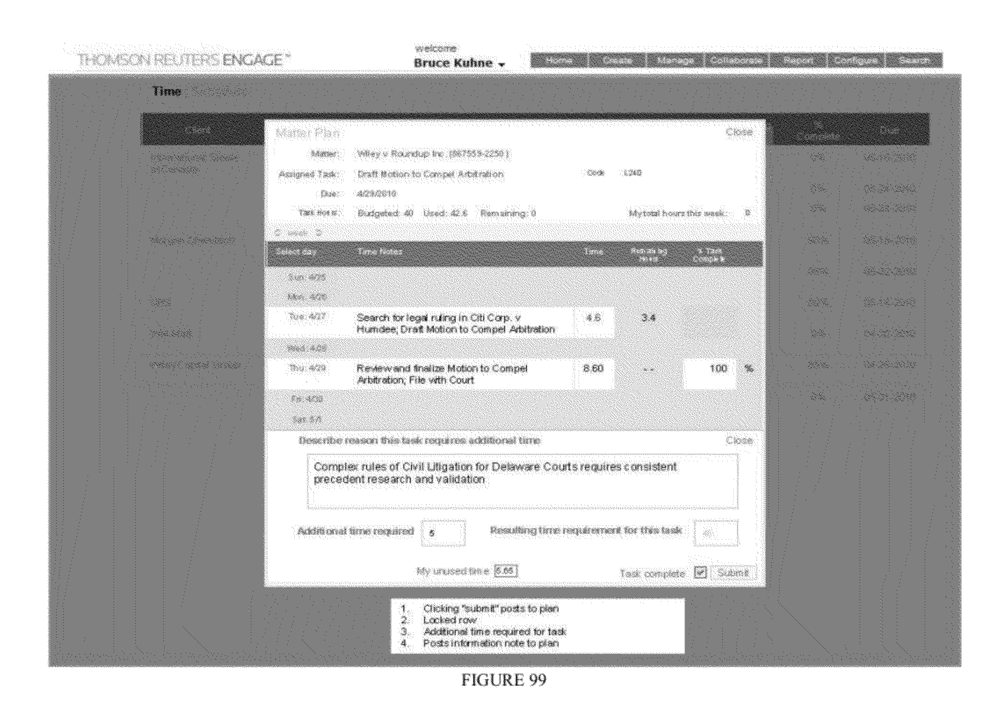

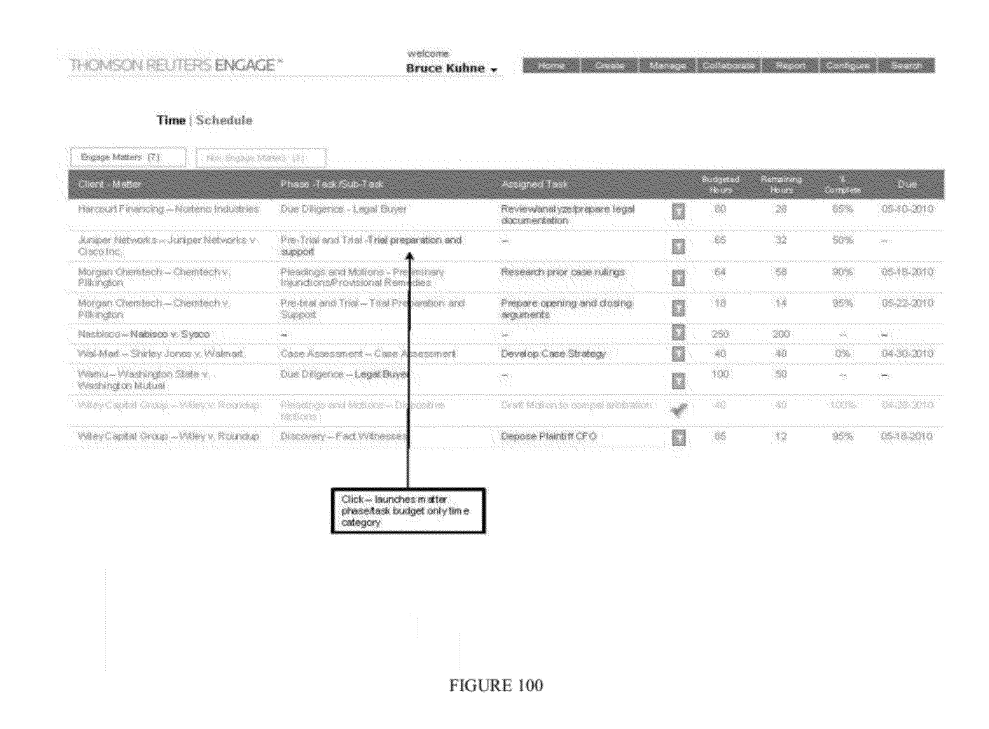

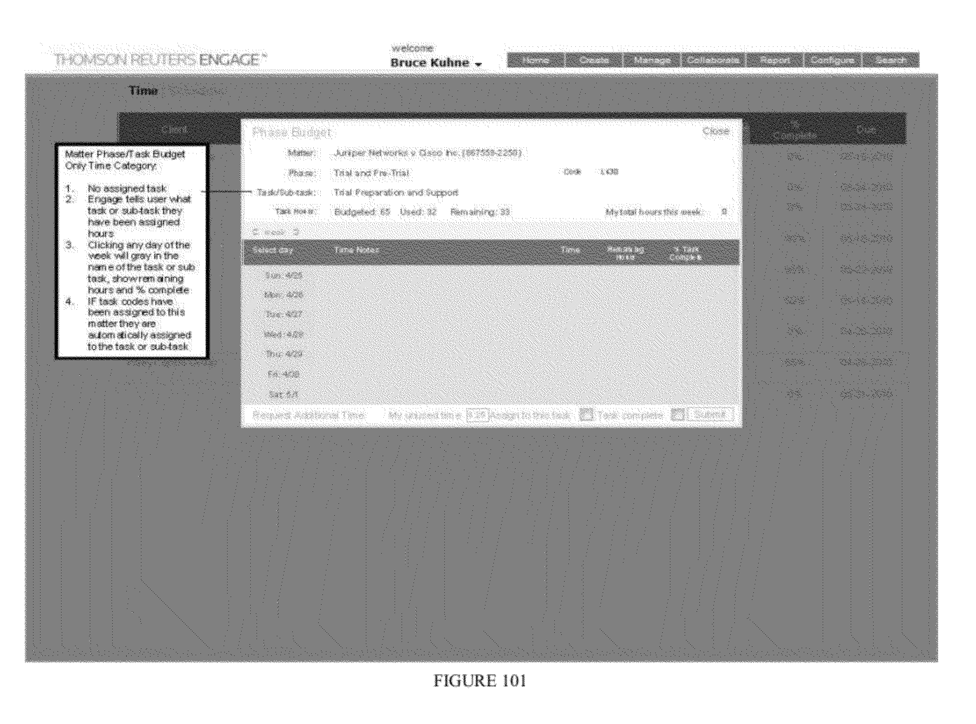

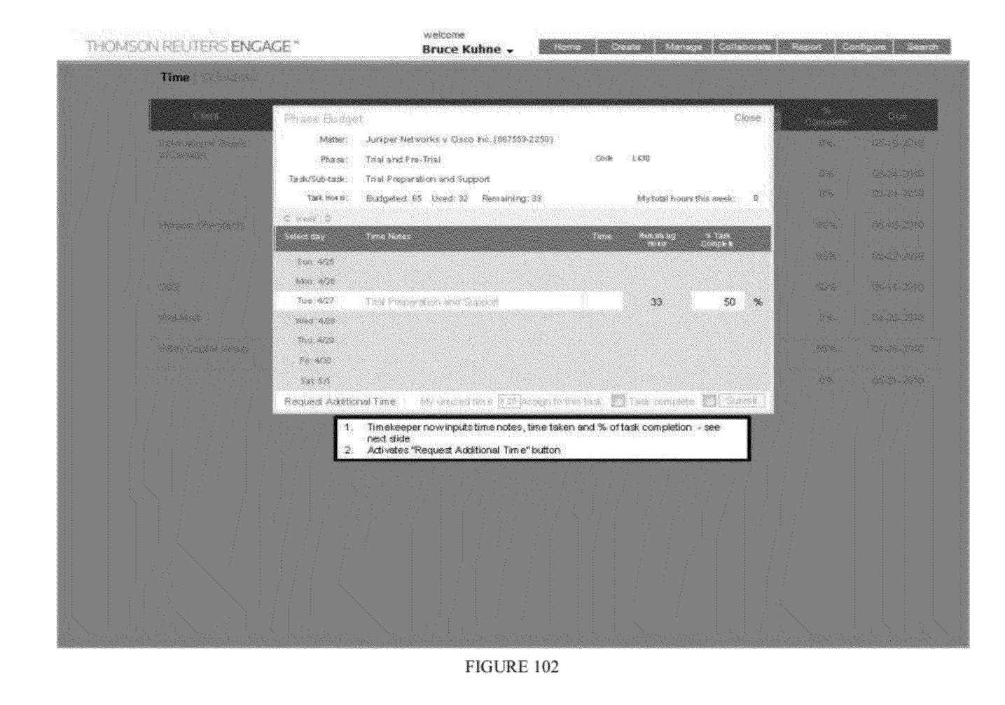

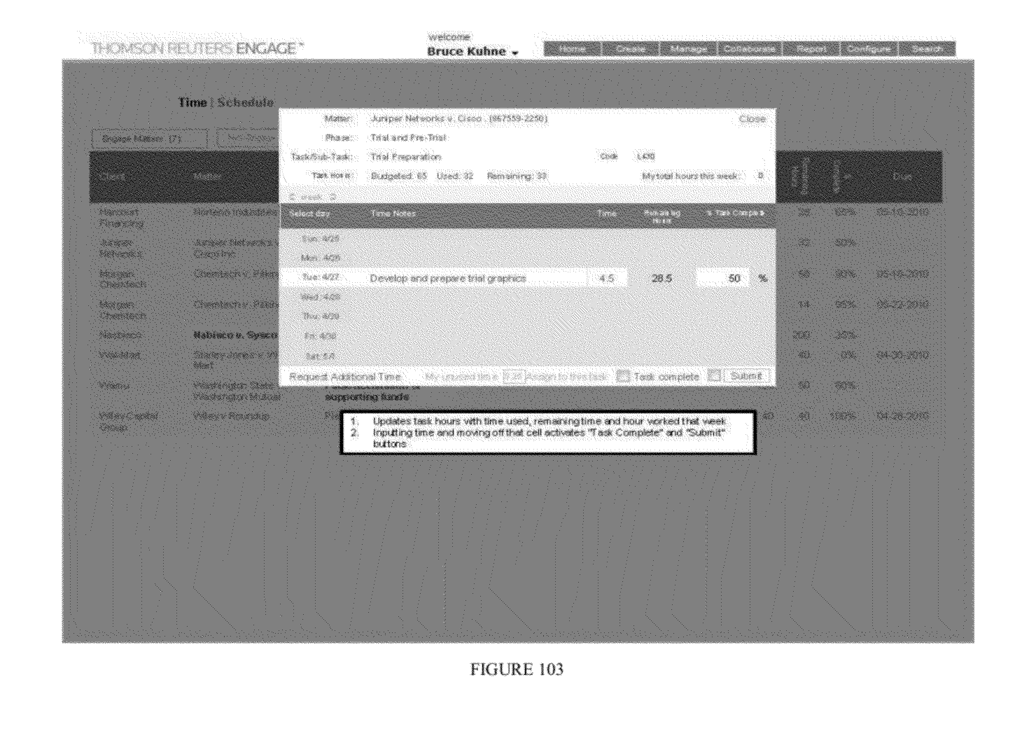

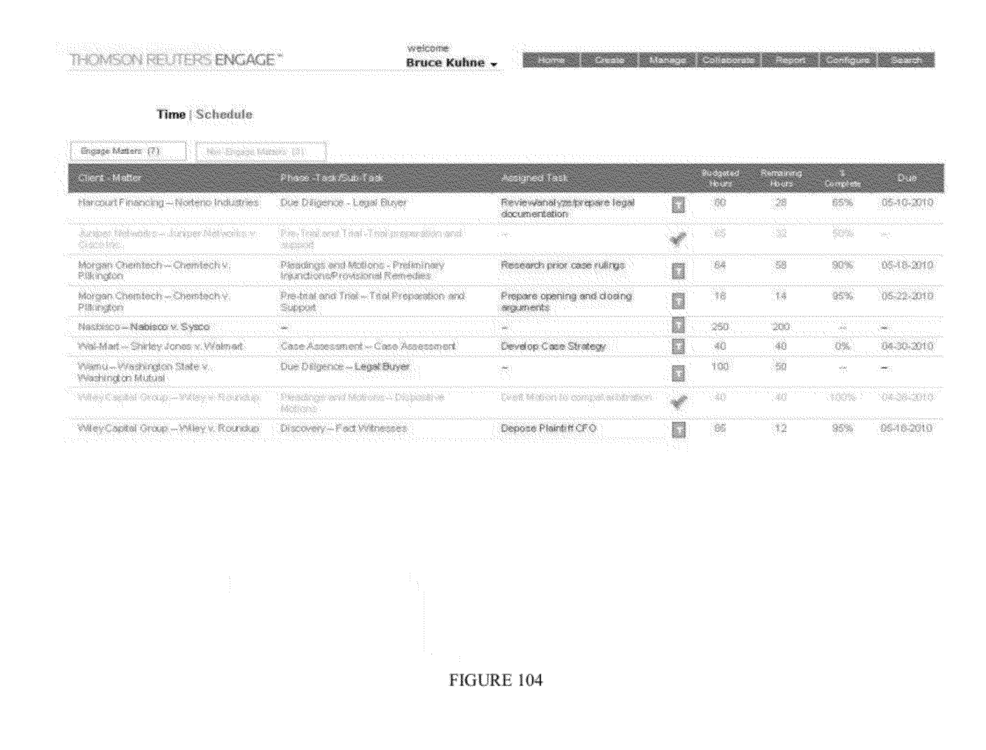

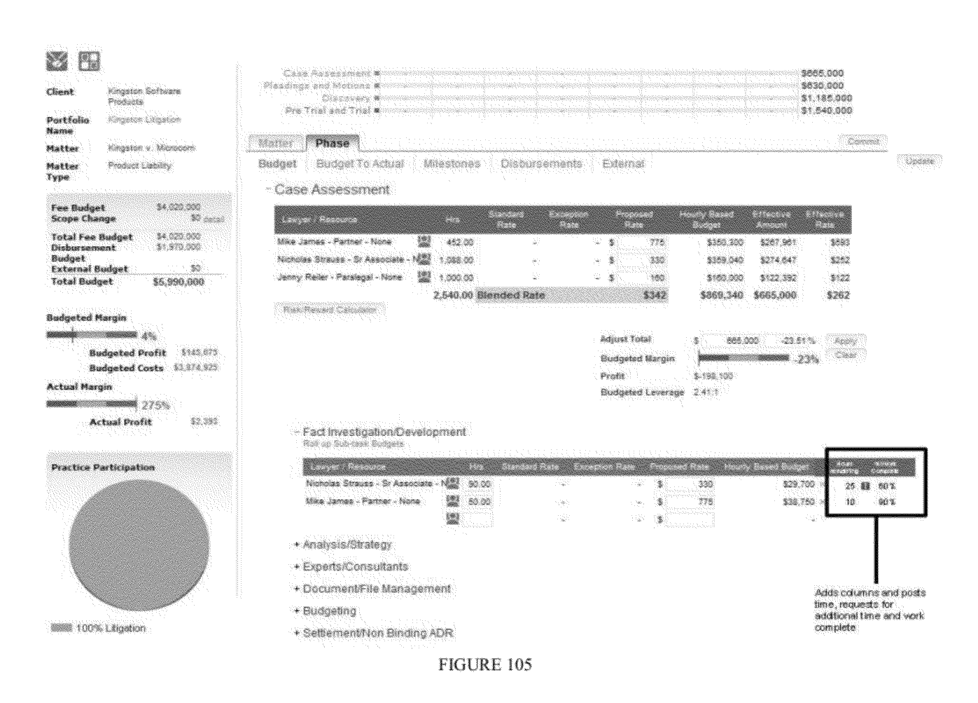

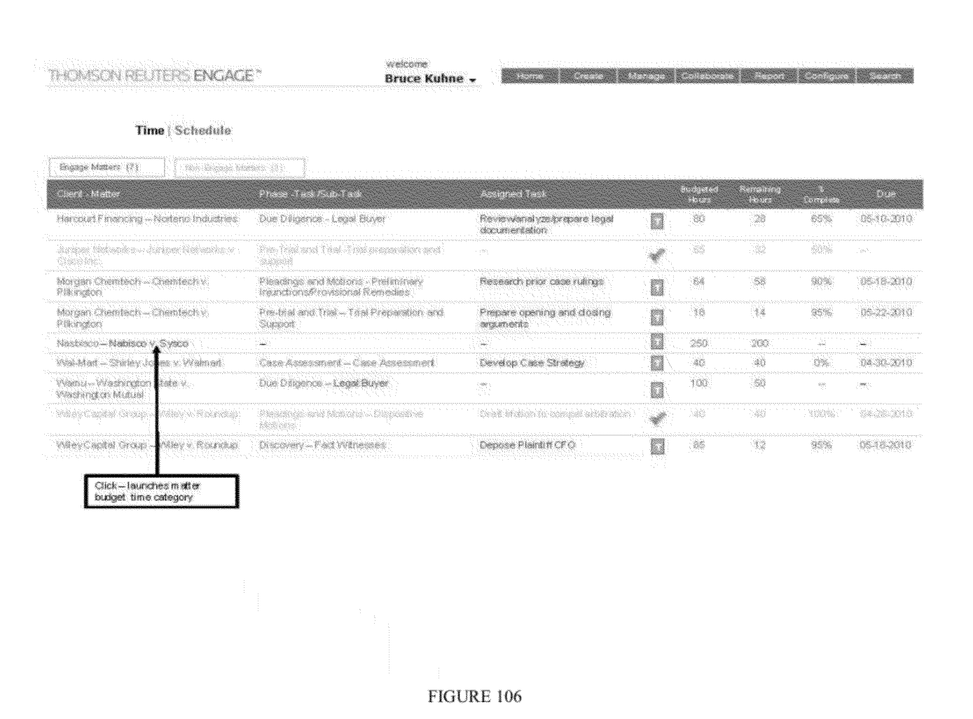

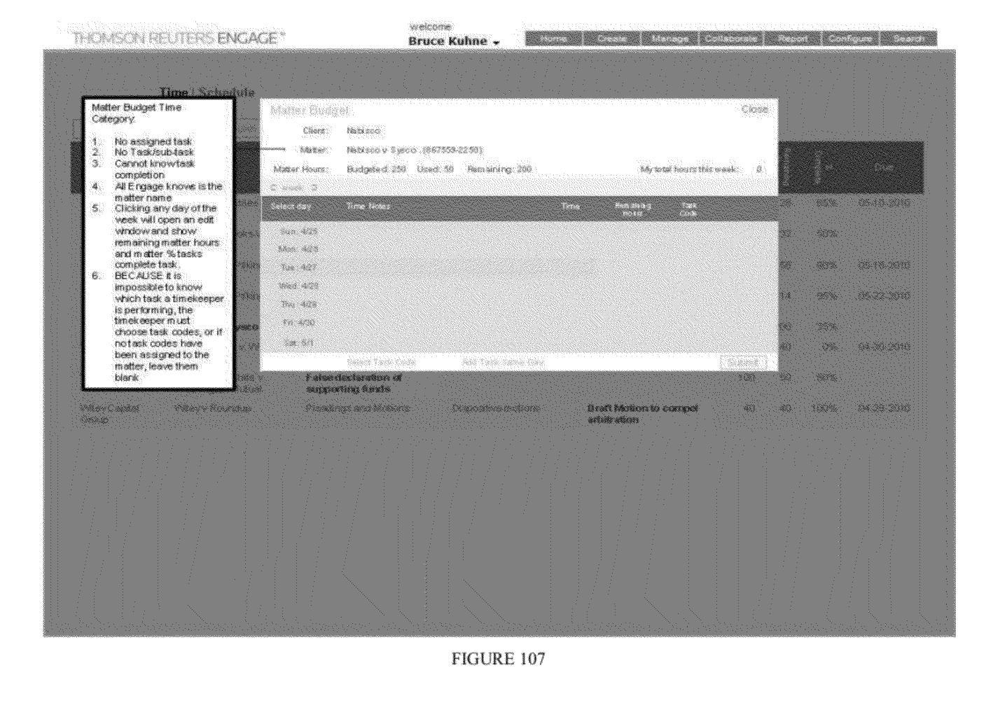

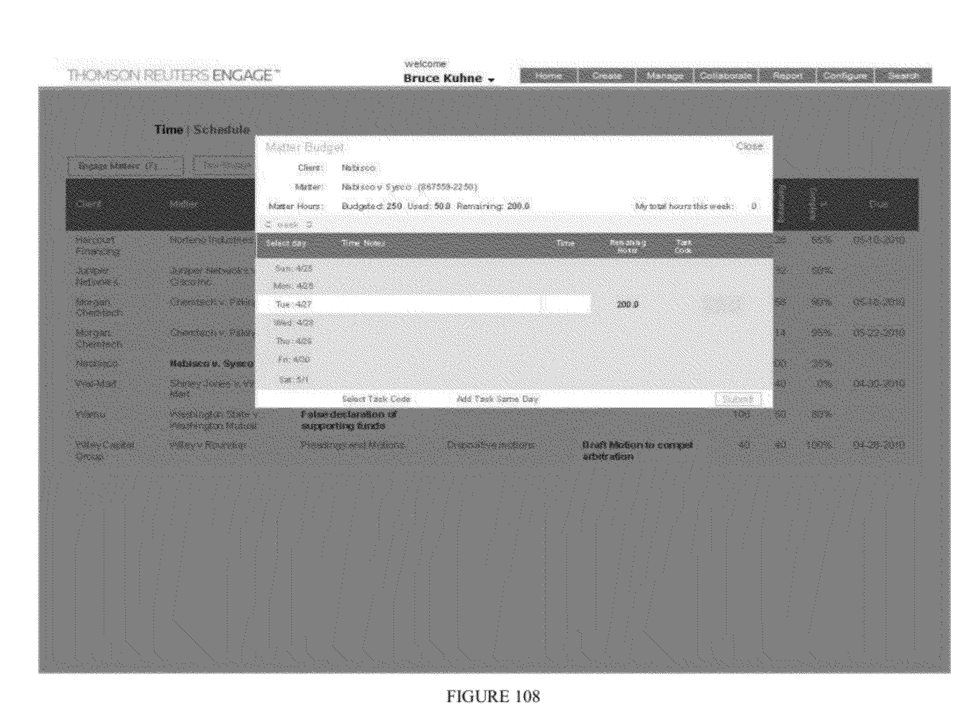

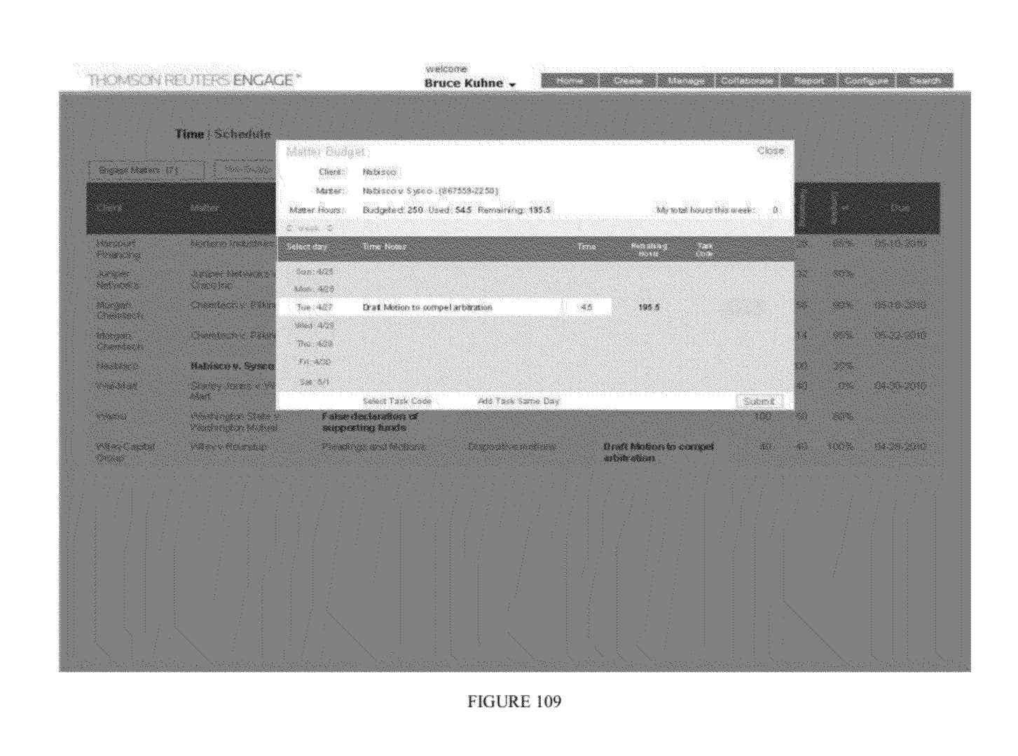

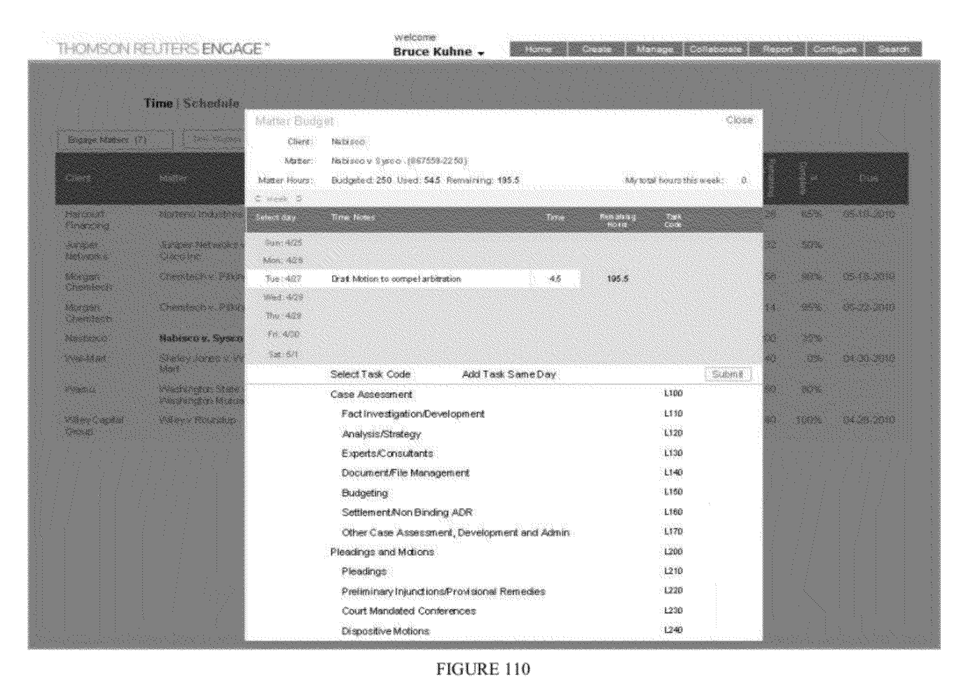

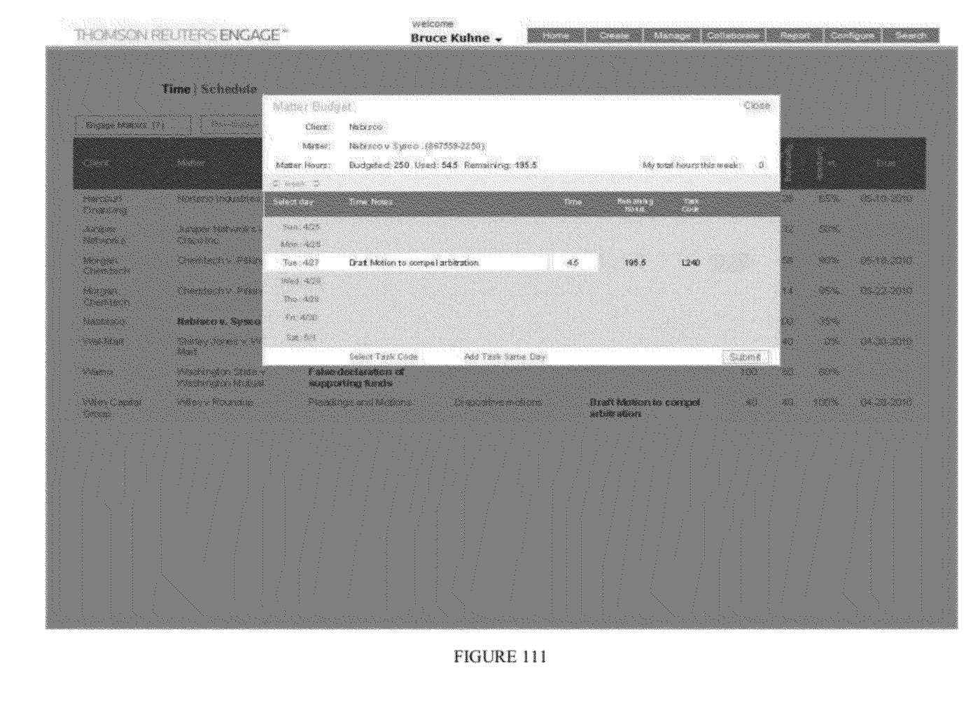

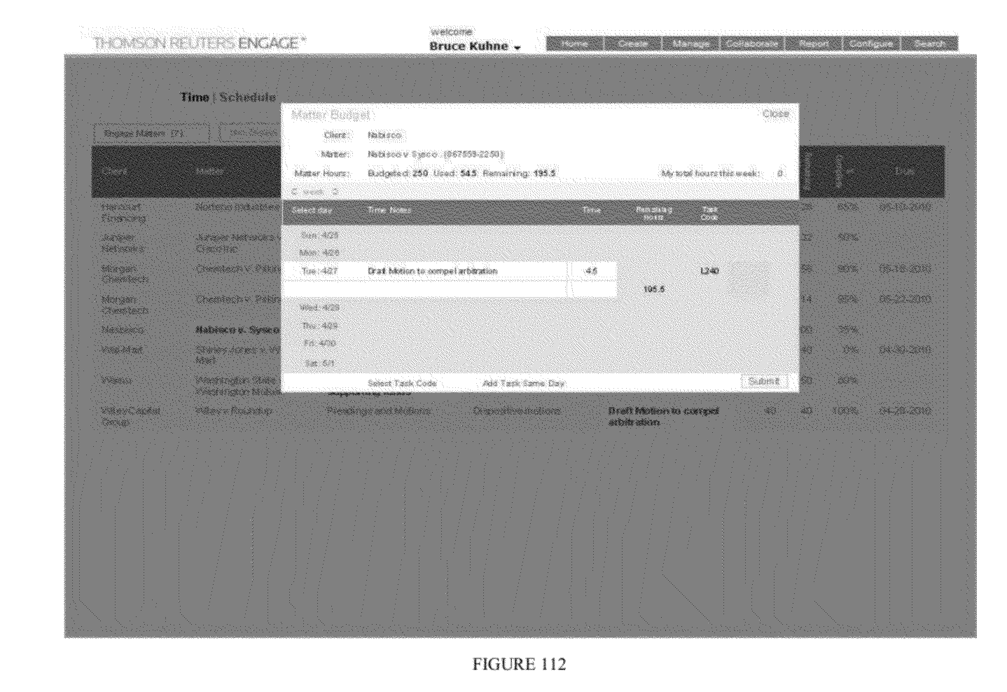

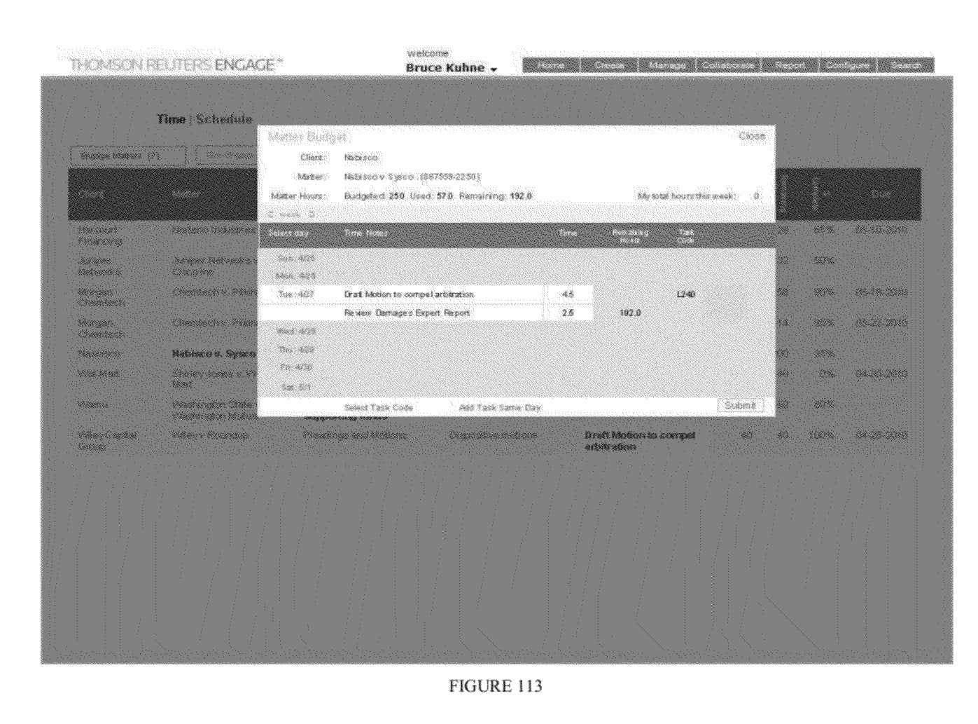

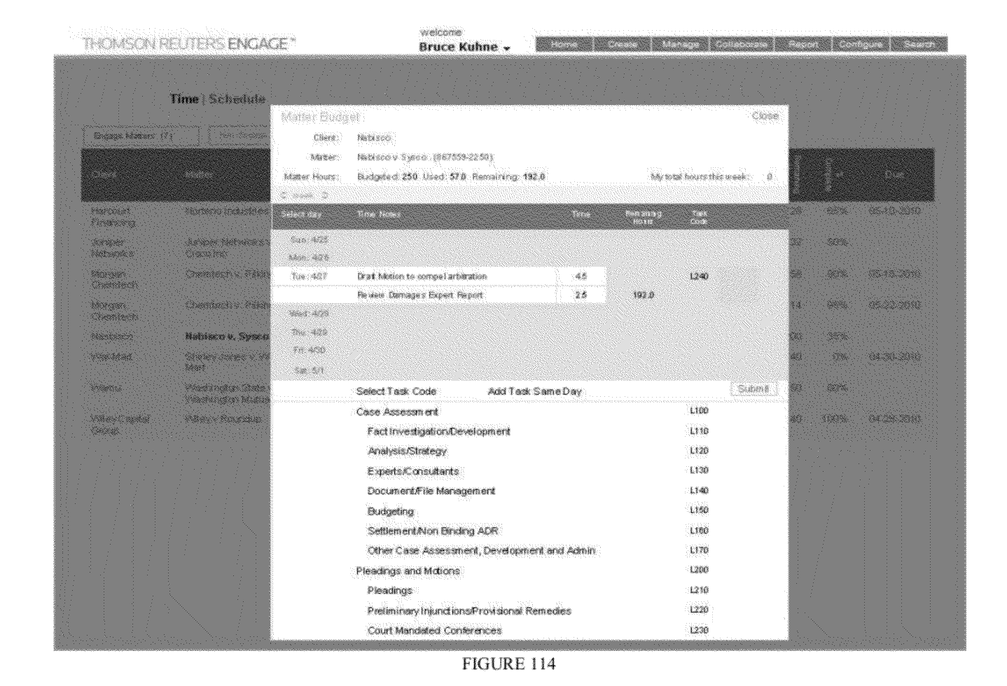

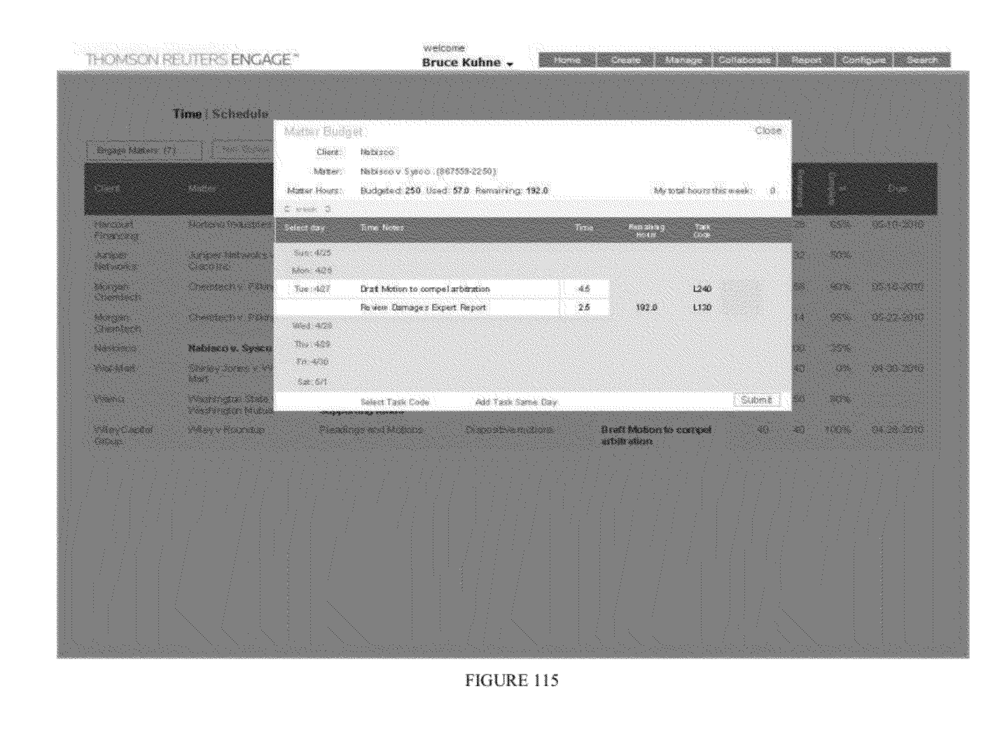

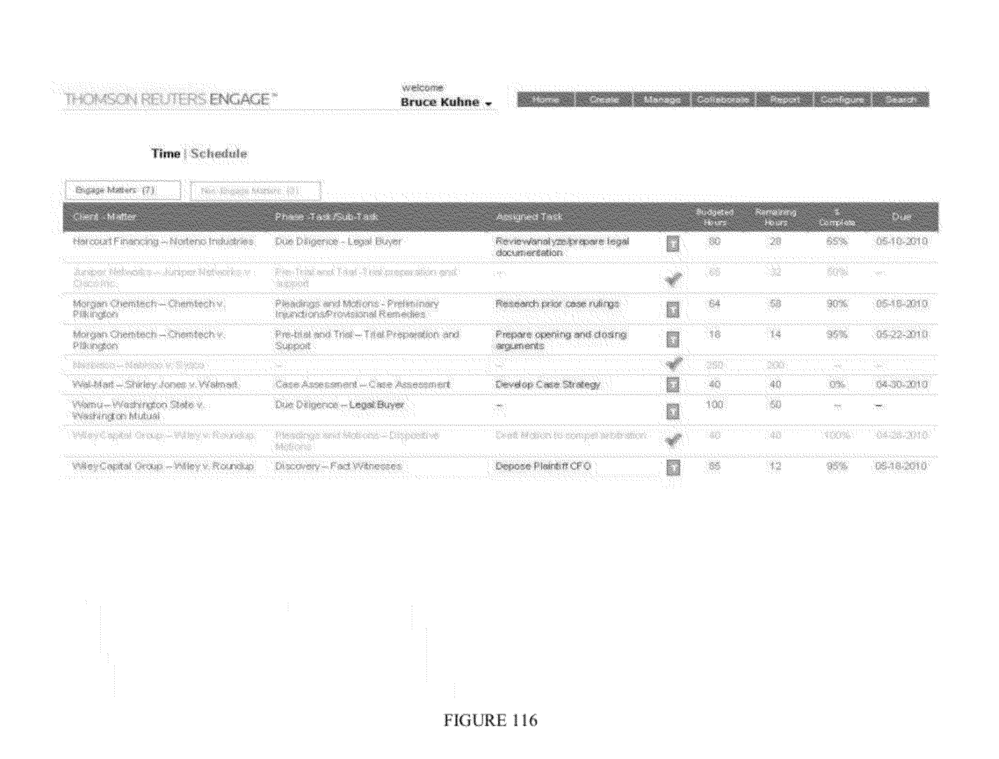

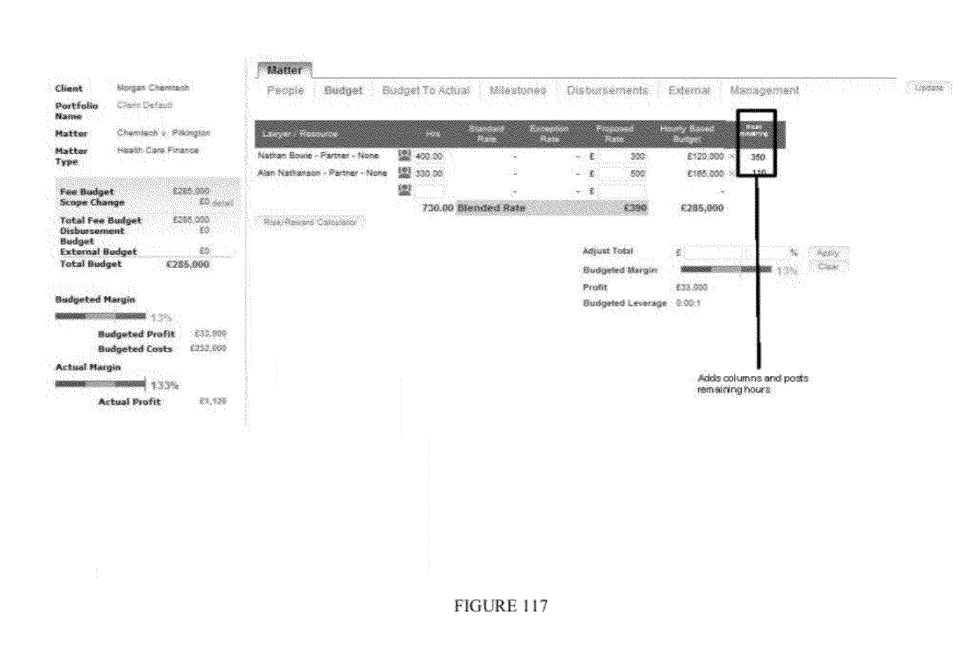

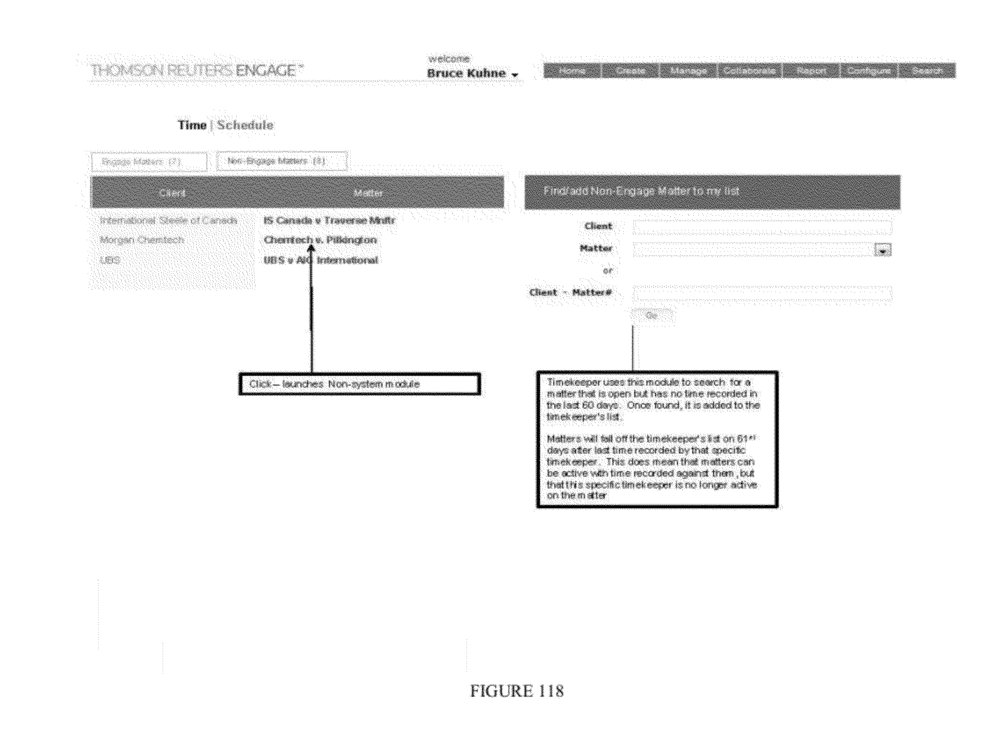

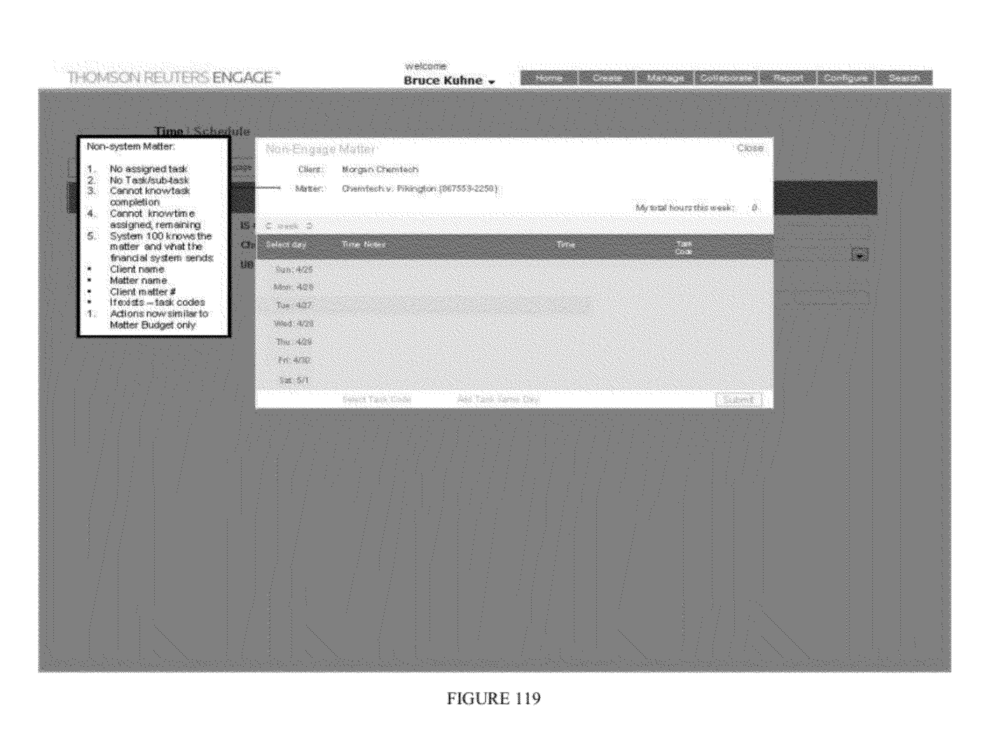

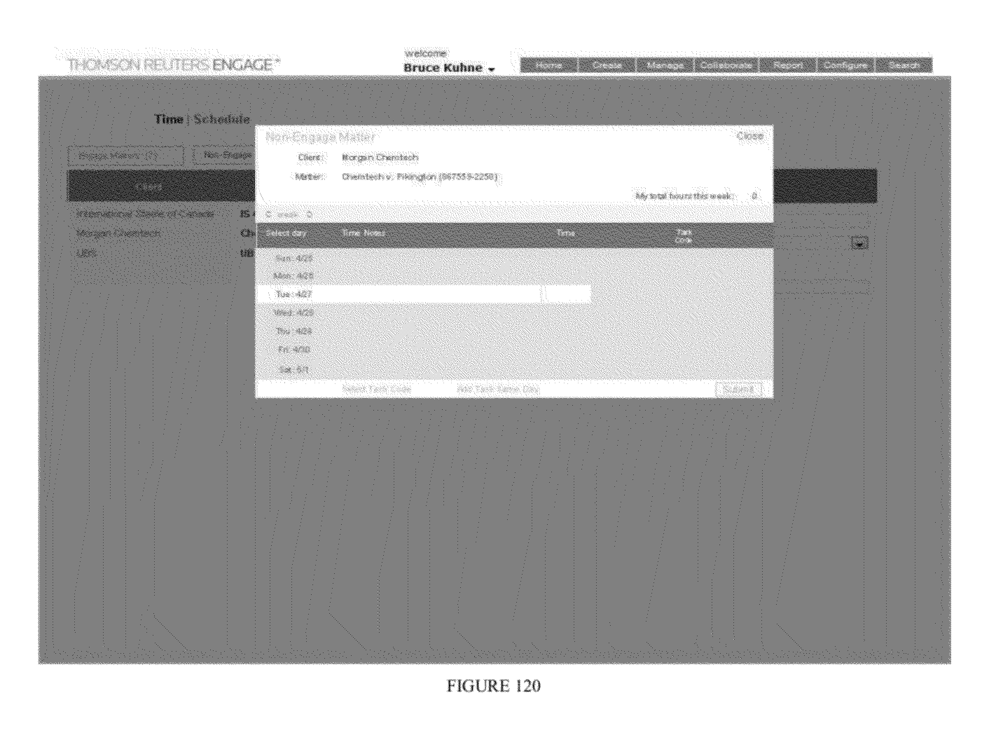

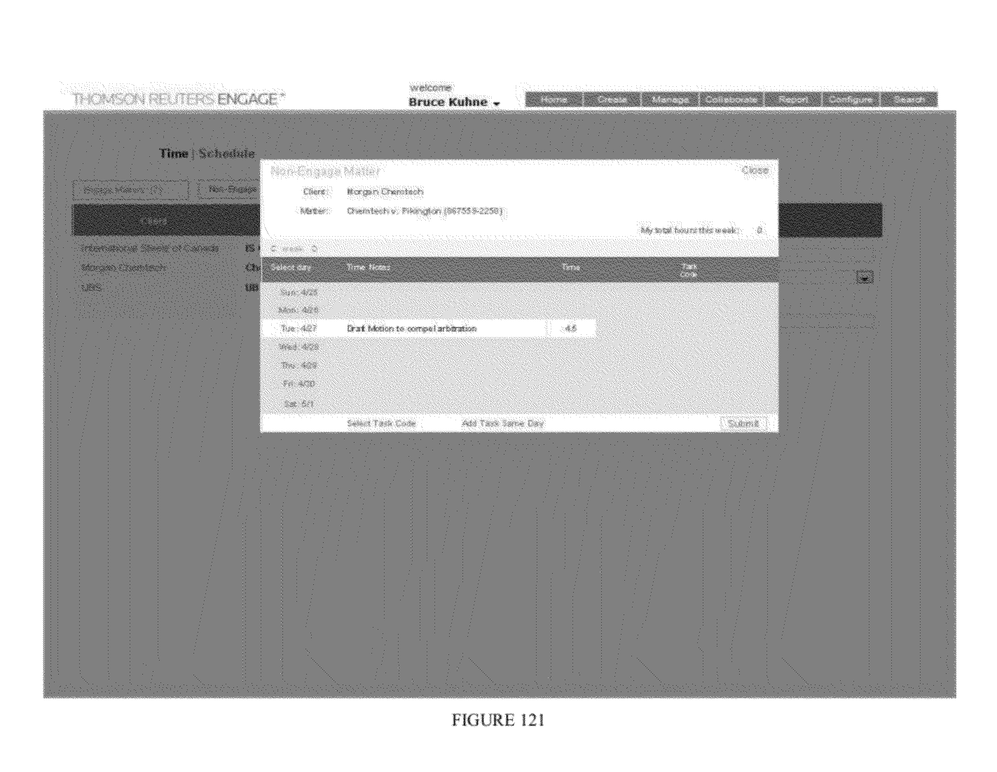

Time entry system 141 contains time entry records for each timekeeper. Exemplary time records information includes but is not limited to individual billing rates, titles, timekeepers and their associated titles, billing rate exceptions, billed hours, and estimated billable hours. Refer to FIGS. 31-124 for illustrations of the time entry system 141 and the integration with system 100.

Documents system 142 contains a content management system. The content management system includes documents associated with an engagement (i.e. matter project). Exemplary documents include but are not limited to patents, pleadings, motion briefs, research notes, exhibits, communications and docket listings. Once the document is created and saved within the content management system, database server 130 via the communications network 105 retrieves the requested document(s). For example, a user may want to access a pleadings document associated within the open engagement. The user clicks on a hyperlink to access the document. Database server 130 via the communications network 105 retrieves the selected document within the documents system 142 and ultimately displays that selected document to the user.

Financial system 144 contains financial information and financially related information. Examples of financial information or financially related information include but are not limited to individual billing rates, titles, title cost rates (i.e. the rate to employ/maintain that title), timekeepers and their associated titles, and billing rate exceptions. At a pre-determined amount of time (i.e. daily, weekly, monthly, continuously, etc.), database server 130 extracts via the communications network 105 relevant financial data from financial system 144. This extracted data is then formatted and stored in resource database 135. For example, all the titles are extracted from the financial system 144 and are displayed for the user to determine the title structure. A title structure is a hierarchical structure of the seniority of the titles. Refer to exemplary interfaces for title structure examples. In addition, the financial system 144 keeps track of the current titles of its active timekeepers. However, the resource database 135 retains the previous financial system data and uses that information to form a knowledge base within the resource database 135. For example, Jackie Doe started for the company in 2009 as a senior associate. The financial system 144 has her in the system in 2009 as a senior associate (i.e. her senior associate title is correlated to a title cost rate) and has her billing rates for matter Y. Then in 2010, Jackie Doe made managing partner. The financial system 144 has updated this information in its system in addition to the resource database 135. However, when a user is trying to clone matter Y, the user usually does not want to Jackie's most current billing or title cost rate. Instead the user wants to know the title and title cost rate that Jackie Doe had at the time of matter Y. Therefore, when matter Y is cloned, only the title information is cloned not Jackie's current title or Jackie's specific information, as she might not be working on the new matter. Further examples are illustrated in the exemplary interfaces section.

Entities system 146 includes information about entities such as law firm personnel, clients and third parties. Exemplary entities system includes a customer relationship management system, a human resources management system and/or entity database(s). Information in the, 146 includes but is not limited to names, titles, timekeepers' locations, email addresses, phones numbers, and other contact information about law firm personnel, clients and/or third parties. At a pre-determined amount of time (e.g. daily, weekly, monthly, continuously, etc.), database server 130 extracts, via the communications network 105, information located within entities system 146. This extracted data is then formatted and stored in resource database 135. See the exemplary interfaces portion of the specification for examples of entity information. In addition, any client and/or third party information that is created and stored in the resource database 135 initially is sent, via the communications network 105, and stored within the entities system 146 afterwards. Furthermore, since the current and past entities information is stored within the resource database 135, a user has the ability to see previous matter projects and all the information associated with that matter projects regardless of currency. For example, if Bob Plane was an associate on matter Z but has since left the company, a personnel system no longer has him as active personnel and therefore his information may no longer be accessible to certain users. Resource database 135 retains this information about Bob in case a user wants to see who specifically worked on matter Z and/or Bob's information as it pertains to matter Z.

External resources 150 are a set of databases that do not reside behind the law firm's firewall (not pictured). External resources 150, in the exemplary embodiment, include a courts and jurisdictions database 152 and an industry database 154. In other embodiments, the external resources 150 might include additional databases, systems or information regarding statutes, professional resources, patents, scientific literature, and financial data, such as public stock market data, news data.

Courts and jurisdictions database 152 contains a listing of courts and/or jurisdictions. Examples of courts and jurisdictions include but are not limited to agency, federal, state, county, city, international, and specialty (e.g. bankruptcy court). Database server 130 requests via the communications network 105 an updated set of courts and jurisdictions at a pre-determined amount of time (e.g. daily, weekly, continuous, etc.) and the updated set is stored within the resource database 135. Having this information stored within the resource database 135 allows a user to select what courts and/or jurisdictions are prevalent to the engagement.

Industry database 154 contains a listing of various industry codes. Industry codes are standards used by entities in classifying business establishments. Exemplary sets of industry codes include North American Industry Classification System (NAICS) and Standard Industrial Classification (SIC). Database server 130 requests via the communications network 105 an updated set of codes at a pre-determined amount of time (e.g. daily, weekly, continuous, etc.) and the updated codes are stored within the resource database 135. Having this information stored within the resource database 135 allows a user to search clients and the particular codes associated with that client when working on a matter project.

### Exemplary Method for Conducting System 100

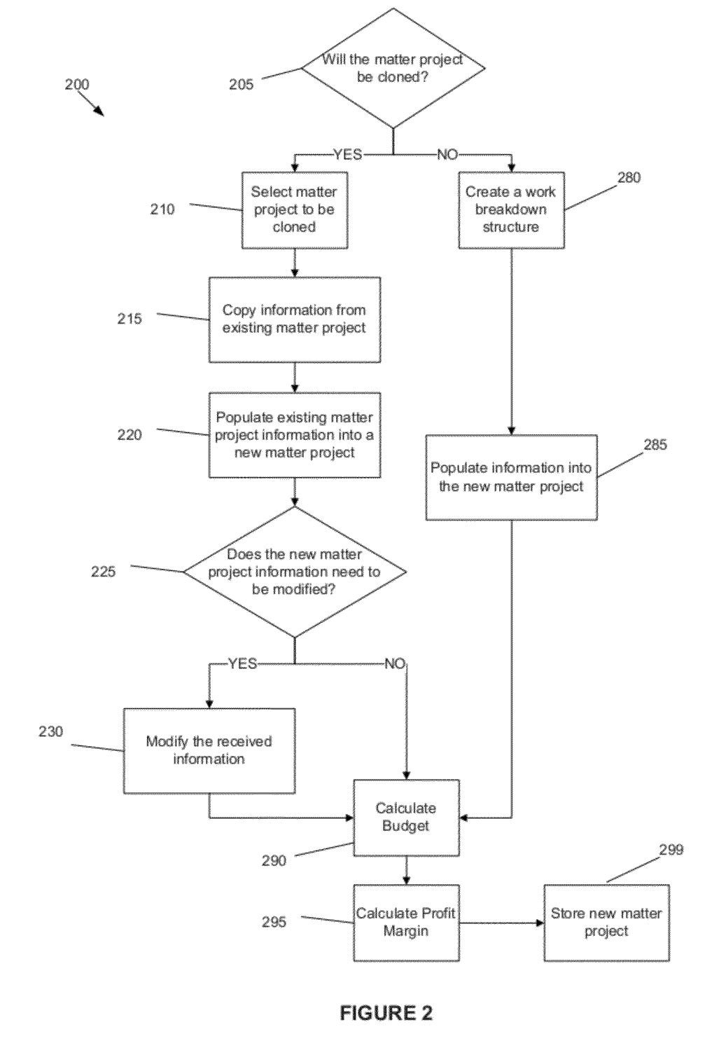

Referring now to FIG. 2, system 100 is configured to implement method 200, which may be adapted to incorporate the capabilities, functions, systems, interfaces, and so forth described herein. Method 200 includes functional blocks 205-299. These functional blocks are steps that perform actions including assignments, decisions, assessments and other like functions.

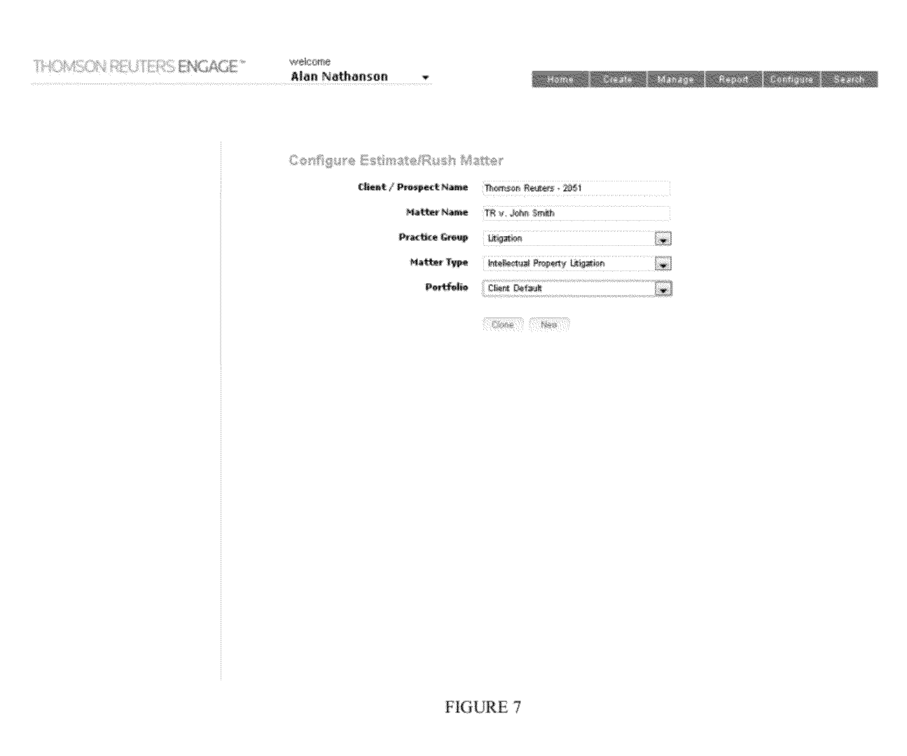

In step 205, the user makes a decision as to whether the new matter project should be cloned (i.e. copied) from an existing matter project. If the new matter project is cloned, the process advances to step 210. Step 210 prompts the user to select the matter project to be cloned. Exemplary illustrations of this selection process are shown in FIGS. 7-11 and described in the corresponding specification section. After the existing matter project is selected, the process continues to step 215.

In step 215, information is copied from the existing matter project, and consequently, the process advances to step 220.

In step 220, the copied information is received by and populated into a new matter project. The process then moves on to decision 225.

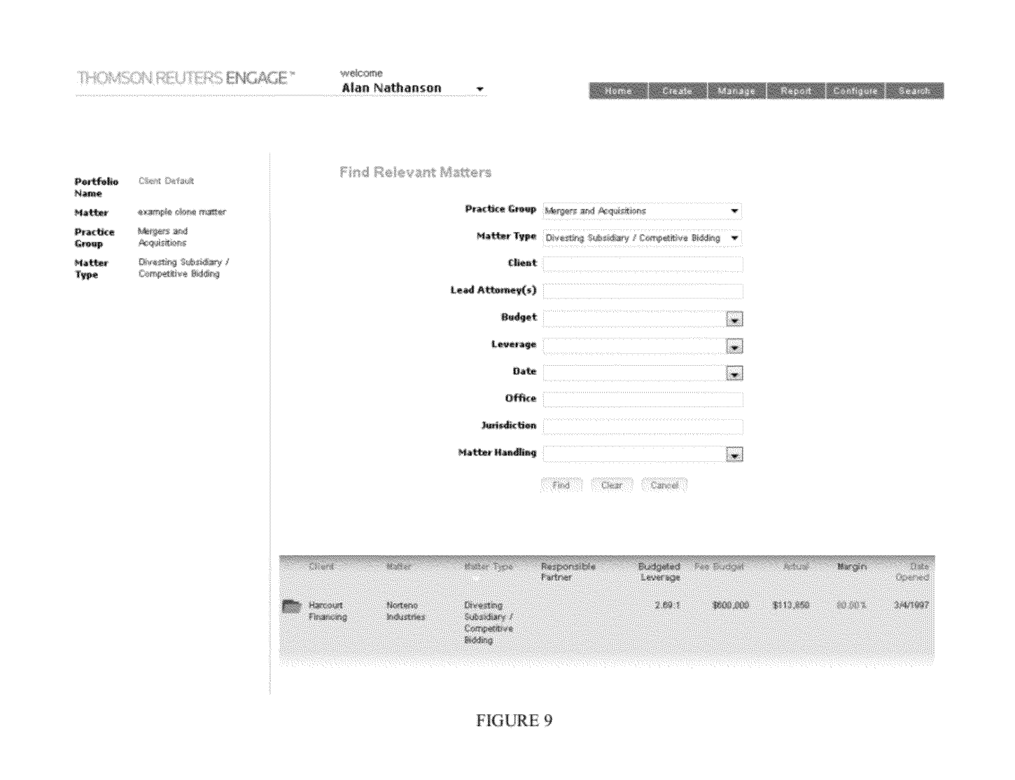

Decision step 225 gives the user the option to modify any received information present within the new matter project. Exemplary figures of modifying received information are found in FIGS. 9-11 and described in the corresponding specification section. Once the modification of the received information is complete, the process progresses to step 290.

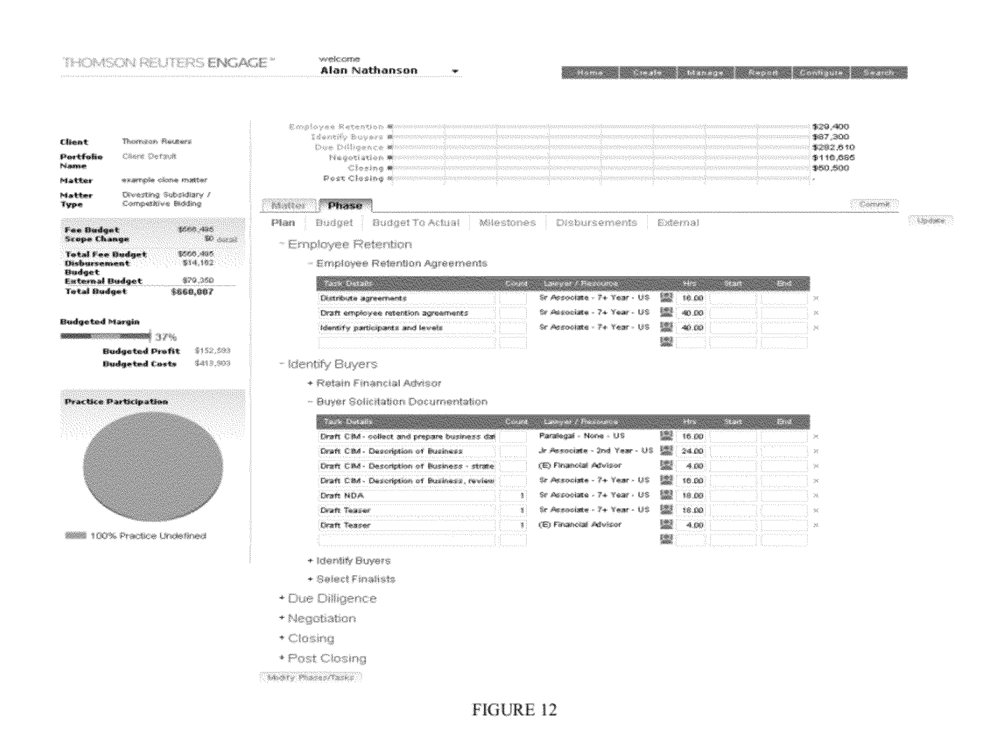

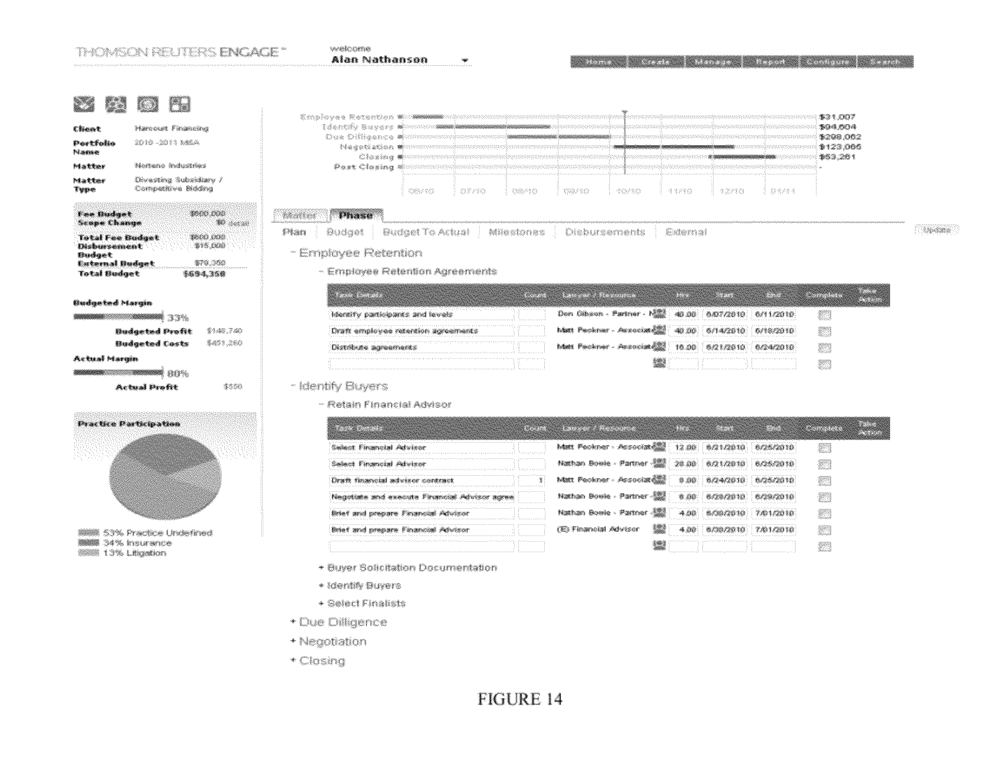

In step 290, a budget is calculated based on the inputted financial information. For example, once individuals are selected for each of the tasks, the rates associated with those individuals is multiplied by the time they are to spend on this new matter project to determine the overall budget for the new matter project. See FIG. 14 for an exemplary matter project budget. Additionally, the budget can also be broken down by individual, phase, month by month, etc. as FIGS. 12, 14 illustrate. The process then moves on to step 295.

In step 295, a matter project profit margin is calculated based on some analysis of the financial information in association with the budget. An exemplary way of calculating a profit margin of a law firm is:

(Revenues−Expenses)/Revenues=Profit Margin

However, there are other calculations for determining a profit margin. These calculations are known to those skilled in the art. Once the profit margin is calculated, the calculation is graphically represented. Examples of graphical profit margins are found in several figures with FIG. 14 representing a budgeted margin, actual margin, success bonus margin, and penalty margin. After the calculations are finished, the process proceeds to step 299.

Step 299 stores the new matter project including the budget and profit margin calculations in the resource database 135. Once the new matter project is stored within the resource database 135, each law firm personnel has the ability to access this matter project using system 100.

On the other hand, if the new matter project is not cloned, the process proceeds to step 280 where the user creates a work breakdown structure (WBS). A work breakdown structure is used to define and group a matter project's discrete work elements in a way that helps organize and define the total work scope of the matter project. For an exemplary work breakdown structure please refer to FIG. 2. Once the work breakdown structure is created, the process continues to step 285.

In step 285, the user enters initial information into the new matter project. Examples of initially entered information include any type of information that comes from the user manually entering information into system 100 or selecting information from the resource database 135. Once the initial information is entered, the process advances to steps 290-299 described above.

### Exemplary Illustrations for Conducting System 100

FIG. 3 illustrates a summarization webpage. This webpage provides the user a daily snapshot of his personal financial management of work, status of his matter projects and portfolio matter projects and the ability to find and create matter projects that have been approved in the law firm's financial system 144. Status is tracked along five dimensions: open matters, active matters, portfolios, new matters and overall user portfolio snapshot. The open matters dimension lets the user see his total active matter projects (i.e. matter projects where time has been recorded less than 60 days) and his total open matter projects (i.e. matter projects where time has been recorded more than 60 days). The active matters dimension lists a set of customizable display criteria by which the user sees what active matters may or may not need attention. These criteria include but are not limited to budget, accounts receivable, realization, leverage (ratio of partners to non-partners), scope change (i.e. there is a scope change within a matter), milestone date, and missing time. Certain criteria are displayed with a color indicator (e.g. red, yellow, green). For example, any red items require immediate attention, any yellow items are on the cusp of becoming urgent, and any green items indicate matter projects that are on track. The color indicator highlights matters that exceed the criteria threshold, what matters are close to exceeding the criteria threshold and what matters are within the criteria threshold. For example, the budget display criteria for this particular user shows that zero matters have exceeded the budget, one matter project has exceeded 80% of its budget and three matter projects are close to exceeding the 80% of their individual budgets. Under the portfolios dimension, the user sees a listing of all portfolio matter projects for which he is a leading partner. He also sees whether the portfolio matter projects are on track to maintain the intended profit margin for the law firm. Under the new matters dimension, the user is shown how many estimates were law firm created for consideration by a client. Additionally, if the client chooses to accept the estimate, the law firm then creates this matter within its internal systems and the matter project gets populated into the “Create New” category under the new matters dimension. The portfolio snapshot dimension displays the aggregate of all the matters in which the user is a managing partner and depicts the most overall relevant information such as total actual profit margin, total active budgets, total remaining budgets, billed time, unbilled time, total accounts receivable, total collections (i.e. money received from the client), last payment date, billing adjustments, actual leverage, and billing realization. Some of this information displays as a month to date total and/or a year to date total.

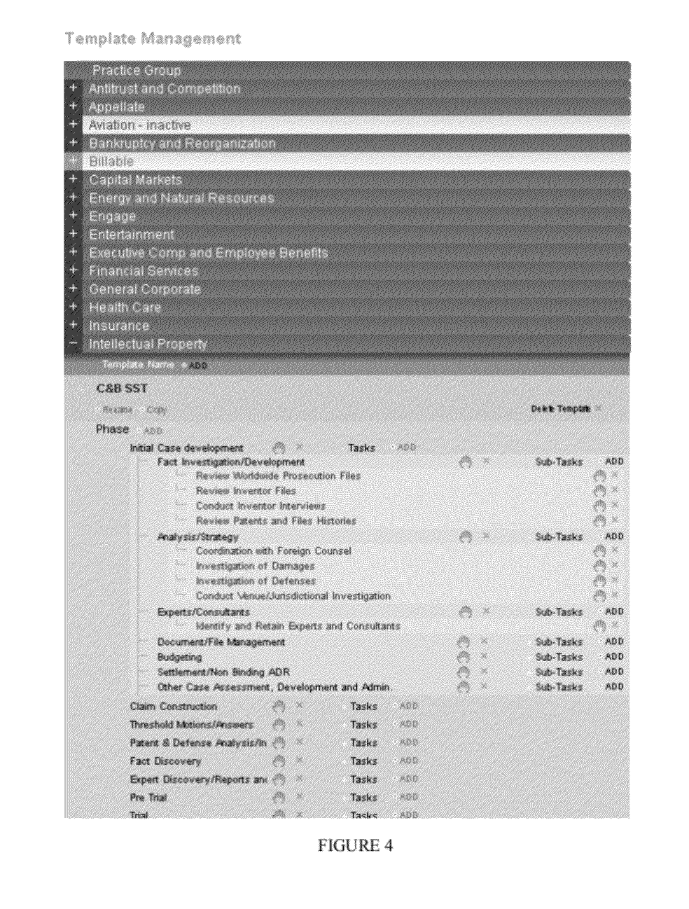

If a user wants to create a new matter project, the user begins by creating a matter project template for practice groups. These templates are the structure that defines the working process for the matter project team. Templates are work breakdown structures (WBS) where matter project teams select a template and use them to create matter projects. Those matter projects are then available firm wide as a knowledge base for how the firm handles and delivers the work on specific matter types. For example, FIG. 4 illustrates a matter project template for the matter type patent litigation. This exemplary matter project template has various phases including Initial Case Development, Claim Construction, Threshold Motions/Answers, Patent & Defense Analysis/Investigation, Fact Discovery, Expert Discovery/Reports, Pre-Trial, and Trial. Exemplary tasks within the phase “Initial Case Development” include Fact Investigation/Development, Analysis/Strategy, Experts/Consultants, Document/File Management, Budgeting, Settlement/Non Binding ADR, Other Case Assessment, Development and Administration. Exemplary sub-tasks within the task “Fact Investigation/Development” include Review Worldwide Prosecution Files, Review Inventor Files, Conduct Inventor Interviews, and Review Patents and File Histories.

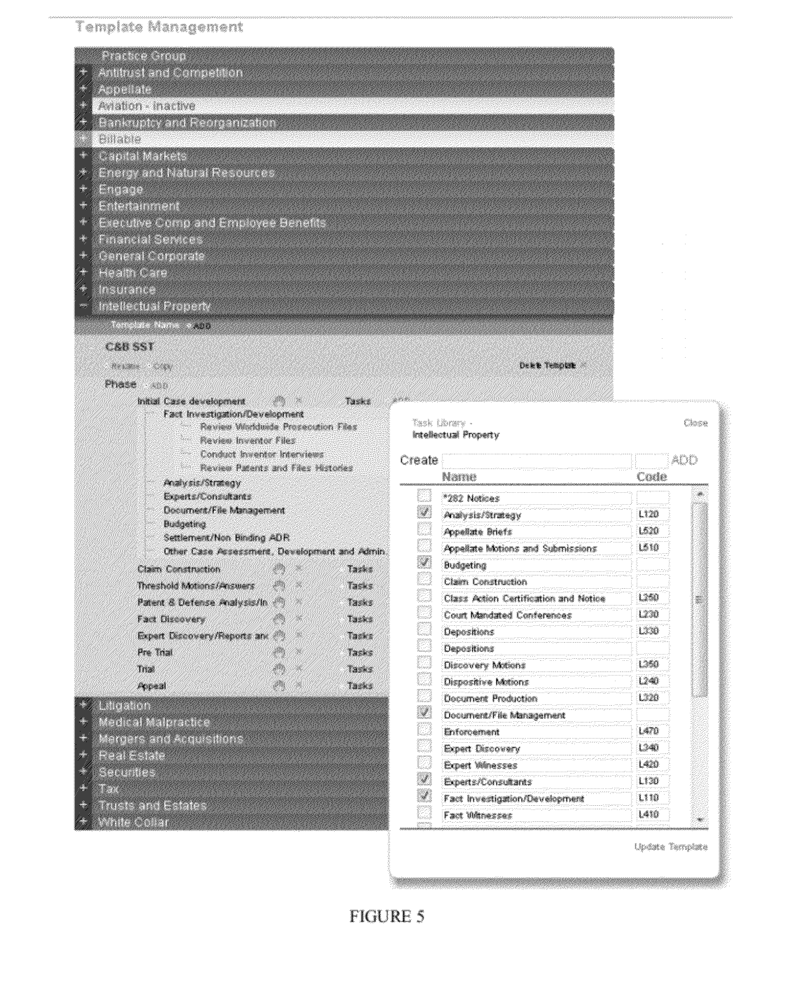

Once in the matter project template, the user selects the “Add” tab behind any of the phases, tasks or sub-tasks and the task library appears. FIG. 5 illustrates a task library with corresponding task codes. Exemplary task codes are American Bar Association (ABA) codes, Legal Electronic Data Exchange Standard (LEDES) codes, client defined codes, firm defined codes or a combination of all of the above. These codes are inputted manually or programmatically into the financial system 144 as well as the resource database 135.

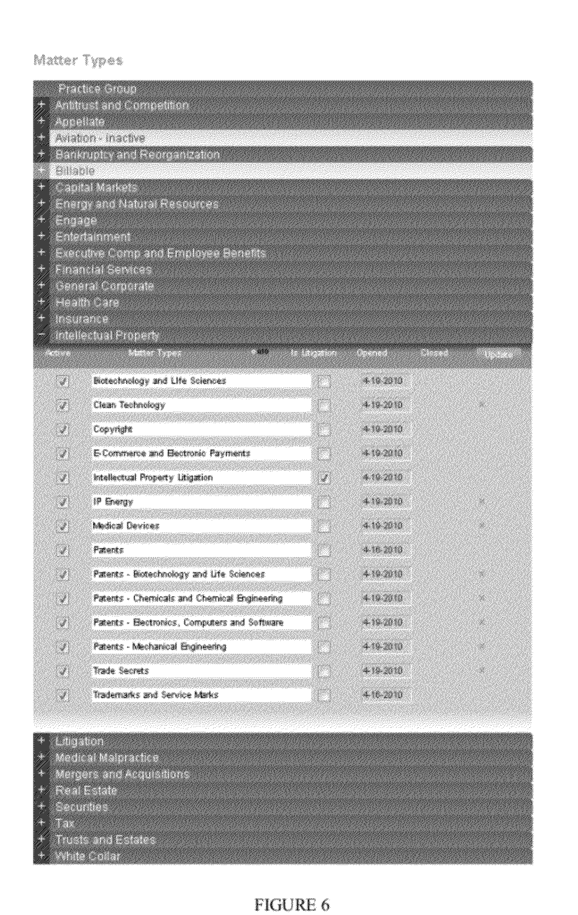

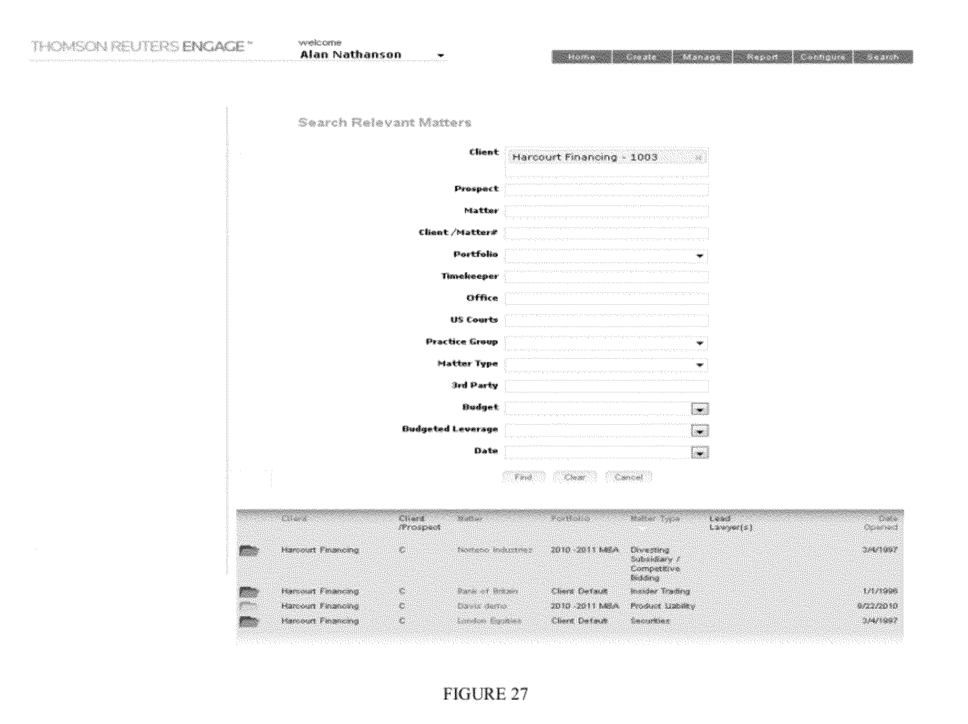

FIGS. 4-6 show a listing of practice groups from financial system 144, a user's manual entry into system 100 or a combination. Under these practice groups, certain matter types are added to each practice group to enhance the flexibility of the system 100. For example, the intellectual property practice group is selected in FIG. 6. The selection of this practice group reveals a sub-listing of intellectual property matter types. This sub-listing of matter types allows the user to search and retrieve a matter project by matter type (see FIG. 27).

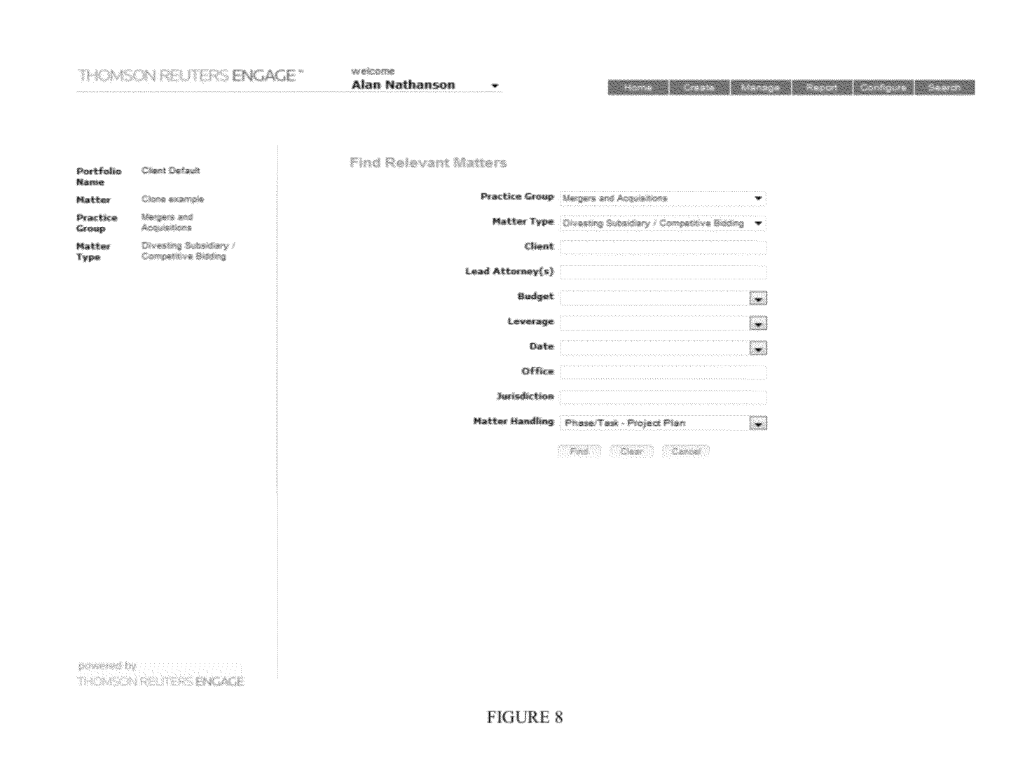

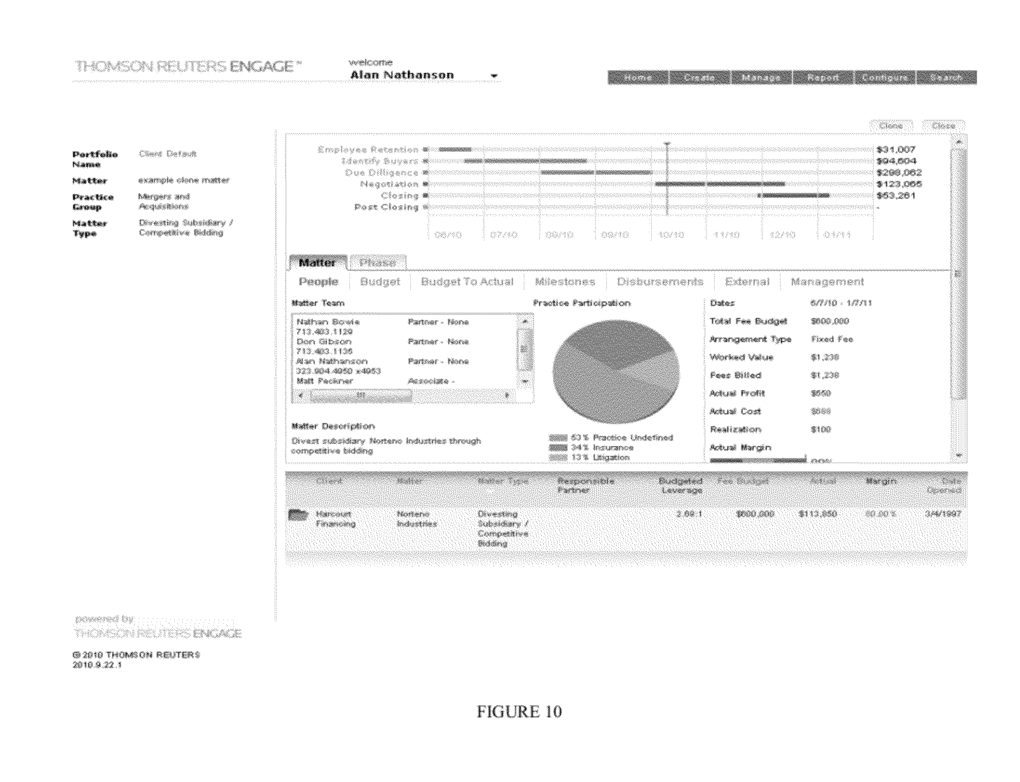

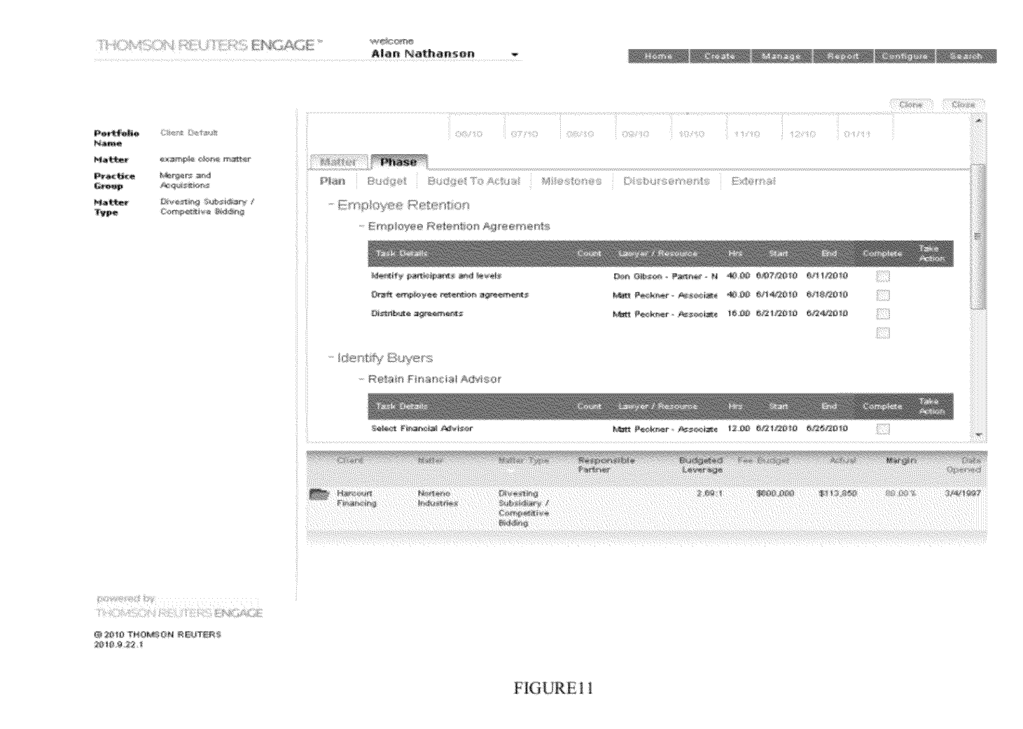

FIG. 7 illustrates the user having the option to create a new matter project or clone an existing matter project by populating certain information into the search template fields. If the user opts to clone a matter project, FIG. 8, for example, shows a search template where the user has selected “Mergers and Acquisitions” from the practice group field, “Divesting Subsidiary/Competitive Bidding” from the matter type field and “Phase/Task-Project Plan” from the matter handling field. Once the user selects “Find”, FIG. 9 shows an exemplary results display at the bottom of the figure. If the user chooses to select one of the existing matter projects, FIG. 10 illustrates a read-only version of the existing matter project where the user assesses if this existing matter project has the level and/or type of detail needed for the potential cloned matter project. The user looks at various types of information including but not limited to budget, timekeeper who worked on the matter project, matter project status, external participation (e.g. damages expert, financial advisor, etc.), matter project calendar, disbursement costs, and expertise participation (i.e. which practice areas and to what degree those practice groups had a hand in this matter). The user may also select the “Phase” tab bringing the user to FIG. 11 which shows the project plan of the existing matter project. If this level and type of detail is satisfactory, he clicks “Clone,” certain information gets copied from the existing matter project and then populates the copied information (i.e. received information) into a new matter project. For example, FIGS. 10-12 depict exemplary received information copied from the existing matter project. Once the matter project has been cloned the user may modify the matter project for customization purposes. For example in FIG. 11, there is a task detail under the “Retain Financial Advisor” task named “Select financial advisor.” If the user did not want to have this task detail in the new matter project, it could be deleted or modified as needed. Furthermore, the user may choose to modify the timekeeper information. When the information is copied, the names of the timekeepers who worked on the existing matter project are copied or populated. Instead their titles at the time they worked on the matter project are copied and populated. The user may modify this title-only detail by changing the timekeeper level or selecting a specific person to be responsible for the task detail. This modification is initiated by selecting the face icon which launches the mechanism to assign specific timekeepers to the matter project.

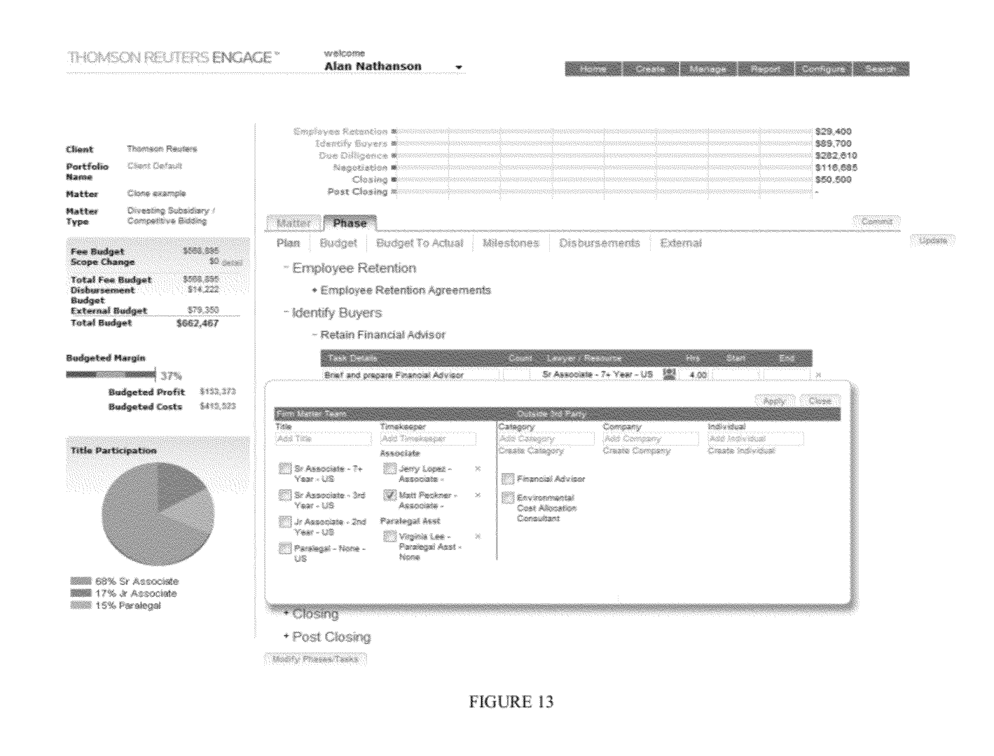

FIG. 13 depicts an exemplary resource mechanism. This mechanism allows matter managers, partners, or project managers to assign internal timekeepers by name as well as third parties by category, company or individual. Once the individual is identified for the task detail, the user clicks the “Apply” button and the selected individual's information, if any, is populated into the matter project as shown in FIG. 14.

In FIG. 14, most of the task and/or task details are assigned to specific individuals within the law firm. For example, task detail “Identify participants and levels” was assigned to Don Gibson, a partner at the firm. His title, billing rate and potentially other information were populated into this matter project after the user selected “Update.”

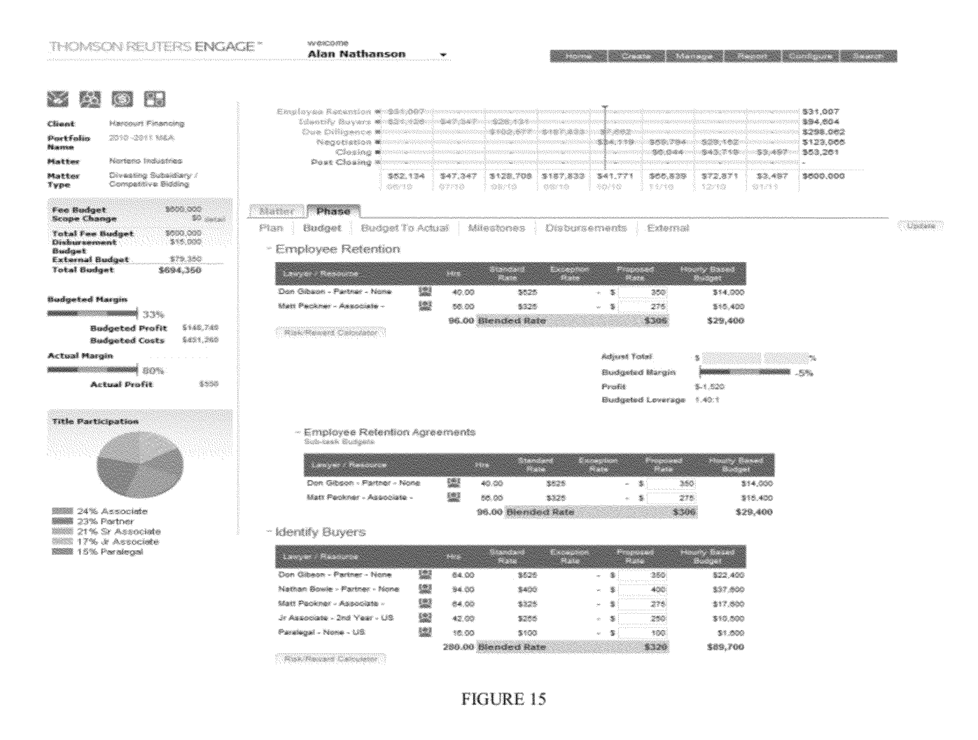

FIG. 15 shows an exemplary phase matter budget. For instance, under the “Employee Retention” phase, Don Gibson is working 40 hours on this particular phase. This view shows the monetary break down of each phase, task and/or sub-task.

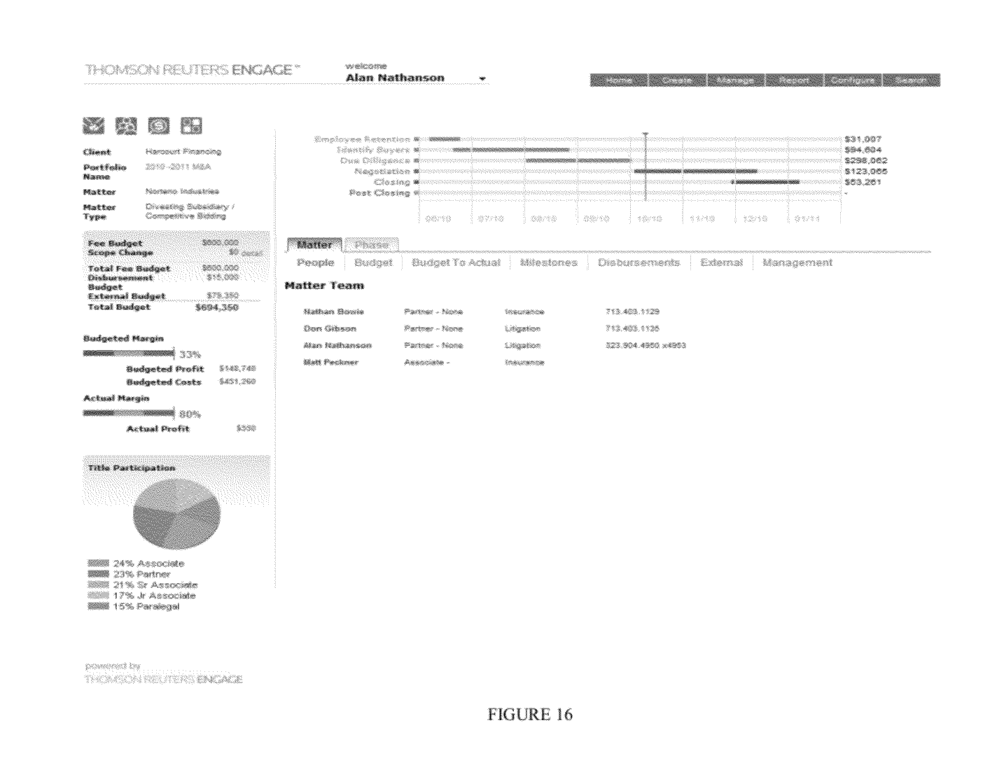

FIG. 16 illustrates all the matter project team members and their information. Exemplary information includes name, title, practice group and phone number.

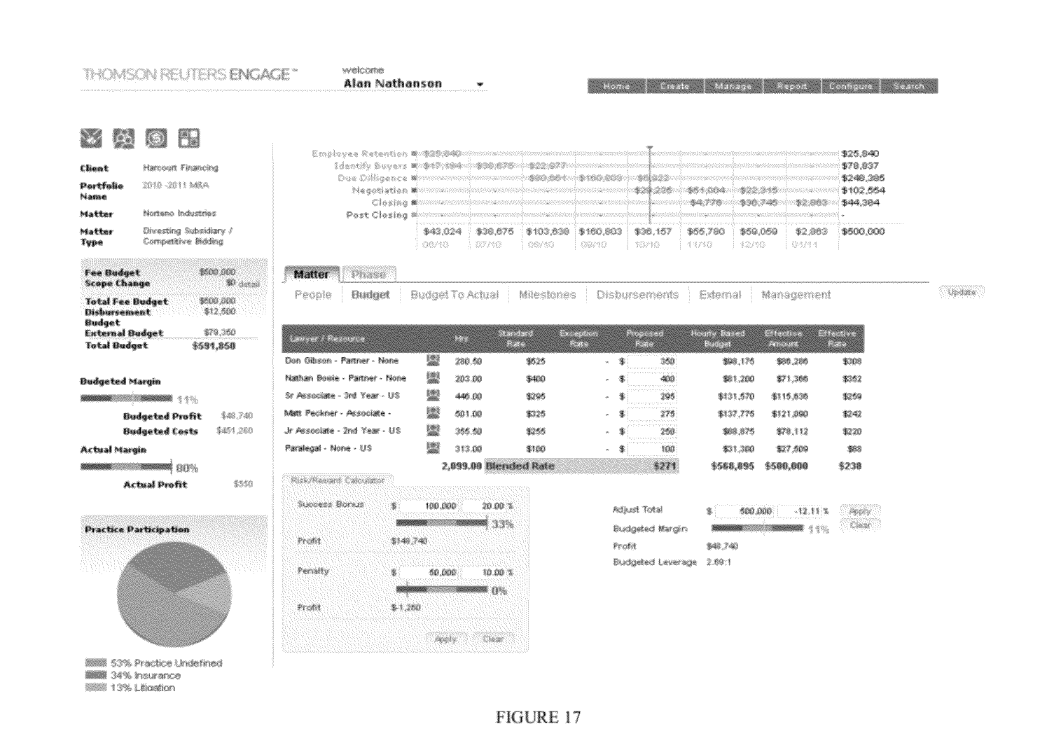

FIG. 17 depicts an exemplary matter budget view. The budgets from the task and phases are rolled up into a summary view by timekeeper along with the detailed run rate (month by month costs) being displayed within the timeline tool.

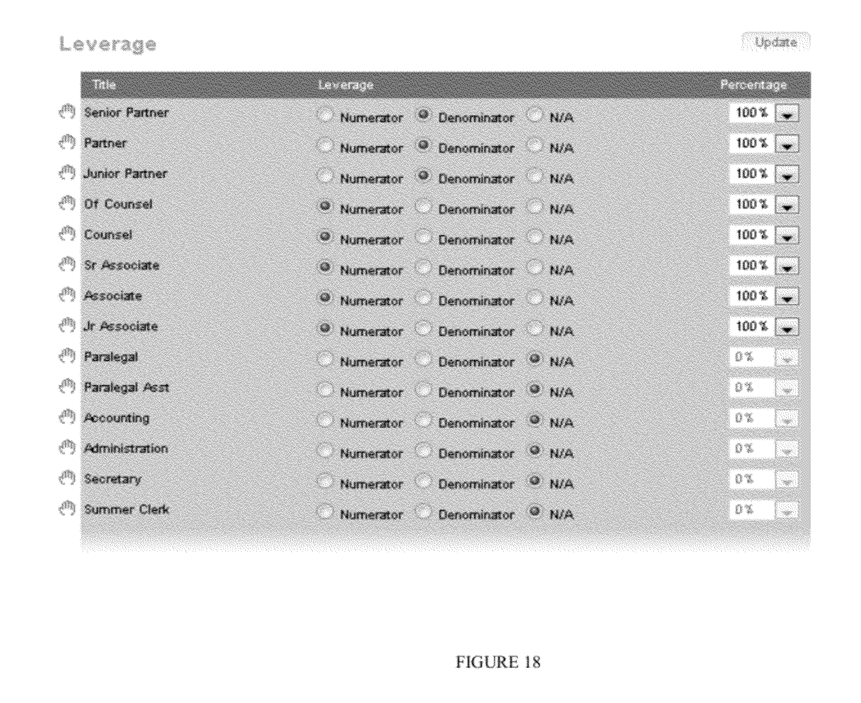

FIG. 18 shows an exemplary leverage display. The leverage display lists all the titles within the financial system 144 and allows a user with configure permissions to assign titles to the appropriate side of the leverage calculation in order to produce leverage ratio results. The leverage display also depicts a weight to each title, captured in the percentage field, to allow for some titles' hours amount to not figure into the leverage ratio.

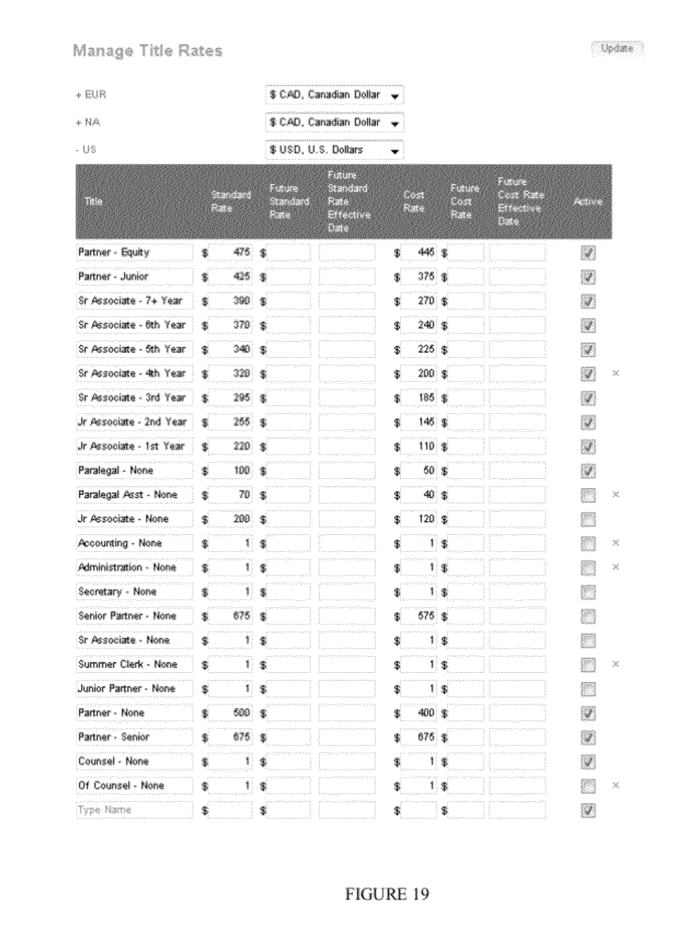

FIG. 19 illustrates an output of the titles within the law firm. System 100 captures and builds out all titles in the firm through the information within the financial system 144 and displays the titles and various corresponding rates for budgeting and profitability purposes.

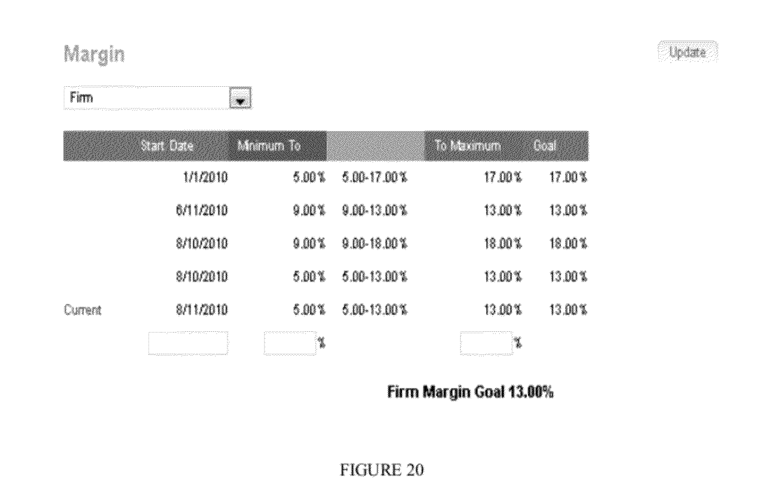

Margins are calculated consistently throughout system 100, but determining whether a margin falls within acceptable ranges varies depending upon the level at which the margin is reviewed. To accommodate a flexible margin threshold, an interface is provided where a user with configure permissions is able to define ranges for margin thresholds at the firm level overall, at a practice group level, at a matter type level, at a client level, and at a portfolio level. For example, FIG. 20 illustrates a firm level margin. Since margin threshold ranges change over time, the user with configure permissions views the past threshold ranges, edits the current threshold ranges, and sets up and manages future threshold ranges. Each range has an effective date, a minimum percent, and a maximum percent.

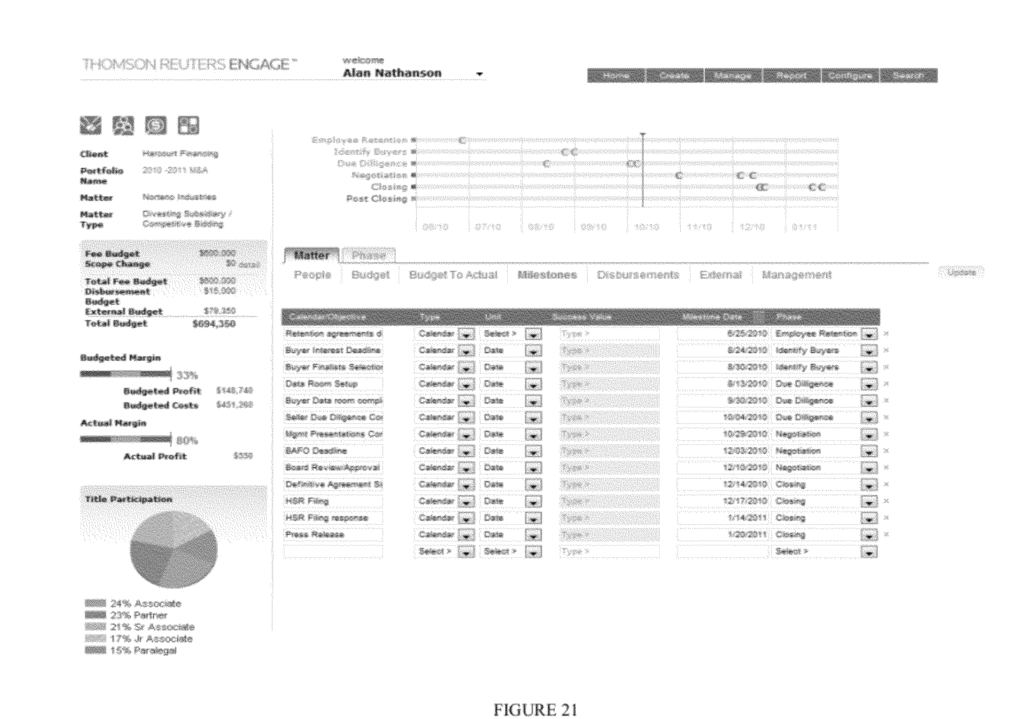

FIG. 21 illustrates the milestone tab. This tab displays icons representing calendar objectives (e.g. deal calendar, litigation calendar, or patent prosecution calendar) with each milestone date being previously inputted into a timeline tool. If a user moves his mouse 133 over an icon within the timeline tool, the calendar objective appears.

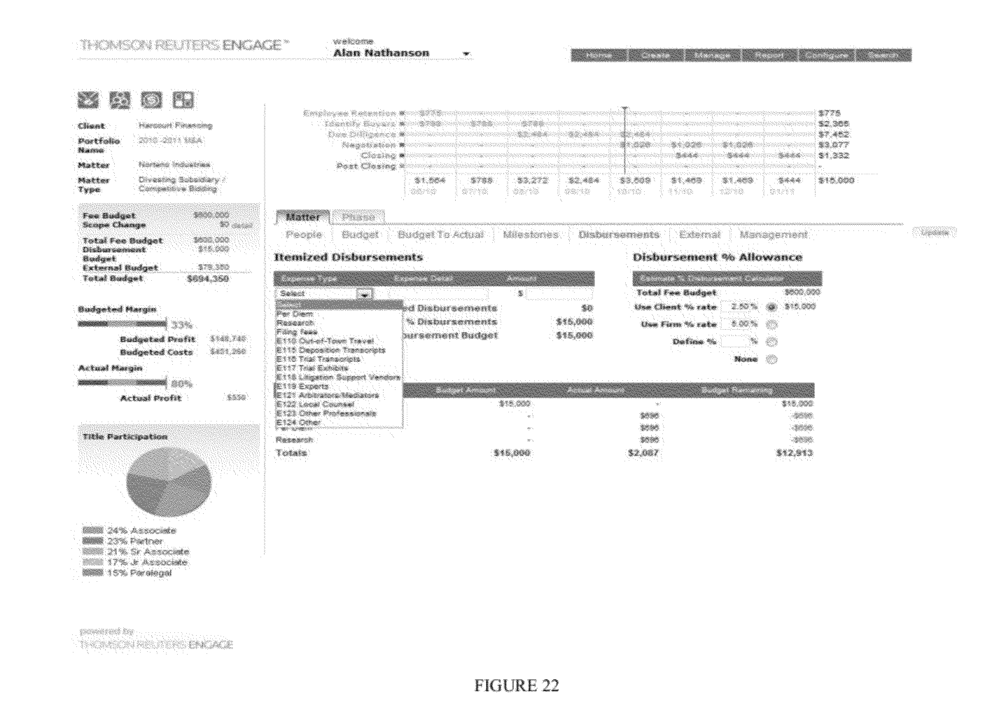

FIG. 22 shows the disbursements tab where the costs (i.e. disbursements) displayed are either automatically built by assigning them as a percentage of the budget and/or itemizing disbursement costs.

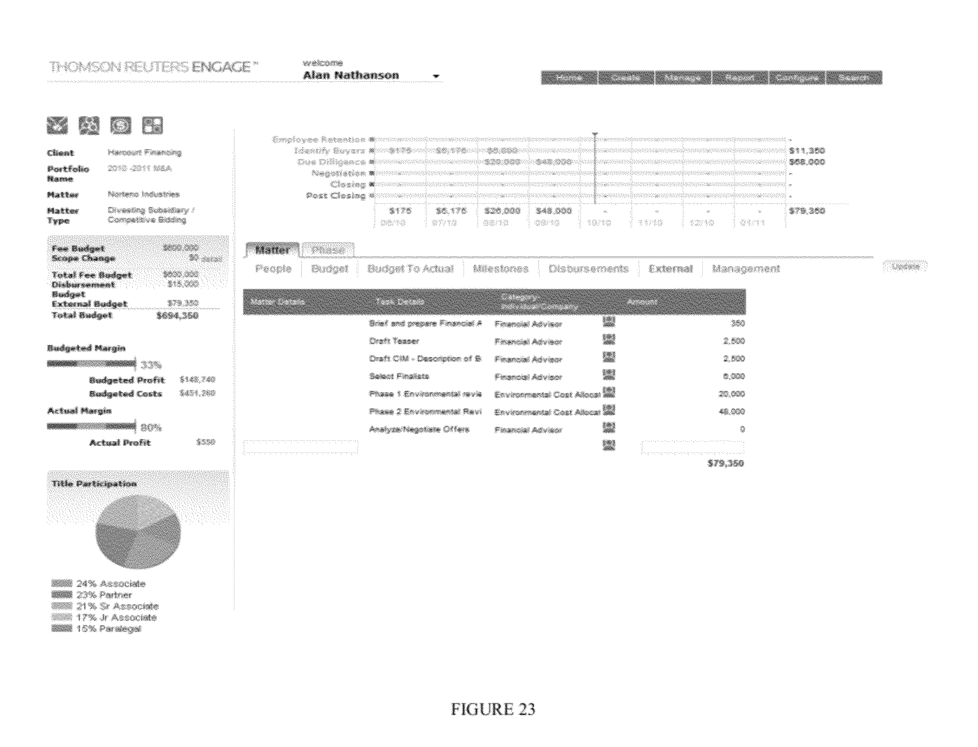

FIG. 23 depicts an exemplary budget management for third party costs. Generally in other systems, third parties are assigned to the matter project plan but third party costs are not reflected or managed in the firm's financial systems. Additionally these costs are passed on directly to the client and usually not part of the law firm budget. However, this external third party budget management mechanism allows for including third party costs into the matter project plan and budget as illustrated in the left hand pane.

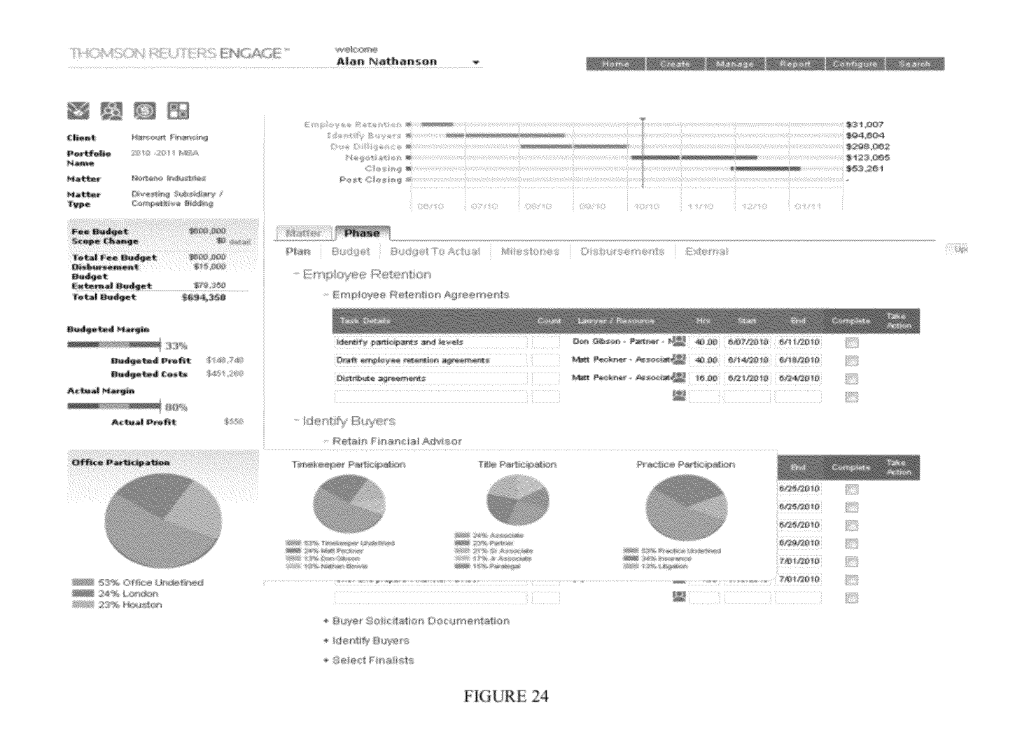

FIG. 24 shows several graphical representations of information for the matter manager to evaluate the effectiveness of the decision making. The “Office Participation” pie chart shows the breakdown of work being done in each office location. The “Timekeeper Participation” pie chart represents the amount of time each timekeeper has been assigned for the matter project. The “Title Participation” pie chart represents the percentage of titles that are working on this matter project. The “Practice Participation” pie chart represents which practice areas and to what degree those practice groups had a hand in this matter project.

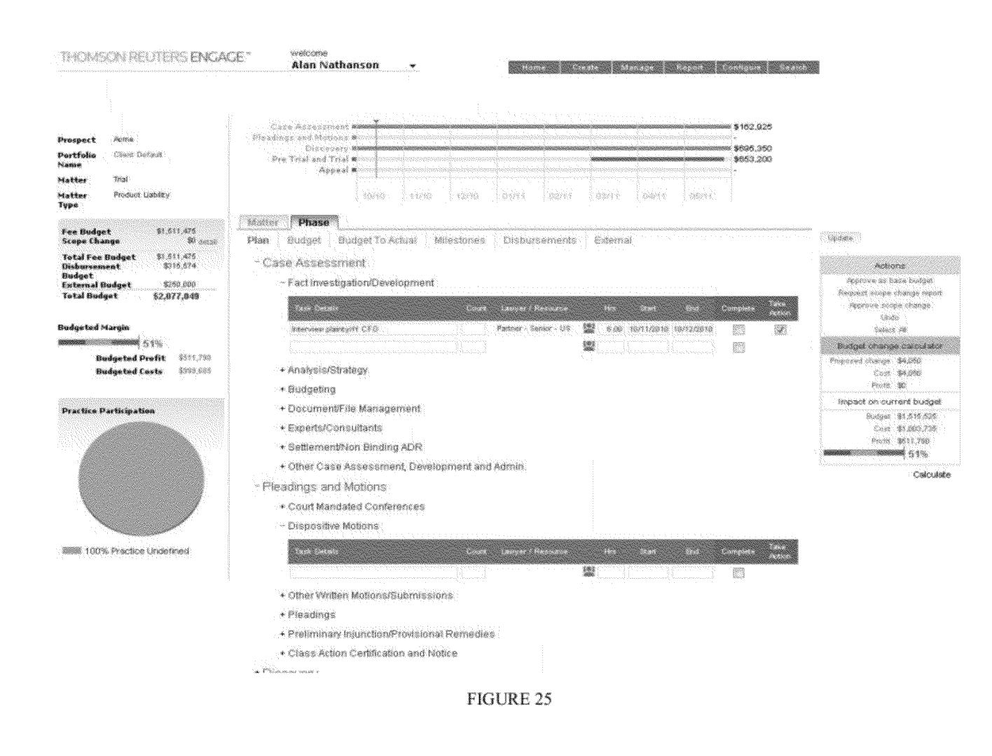

FIG. 25 illustrates the user option of changing the base budget and/or the scope of the budget. A base budget change scenario might entail a managing partner creating an initial budget and wanting to include a monetary cushion in order to expand the initial budget without needing approval from the client every time an additional event arises. A scope change scenario might occur when the client wants to be in control of any increase in monetary expense beyond the initial budget. For example, the initial budget does not include a motion. This mechanism adds the motion to the budget contingent upon the client approval of the scope change. If approved, the budget is then re-calculated with the additional scope fees.

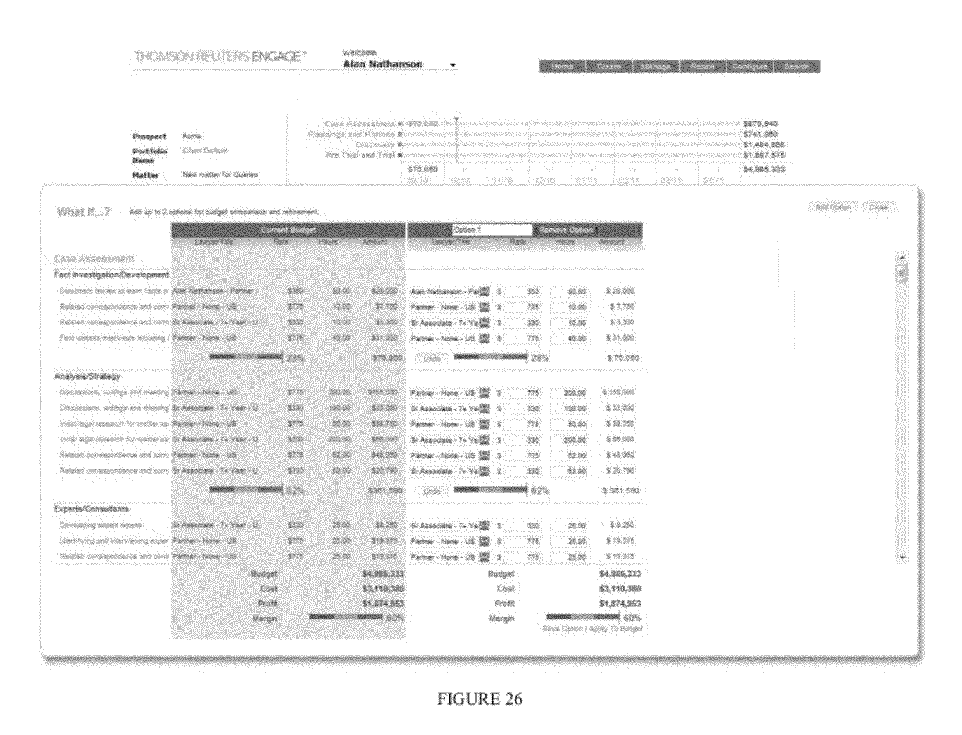

FIG. 26 displays an exemplary “What If” mechanism. This mechanism copies every line out of the project plan, builds a budget and then allows the user to launch options to review changes side by side with the current budget to analyze options for staffing the plan. This display shows the changes to the project plan, such as assigning another resource or changing the estimated hours, and the impact these changes have on the overall budget, cost, profit, and margin. The “What If” mechanism shows all current matter, phase and/or task level budget details and saves up to two additional “What If” copies. Each “What If” copy may overwrite the current matter budget. Once the matter project has been committed, the “What If” mechanism is no longer allowed.

FIG. 27 illustrates a search template and a results list below the search template. The template allows a user to enter certain criteria and search for matters that meet the certain criteria. The results of that search are displayed below the search template. The user may then select a matter project to view.

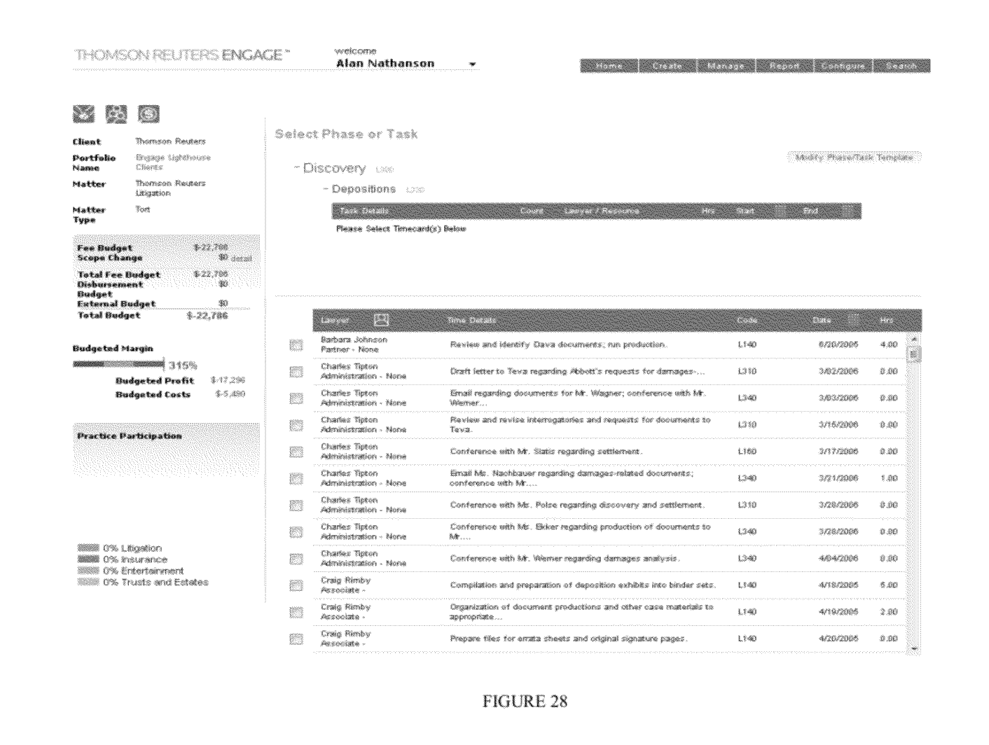

System 100 allows non-system matters to be imported and modified to become matter projects. A user with configure permissions searches by client, matter, and/or client matter number to receive a listing of non-system matters within the financial system 144. The user selects a non-system matter to import via a link and the matter along with applicable fields is imported into system 100 to be modified into a matter project. For example, FIG. 28 shows how a user matches timecard information to task details to create matter project details. When finished adding all available time card information to task details, the matter project is stored in resource database 135 and available in system 100.

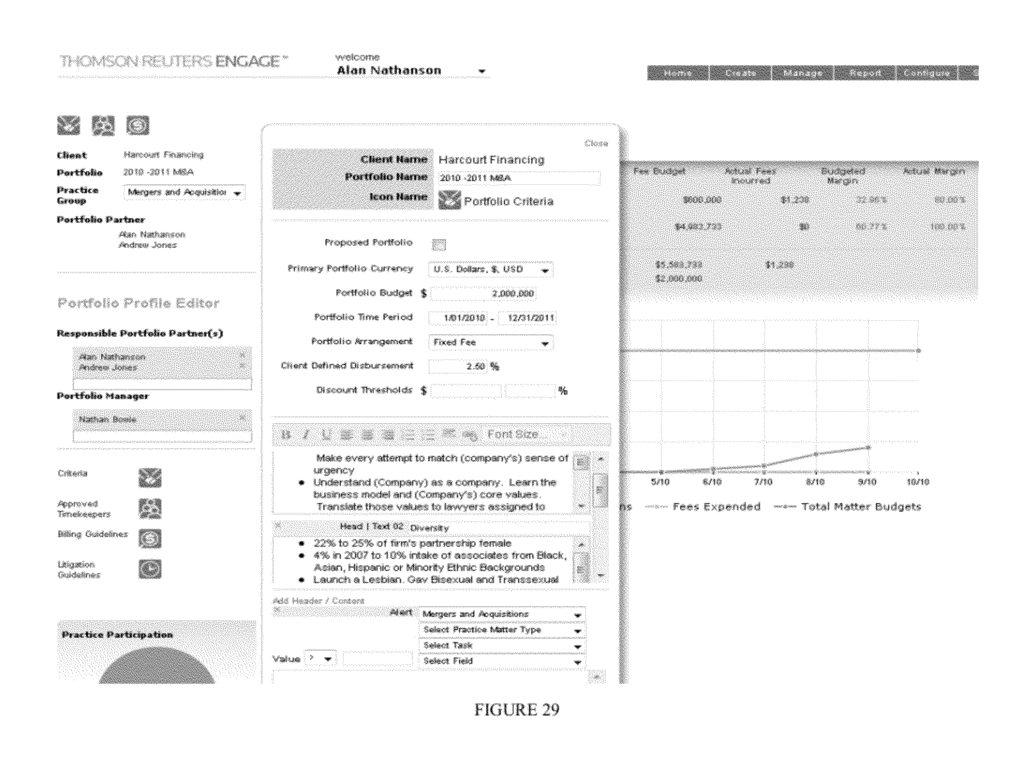

When creating a portfolio matter project, FIG. 29 illustrates a mechanism that builds out and displays agreements details between the client and the law firm for the portfolio matter project work. This tool displays four elements of the agreement: contract criteria; timekeeper pre-approval; billing guidelines; litigation guidelines.

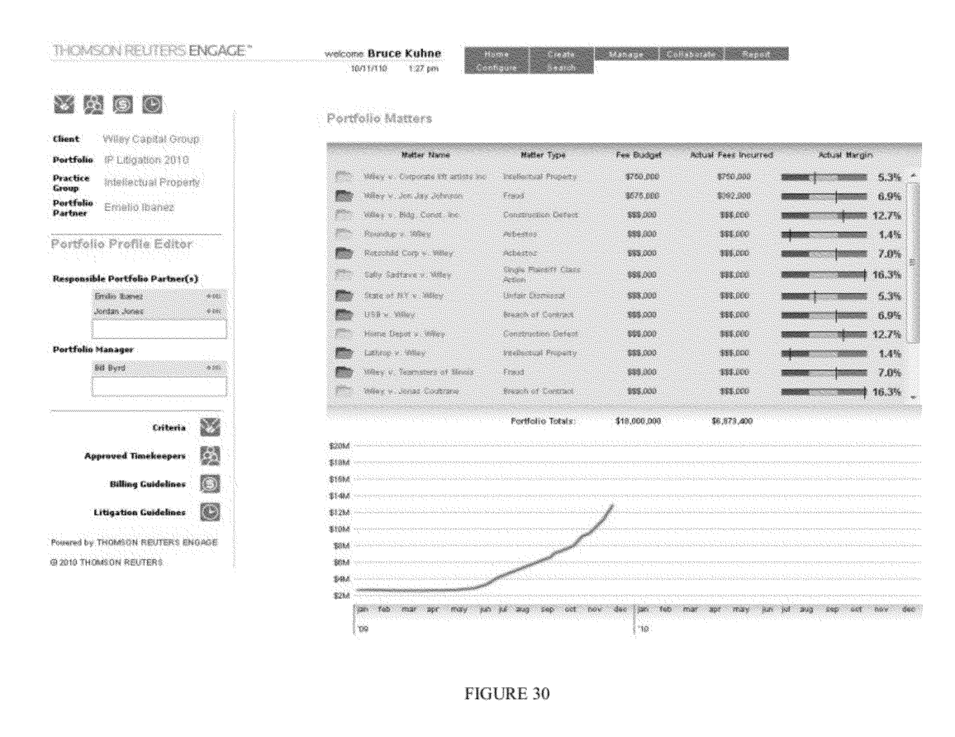

After initial creation, the portfolio matter project record is updated by users who are associated to the portfolio matter project. The user accesses FIG. 30 by selecting the portfolio matter project from the list of their portfolio matter projects. FIG. 30 shows an exemplary portfolio profile control that allows the user to view and/or update the portfolio matter project partner and portfolio matter project manager lists, the list of related matters, and a chart representing the portfolio matter project fees month by month.

### Exemplary Illustrations for Time Entry Mechanism within System 100

FIGS. 31-124 include exemplary illustrations for a time entry mechanism, within system 100, which may be adapted to incorporate the capabilities, functions, systems, methods, and so forth described herein.

FIG. 31 shows the workflow of the time entry mechanism within system 100. As further illustrated in FIGS. 32-124 and described in the corresponding specification sections, once a timekeeper submits his time entry within system 100, his time entry and other time entry information are sent through two different paths. One path consists of sending the time entry records and information to the resource database 135 via communications networks 101, 103. The other path consists of sending a system 100 staging table to the time entry system 141 and/or financial system 144 via communications networks 101, 103, 105. This system 100 staging table includes time entry and related information formatted to conform and integrate with the appropriate time entry system 141 and/or financial system 144. This dual path workflow ensures that the time entry information is up to date in the resource database 135 and the time entry system 141 and/or financial system 144.

FIGS. 32-35 depict different views for user matter projects. The user has the ability to view his time and/or schedule. The time view shows all matter projects that require time entry. For example FIG. 33 displays three different categories of time: 1) matter plan, 2) matter phase/task budget only, and 3) matter budget. Exemplary embodiments of the different time categories are illustrated and described herein. The matter plan time category has detailed information about the task, including dates and the assigned task. This time category is the most common within system 100. Also within the time view, the user may choose to view his non-system matters (See FIG. 34). In addition, FIG. 35 shows the schedule view where the matter projects the user has assigned tasks displays.

Within the time category of matter plan, FIGS. 36-39 illustrate an exemplary task assignment with emails being sent to the assigned timekeeper. A lead matter partner or matter manager assigns the task to a timekeeper. Once this assignment takes place, the timekeeper receives a notification email listing out the phases and tasks that have been assigned to him, the budgeted hours and the due date. A timekeeper may be updated at any time and if that update occurs, the new timekeeper receives an email with his new phase/task and the phase/task is removed from the former timekeeper's time and schedule lists. At the start of each week, the system 100 emails all the timekeepers with a list of all his tasks, from all matters, with due dates, hours remaining and percentage complete. This particular email is an informative email sent to the timekeeper.

When the due date is within a week, the system 100 again emails the timekeeper the task requiring time entry. FIGS. 40-52 display the task requirements for matter plan time category. The user clicks on the task to open the time record for this task consequently launching the time entry mechanism. Then the user clicks any day within the time period and enters a task description in the time notes window. The time field is then activated allowing the user to enter the amount of hours worked on the task. The remaining hours and percentage complete are calculated based on the time entered. After all the time notes, hours and/or other information are entered, the timekeeper submits his time and his task list updates to reflect the completed task.

FIGS. 53-56 depict missed deadline illustrations. If a timekeeper misses a deadline, the missed deadline task is highlighted and remains highlighted until the task is complete. An email reminds the timekeeper to submit his time within the time entry mechanism. In addition, the lead attorney and matter manager receive an email reporting the missed deadline.

In some tasks, additional time may be needed for the timekeeper to complete the task. FIGS. 57-69 show examples for requesting additional time. Requesting additional time may require a scope change. Once the scope change is applied, the additional time is allocated to the task. The request for additional time also helps build the knowledge base for the law firm by keeping track of how long this task actually took. When the timekeeper requests additional time, he describes the reason the task requires additional time and the amount of the additional time required. The request is submitted and the submission is emailed to the matter manager or lead matter attorney to review. The matter manager and/or lead attorney views the task and the additional time reasoning and decides whether to approve. If approval occurs, the decision maker decides if the additional time requires a scope change or a change to the base budget. If the decision maker decides to approve the additional time, the budgeted time and time remaining are recalculated for that timekeeper on that task. FIGS. 70-72 show illustrations for declining a request for additional time including sending an email to the timekeeper notifying him of the declined request. FIGS. 74-91 display multiple requests from the same timekeeper for additional time. The decision maker views a summary page of all the additional time requests from that timekeeper. This summary page allows for navigation through each task and the reasoning for each additional time request. The same functionality for individual approval and/or denial of requests also appears when there are multiple requests from the same timekeeper. Once the decision maker decides the additional time requests, he has the ability to look at the overall management of the specific timekeeper for this matter project.

In some instances, a timekeeper requires less time than allocated to complete a task. FIGS. 92-99 depict examples of the reallocation of hours. Once the timekeeper submits his hours for the task and indicates that the task is complete, an input window appears asking the timekeeper to specify why the task required less time. The unused hours are then built into a grouping of unused time for that timekeeper. This functionality allows timekeepers to draw from their individual grouping of unused hours for tasks that require more hours. When the timekeeper draws from his grouping of unused time, it automatically launches the input box to justify the additional hours required for the task. After the justification is inputted, the unused hours are applied to the task that requires additional hours.

Another time category is a matter phase/task budget only. Matter phase/task budget only includes client name, matter project, phase and task with no task assignments or due dates, allocated timekeeper, estimated hours, and percentage complete. The timekeeper clicks the task to launch the time entry mechanism and if task codes have been assigned to that task, the time is entered against that code. FIGS. 100-105 include exemplary illustrations for a matter phase/task time category.

Yet another time category is a matter budget. Matter budget category of time includes the timekeeper's hours, an estimate of percentage complete, client and matter project name. The timekeeper clicks the matter project name to launch the time entry mechanism within system 100. FIGS. 106-117 exhibit exemplary interfaces for matter budget time category.

System 100 allows for time entry recording for non-system matters. FIGS. 118-124 illustrate non-system matter time allocation.

### CONCLUSION

The embodiments described above and in the claims are intended only to illustrate and teach one or more ways of practicing or implementing the present invention, not to restrict its breadth or scope. For example, system 100 could utilize an n-tier structure instead of the 3-tier structure. The actual scope of the invention embraces all ways of practicing or implementing the teachings of the invention and is defined only by the issued claims and their equivalents.

1. An apparatus comprising:
a. a server comprising a memory and a processor, the processor configured to:
i. manage at least one law firm matter project;
ii. populate the at least one law firm matter project with a set of received information, the set of received information stored in at least one resource database, wherein the set of received information comprises at least one of a piece of financial information and a piece of a matter project template associated with an existing law firm matter project; and
iii. enable access of the at least one of the law firm matter project to a set of law firm personnel, the at least one of the law firm matter project stored in the at least one resource database.

2. The apparatus of claim 1 further comprises the processor configured to calculate a budget automatically based on the set of received information populated into the at least one law firm matter project.

3. The apparatus of claim 2 further comprises the processor configured to calculate an updated budget based on a scope change.

4. The apparatus of claim 1 wherein the piece of financial information comprises at least one of a timekeeper billing rate, a timekeeper billing rate exception, a title associated with a timekeeper, and a title cost rate.

5. The apparatus of claim 1 wherein the piece of a matter project template comprises at least one of a phase, a task, and a sub-task.

6. The apparatus of claim 1 further comprises the processor configured to enable a time entry mechanism.

7. A method comprising:
a. managing at least one law firm matter project;
b. populating the at least one law firm matter project with a set of received information, the set of received information stored in at least one resource database, wherein the set of received information comprises at least one of a piece of financial information and a piece of a matter project template associated with an existing law firm matter project; and
c. enabling access of the at least one of the law firm matter project to each law firm personnel, the at least one of the law firm matter project stored in the at least one resource database.

8. The method of claim 7 further comprising calculating a budget automatically based on the set of received information populated into the at least one law firm matter project.

9. The method of claim 9 further comprising calculating an updated budget based on a scope change.

10. The method of claim 7 wherein the piece of financial information comprises at least one of a timekeeper billing rate, a timekeeper billing rate exception, a title associated with a timekeeper, and a title cost rate.

11. The method of claim 7 wherein the piece of a matter project template comprises at least one of a phase, a task, and a sub-task.

12. The method of claim 7 further comprising enabling a time entry mechanism.
